(19) United States
(12) Patent Application Publication
(10) Pub. No.: US 2023/0319765 A1
(43) Pub. Date: Oct. 5, 2023

(54) SYSTEMS AND METHODS FOR NO POSITIONING UPDATE USING PHYSICAL LAYER TRANSMISSIONS

(71) Applicant: QUALCOMM Incorporated, San Diego, CA (US)

(72) Inventors: Alexandros MANOLAKOS, Escondido, CA (US); Weimin DUAN, San Diego, CA (US); Jay Kumar SUNDARARAJAN, San Diego, CA (US); Hwan Joon KWON, San Diego, CA (US); Krishna Kiran MUKKAVILLI, San Diego, CA (US); Wanshi CHEN, San Diego, CA (US)

(21) Appl. No.: 18/023,695

(22) PCT Filed: Oct. 5, 2021
(86) PCT No.: PCT/US2021/053639

§ 371 Date: Feb. 27, 2023

(30) Foreign Application Priority Data
Oct. 9, 2020 (GR) 20200100610

(51) Int. Cl. H04W 64/00; H04W 28/24

(52) U.S. Cl. CPC H04W 64/00; H04W 28/24

(57) ABSTRACT

During a positioning session in which multiple location reports are provided, a user equipment (UE) that has little or no movement may provide an indication to an entity in the wireless network that there is no update for one or more location measurements. The UE may provide the indication to a serving base station in a Physical layer waveform. The base station may bypass the location server and provide an indication to an external client that the UE position has not changed. The UE may provide the indication to a location server in a location information report or by not sending a location information report by an expiration time. The indication of no update may be provided by a bit that indicates no location measurements are updated or that a particular location measurement is not updated.

### CROSS-REFERENCE TO RELATED APPLICATIONS

This application is a National Stage Application filed under 35 U.S.C. § 371 of PCT/US2021/053639, filed Oct. 5, 2021, entitled “SYSTEMS AND METHODS FOR NO POSITIONING UPDATE USING PHYSICAL LAYER TRANSMISSIONS”, which claims priority to Greek Application No. 20200100610, filed Oct. 9, 2020, entitled “SYSTEMS AND METHODS FOR NO POSITIONING UPDATE USING PHYSICAL LAYER TRANSMISSIONS,” which are incorporated herein by reference in their entirety.

### BACKGROUND

### Field

Subject matter disclosed herein relates to positioning of a user equipment (UE), and more particularly to updating positioning information from the UE.

### Relevant Background

The location of a mobile device, such as a cellular telephone, may be useful or essential to a number of applications including emergency calls, navigation, direction finding, asset tracking and Internet service. For example, a location services (LCS) client may desire to know the location of a terminal in the case of an emergency services call or to provide some service to the user of the terminal such as navigation assistance or direction finding. The terms “location” and “position” are synonymous and are used interchangeably herein.

The location of a UE may be estimated based on information gathered from various systems. In a cellular network implemented according to 4G (also referred to as Fourth Generation) Long Term Evolution (LTE) radio access or 5G (also referred to as Fifth Generation) “New Radio” (NR), for example, a base station may transmit reference signals that are received by the UE and used for positioning measurements. For example, a UE may receive downlink (DL) positioning reference signals (PRS) received from base stations and generate positioning measurements such as Reference Signal Time Difference (RSTD), Reference Signal Received Power (RSRP), and reception and transmission (RX-TX) time difference measurements, which may be used in various positioning methods, such as Time Difference of Arrival (TDOA), Angle of Departure (AoD), and multi-cell Round Trip Time (RTT). Other position methods that may be used for a UE include use of a Global Navigation Satellite System (GNSS) such as GPS, GLONASS or Galileo and use of Assisted GNSS (A-GNSS).

The UE may deliver signal-based measurements to a location server, which may be part of an Evolved Packet Core (EPC) or 5G Core Network (5GCN), for use in computing a location estimate of the UE in a UE-assisted positioning process. Alternatively, the UE may compute an estimate of its own location using various positioning methods in a UE based positioning process.

Transmitting positioning information, such as positioning measurements acquired by the UE or a position estimate determined by the UE, however, may be resource intensive, e.g., requiring UE and network resources. Accordingly, efficient operation of positioning operations is desirable.

### SUMMARY

During a positioning session in which multiple location reports are provided, a user equipment (UE) that has little or no movement between location measurement may determine that that there is little change with respect to one or more location measurements that was previously reported. The UE provides an indication to an entity in the wireless network that there is no update for the one or more location measurements. The UE may provide the indication to a serving base station in a Physical layer waveform. The base station may bypass the location server and provide an indication that the UE position has not changed to an external client. The UE may provide the indication to a location server in a location information report or by not sending a location information report by an expiration time. The indication that there is no update to location measurements may be provided, for example, using a bit in a message to indicate that no location measurements are updated or that a particular location measurement is not updated, or by including no data in a message.

In one implementation, a method for supporting location services for a user equipment (UE) performed by the UE in a wireless network comprising: generating a first set of location measurements comprising at least one location measurement; sending location information report to a location server in the wireless network for location determination of the UE, wherein the location information report comprises location information based on the first set of location measurements; generating a second set of location measurements comprising the at least one location measurement; and providing an indication to an entity in the wireless network that there is no update for at least a portion of the location information that is related to the at least one location measurement.

In one implementation, a user equipment (UE) configured for supporting location services in a wireless network comprising: at least one wireless transceiver configured to wirelessly communicate with at least one wireless network; at least one memory; and at least one processor coupled to the at least one wireless transceiver and the at least one memory and configured to: generate a first set of location measurements comprising at least one location measurement; send a location information report to a location server in the wireless network for location determination of the UE, wherein the location information report comprises location information based on the first set of location measurements; generate a second set of location measurements comprising the at least one location measurement; and provide an indication to an entity in the wireless network that there is no update for at least a portion of the location information that is related to the at least one location measurement.

In one implementation, a user equipment (UE) configured for supporting location services in a wireless network includes: means for generating a first set of location measurements includes at least one location measurement; means for sending a location information report to a location server in the wireless network for location determination of the UE, wherein the location information report comprises location information based on the first set of location measurements; means for generating a second set of location measurements includes the at least one location measurement; and means for providing an indication to an entity in the wireless network that there is no update for at least a portion of the location information that is related to the at least one location measurement.

In one implementation, a non-transitory storage medium including program code stored thereon, the program code is operable to configure at least one processor in a user equipment (UE) for supporting location services in a wireless network, the program code includes instructions to: generate a first set of location measurements includes at least one location measurement; send location information report to a location server in the wireless network for location determination of the UE, wherein the location information report comprises location information based on the first set of location measurements; generate a second set of location measurements includes the at least one location measurement; and provide an indication to an entity in the wireless network that there is no update for at least a portion of the location information that is related to the at least one location measurement.

In one implementation, a method for supporting location services for a user equipment (UE) performed by a base station serving the UE in a wireless network comprising: receiving a location information report from the UE comprising location information based on a set of location measurements comprising at least one location measurement generated by the UE; and receiving an indication from the UE that there is no update for at least a portion of the location information that is related to the at least one location measurement.

In one implementation, a base station configured for supporting location services for a user equipment (UE), the base station serving the UE in a wireless network, comprising: an external interface configured to wirelessly communicate with entities in the wireless network; at least one memory; at least one processor coupled to the external interface and the at least one memory, wherein the at least one processor is configured to: receive a location information report from the UE comprising location information based on a set of location measurements comprising at least one location measurement generated by the UE; and receive an indication from the UE that there is no update for at least a portion of the location information that is related to the at least one location measurement.

In one implementation, a base station configured for supporting location services for a user equipment (UE), the base station serving the UE in a wireless network, includes: means for receiving a location information report from the UE includes location information based on a set of location measurements includes at least one location measurement generated by the UE; and means for receiving an indication from the UE that there is no update for at least a portion of the location information that is related to the at least one location measurement.

In one implementation, a non-transitory storage medium including program code stored thereon, the program code is operable to configure at least one processor in a base station for supporting location services for a user equipment (UE), the base station serving the UE in a wireless network, the program code includes instructions to: receive a location information report from the UE includes location information based on a set of location measurements includes at least one location measurement generated by the UE; and receive an indication from the UE that there is no update for at least a portion of the location information that is related to the at least one location measurement.

In one implementation, a method for supporting location services for a user equipment (UE) performed by a location server in a wireless network comprising: receiving a location information report from the UE comprising location information based on a set of location measurements comprising at least one location measurement generated by the UE; and detecting an indication from the UE that there is no update for at least a portion of the location information that is related to the at least one location measurement.

In one implementation, a location server configured for supporting location services for a user equipment (UE) in a wireless network comprising: an external interface configured to communicate with entities in the wireless network; at least one memory; at least one processor coupled to the external interface and the at least one memory, wherein the at least one processor is configured to: receive a location information report from the UE comprising location information based on a set of location measurements comprising at least one location measurement generated by the UE; and detect an indication from the UE that there is no update for at least a portion of the location information that is related to the at least one location measurement.

In one implementation, a location server configured for supporting location services for a user equipment (UE) in a wireless network includes: means for receiving a location information report from the UE includes location information based on a set of location measurements includes at least one location measurement generated by the UE; and means for detecting an indication from the UE that there is no update for at least a portion of the location information that is related to the at least one location measurement.

In one implementation, a non-transitory storage medium including program code stored thereon, the program code is operable to configure at least one processor in a location server for supporting location services for a user equipment (UE) in a wireless network, the program code comprises instructions to: receive a location information report from the UE includes location information based on a set of location measurements includes at least one location measurement generated by the UE; and detect an indication from the UE that there is no update for at least a portion of the location information that is related to the at least one location measurement.

### BRIEF DESCRIPTION OF THE DRAWINGS

An understanding of the nature and advantages of various embodiments may be realized by reference to the following figures.

FIG. 1 shows a communication system capable of providing location services to a User Equipment (UE).

FIG. 2 is a block diagram illustrating an architecture of a communication system capable of providing location services to UE.

FIG. 3A is a block diagram illustrating another architecture of a communication system capable of providing location services to UE.

FIG. 3B shows an architecture diagram of an NG-RAN node that includes a gNB Central Unit, a gNB Distributed Unit, and gNB Remote Unit.

FIG. 4 shows a block diagram of a design of base station and UE.

FIG. 5 illustrates a message flow for location information between the UE and a location server.

FIG. 6 illustrates a message flow illustrating transmission of messages between the UE and a base station as part of a scheduling procedure

FIG. 7 is a message flow illustrating the messaging between the UE, the serving base station and location server during a positioning session.

FIG. 8 is another message flow illustrating the messaging between the UE, the serving base station and location server during a positioning session.

FIG. 9 shows a schematic block diagram illustrating certain exemplary features of a UE enabled to support positioning.

FIG. 10 shows a schematic block diagram illustrating certain exemplary features of a base station enabled to support positioning of a UE.

FIG. 11 shows a schematic block diagram illustrating certain exemplary features of a location server enabled to support positioning of a UE.

FIG. 12 shows a flowchart for an exemplary method for supporting location services for a UE that is performed by the UE in a wireless network.

FIG. 13 shows a flowchart for an exemplary method for supporting location services for a UE that is performed by a serving base station in a wireless network.

FIG. 14 shows a flowchart for an exemplary method for supporting location services for a UE that is performed by a location server in a wireless network.

Like reference numbers and symbols in the various figures indicate like elements, in accordance with certain example implementations. In addition, multiple instances of an element may be indicated by following a first number for the element with a letter or with a hyphen and a second number. For example, multiple instances of an element 110 may be indicated as either 110-1, 110-2, 110-3 etc. or 110A, 110B, 110C etc. When referring to such an element using only the first number, any instance of the element is to be understood (e.g. elements 110 in the previous example may refer to elements 110-1, 110-2 and 110-3 or elements 110A, 110B and 110C).

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular Radio Access Technology (RAT), unless otherwise noted. In general, a UE may be any wireless communication device (e.g., a mobile phone, router, tablet computer, laptop computer, tracking device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” “mobile device,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11, etc.) and so on.

A base station may operate according to one of several RATs in communication with UEs depending on the network in which it is deployed, and may be alternatively referred to as an access point (AP), a network node, a NodeB, an evolved NodeB (eNB), a New Radio (NR) Node B (also referred to as a gNB), etc. In addition, in some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an UL/reverse or DL/forward traffic channel.

The term “base station” may refer to a single physical transmission point or to multiple physical transmission points that may or may not be co-located. For example, where the term “base station” refers to a single physical transmission point, the physical transmission point may be an antenna of the base station corresponding to a cell of the base station. Where the term “base station” refers to multiple co-located physical transmission points, the physical transmission points may be an array of antennas (e.g., as in a multiple-input multiple-output (MIMO) system or where the base station employs beamforming) of the base station. Where the term “base station” refers to multiple non-co-located physical transmission points, the physical transmission points may be a distributed antenna system (DAS) (a network of spatially separated antennas connected to a common source via a transport medium) or a remote radio head (RRH) (a remote base station connected to a serving base station). Alternatively, the non-co-located physical transmission points may be the serving base station receiving the measurement report from the UE and a neighbor base station whose reference radio frequency (RF) signals the UE is measuring.

To support positioning of a UE, two broad classes of location solution have been defined: control plane and user plane. With control plane (CP) location, signaling related to positioning and support of positioning may be carried over existing network (and UE) interfaces and using existing protocols dedicated to the transfer of signaling. With user plane (UP) location, signaling related to positioning and support of positioning may be carried as part of other data using such protocols as the Internet Protocol (IP), Transmission Control Protocol (TCP) and User Datagram Protocol (UDP).

The Third Generation Partnership Project (3GPP) has defined control plane location solutions for UEs that use radio access according to Global System for Mobile communications GSM (2G), Universal Mobile Telecommunications System (UMTS) (3G), LTE (4G) and New Radio (NR) for Fifth Generation (5G). These solutions are defined in 3GPP Technical Specifications (TSs) 23.271 and 23.273 (common parts), 43.059 (GSM access), 25.305 (UMTS access), 36.305 (LTE access) and 38.305 (NR access). The Open Mobile Affiance (OMA) has similarly defined a UP location solution known as Secure User Plane Location (SUPL) which can be used to locate a UE accessing any of a number of radio interfaces that support IP packet access such as General Packet Radio Service (GPRS) with GSM, GPRS with UMTS, or IP access with LTE or NR.

Both CP and UP location solutions may employ a location server to support positioning. The location server may be part of or accessible from a serving network or a home network for a UE or may simply be accessible over the Internet or over a local Intranet. If positioning of a UE is needed, a location server may instigate a session (e.g. a location session or a SUPL session) with the UE and coordinate location measurements by the UE and determination of an estimated location of the UE. During a location session, a location server may request positioning capabilities of the UE (or the UE may provide them without a request), may provide assistance data to the UE (e.g. if requested by the UE or in the absence of a request) and may request a location estimate or location measurements from a UE for various positioning techniques, e.g. for the Global Navigation Satellite System (GNSS), Time Difference of Arrival (TDOA), Angle of Departure (AoD), Round Trip Time (RTT) or multi cell RTT (Multi-RTT), and/or Enhanced Cell ID (ECID) position methods. Assistance data may be used by a UE to acquire and measure GNSS and/or PRS signals (e.g. by providing expected characteristics of these signals such as frequency, expected time of arrival, signal coding, signal Doppler).

In a UE based mode of operation, assistance data may also or instead be used by a UE to help determine a location estimate from the resulting location measurements (e.g., if the assistance data provides satellite ephemeris data in the case of GNSS positioning or base station locations and other base station characteristics such as PRS timing in the case of terrestrial positioning using, e.g., TDOA, AoD, Multi-RTT, etc.).

In a UE assisted mode of operation, a UE may return location measurements to a location server which may determine an estimated location of the UE based on these measurements and possibly based also on other known or configured data (e.g. satellite ephemeris data for GNSS location or base station characteristics including base station locations and possibly PRS timing in the case of terrestrial positioning using, e.g., TDOA, AoD, Multi-RTT, etc.).

In another standalone mode of operation, a UE may make location related measurements without any positioning assistance data from a location server and may further compute a location or a change in location without any positioning assistance data from a location server. Position methods that may be used in a standalone mode include GPS and GNSS (e.g. if a UE obtains satellite orbital data from data broadcast by GPS and GNSS satellites themselves) as well as sensors.

In the case of 3GPP CP location, a location server may be an enhanced serving mobile location center (E-SMLC) in the case of LTE access, a standalone SMLC (SAS) in the case of UMTS access, a serving mobile location center (SMLC) in the case of GSM access, or a Location Management Function (LMF) in the case of 5G NR access. In the case of OMA SUPL location, a location server may be a SUPL Location Platform (SLP) which may act as any of: (i) a home SLP (H-SLP) if in or associated with the home network of a UE or if providing a permanent subscription to a UE for location services; (ii) a discovered SLP (D-SLP) if in or associated with some other (non-home) network or if not associated with any network; (iii) an Emergency SLP (E-SLP) if supporting location for an emergency call instigated by the UE; or (iv) a visited SLP (V-SLP) if in or associated with a serving network or a current local area for a UE.

A location server and a base station (e.g. an eNodeB for LTE access or a gNodeB for 5G NR access) may exchange messages to enable the location server to (i) obtain position measurements for a particular UE from the base station, or (ii) obtain location information from the base station not related to a particular UE such as the location coordinates of an antenna for the base station, the cells (e.g. cell identities) supported by the base station, cell timing for the base station and/or parameters for signals transmitted by the base station such as PRS signals. In the case of LTE access, the LPP A (LPPa) protocol may be used to transfer such messages between a base station that is an eNodeB and a location server that is an E-SMLC. In the case of NR access, the NRPPA protocol may be used to transfer such messages between a base station that is a gNodeB and a location server that is an LMF. It is noted that the terms “parameter” and “information element” (IE) are synonymous and are used interchangeably herein.

During positioning using signaling in LTE and 5G NR, a UE typically acquires dedicated positioning signals transmitted by base stations, referred to as a Positioning Reference Signals (PRS), which are used to generate the desired measurements for the supported positioning technique. Positioning Reference Signals (PRS) are defined for 5G NR positioning to enable UEs to detect and measure more neighbor base stations or Transmission and Reception Points (TRPs). Other types of signals, i.e., signals that are not dedicated for positioning, may be used by the UE for positioning. Several configurations are supported to enable a variety of deployments (indoor, outdoor, sub-6, mmW). To support PRS beam operation, beam sweeping is additionally supported for PRS. Table 1 below illustrates 3GPP release numbers (e.g., Rel.16 or Rel.15) that define particular reference signals for various UE measurements and the accompanying positioning techniques.

TABLE 1

| | | To facilitate support |
|---|---|---|
| DL/UL Reference | | of the following |
| Signals | UE Measurements | positioning techniques |
| Rel. 16 DL PRS | DL RSTD | DL-TDOA |
| Rel. 16 DL PRS | DL PRS RSRP | DL-TDOA, DL-AoD, |
| | | Multi-RTT |
| Rel. 16 DL PRS / Rel. 16 | UE Rx-Tx time | Multi-RTT |
| SRS for positioning | difference | |
| Rel. 15 SSB / CSI-RS | SS-RSRP(RSRP for | E-CID |
| for RRM | RRM), SS-RSRQ(for | |
| | RRM), CSI-RSRP (for | |
| | RRM), CSI-RSRQ (for | |
| | RRM) | |

During a location session, a location server and UE may exchange messages defined according to some positioning protocol in order to coordinate the determination of an estimated location. Possible positioning protocols may include, for example, the LTE Positioning Protocol (LPP) defined by 3GPP in 3GPP TS 36.355 and the LPP Extensions (LPPe) protocol defined by OMA in OMA TSs OMA-TS-LPPe-V1_0, OMA-TS-LPPe-V1_1 and OMA-TS-LPPe-V2_0. The LPP and LPPe protocols may be used in combination where an LPP message contains one embedded LPPe message. The combined LPP and LPPe protocols may be referred to as LPP/LPPe. LPP and LPP/LPPe may be used to help support the 3GPP control plane solution for LTE or NR access, in which case LPP or LPP/LPPe messages are exchanged between a UE and E-SMLC or between a UE and LMF. LPP or LPPe messages may be exchanged between a UE and E-SMLC via a serving Mobility Management Entity (MME) and a serving eNodeB for the UE. LPP or LPPe messages may also be exchanged between a UE and LMF via a serving Access and Mobility Management Function (AMF) and a serving NR Node B (gNB) for the UE. LPP and LPP/LPPe may also be used to help support the OMA SUPL solution for many types of wireless access that support IP messaging (such as LTE, NR and WiFi), where LPP or LPP/LPPe messages are exchanged between a SUPL Enabled Terminal (SET), which is the term used for a UE with SUPL, and an SLP, and may be transported within SUPL messages such as a SUPL POS or SUPL POS INIT message.

Positioning procedures, e.g., in the NG-RAN, are modelled as transactions of the LPP protocol. A procedure, for example, consists of a single operation of one of the following types: exchange of positioning capabilities; transfer of assistance data; transfer of location information (positioning measurements and/or position estimate); error handling; and abort.

The UE may be requested to perform periodic and triggered location measurements. For example, the UE may be required to perform location measurements and report the resulting location information, e.g., the measurements and/or a resulting estimate, based on detection of a periodic or triggered event. There are instances, however, when the UE is stationary or nearly stationary, and thus, there will be little or no change in the reported location information. Currently, in response to a periodic or triggered location request, the UE is required repeatedly report location information even if there are no changes, which requires UE resources, such as power resources, as well as network resources.

Accordingly, in one implementation, when the UE determines that one or more location measurements have little change with respect to the one or more location measurements as previously measured and reported, the UE may provide an indication to an entity in the wireless network that there is no update for the one or more location measurements. For example, the UE may provide an indication of no update to the location server or to a serving base station, which may provide an indication to the location server and/or an external client that there is no update to the location information. The UE, for example, may determine that there is little or no change in the one or more location measurements based on determining that a change in location of the UE is below a threshold, that the difference in location measurements is below a threshold, or that an accuracy quality of service is satisfied without updating the location information.

The indication that there is no update may be transmitted in a physical layer waveform, such a Physical Uplink Control Channel (PUCCH) message or a Physical Uplink Shared Channel (PUSCH) message. The indication that there is no update may be, e.g., a flag or a bit in the message that indicates that there is no update for the one or more location measurements. For example, the bit may indicate that there is no update for all location measurements, or a separate bit may be used to indicate each location measurement for which there is no update. In one implementation, the indication that there is no update for one or more location measurements may be provided by not sending a location report by the end of a configured report expiration timer.

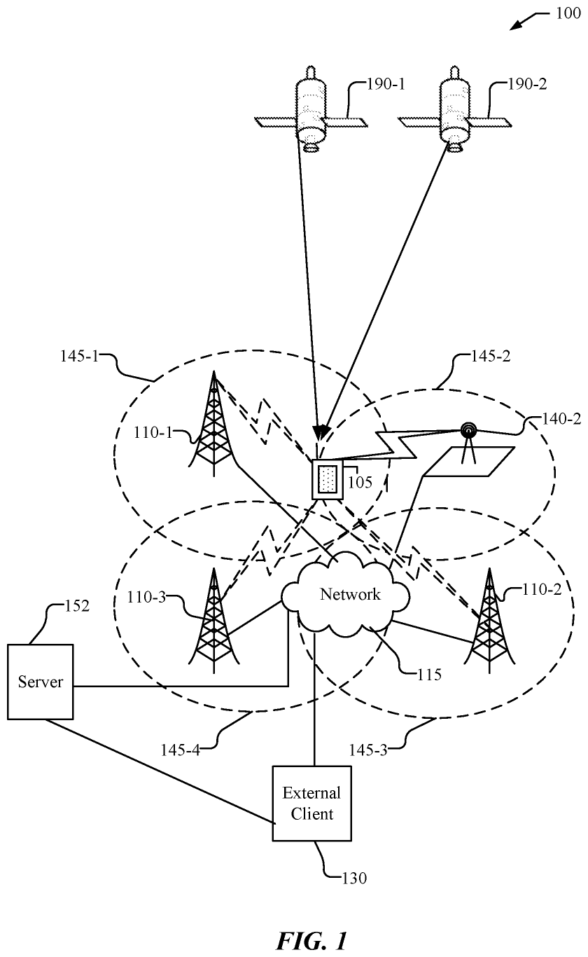

FIG. 1 shows a communication system 100 capable of providing location services to UE 105 using messages such as Long Term Evolution (LTE) Positioning Protocol (LPP) or LPP extensions (LPPe) messages between a UE 105 and a server 152, which, in some instances, may take the form of a location server, such a Location Management Function (LMF), or another network entity and is referred to here as a location server 152 or LMF 152. LPP is well-known and described in various publicly available technical specifications from 3GPP. LPPe has been defined by the Open Mobile Alliance (OMA) and may be used in combination with LPP such that each combined LPP/LPPe message would be an LPP message comprising an embedded LPPe message.

For simplicity, only one UE 105 and location server 152 are shown in FIG. 1. In general, communication system 100 may comprise multiple cells indicated by 145-k (0≤k≤Ncells, where Ncells is the number of cells) with one or more networks 115, external clients 130, UEs 105, base stations 110 with antennas, and Space Vehicles (SVs) 190. Communication system 100 may further comprise a mix of cells including macrocells such as cells 145-1, 145-3, and 145-4 along with femtocells such as cell 145-2 in a manner consistent with embodiments disclosed herein.

UE 105 may be capable of wirelessly communicating with location server 152 through network 115 (or through multiple networks 115) that support positioning and location services. For example, location services (LCS) may be performed on behalf of the external client 130, sometimes referred to as an LCS client 130, that accesses location server 152 and/or network 115 and issues a request for the location of UE 105. Location server 152 or network 115 may then respond to LCS client 130 with a location estimate for UE 105. LCS Client 130 may also be known as a Secure User Plane Location (SUPL) Agent—e.g. when the location solution used by location server 152 and UE 105 is the SUPL solution defined by OMA. In some embodiments, UE 105 may also include an LCS Client or a SUPL agent that may issue a location request to some positioning capable function within UE 105 and later receive back a location estimate for UE 105. The LCS Client or SUPL Agent within UE 105 may perform location services for the user of UE 105—e.g. provide navigation directions or identify points of interest within the vicinity of UE 105.

As illustrated in FIG. 1, the UE 105 may communicate with location server 152 through network 115 and base stations 110, which may be associated with network 115. UE 105 may receive and measure signals from antennas for base stations 110, which may be used for position determination. For example, UE 105 may receive and measure signals from antennas for one or more of base stations 110-1, 110-2, 110-3 and/or 110-4, which may be associated with cells 145-1, 145-2, 145-3 and 145-4, respectively. In some embodiments, base stations 110 may form part of a wireless communication network, which may be a wireless wide area network (WWAN), wireless local area network (WLAN), a wireless personal area network (WPAN), and so on. The term “network” and “system” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, Long Term Evolution (LTE), WiMax and so on.

UE 105 may also receive signals from one or more Earth orbiting Space Vehicles (SVs) 190-1 or 190-2 collectively referred to as SVs 190, which may be part of a satellite positioning system (SPS). SVs 190, for example, may be in a constellation of Global Navigation Satellite System (GNSS) such as the US Global Positioning System (GPS), the European Galileo system, the Russian Glonass system or the Chinese BeiDou system. In accordance with certain aspects, the techniques presented herein are not restricted to global systems (e.g., GNSS) for SPS. For example, the techniques provided herein may be applied to or otherwise enabled for use in various regional systems, such as, e.g., Quasi-Zenith Satellite System (QZSS) over Japan, Indian Regional Navigational Satellite System (IRNSS) over India, and/or various augmentation systems (e.g., a Satellite Based Augmentation System (SBAS)) that may be associated with or otherwise enabled for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GP S Aided Geo Augmented Navigation or GP S and Geo Augmented Navigation system (GAGAN), and/or the like. Thus, as used herein an SPS may include any combination of one or more global and/or regional navigation satellite systems and/or augmentation systems, and SP S signals may include SP S, SP S-like, and/or other signals associated with such one or more SPS.

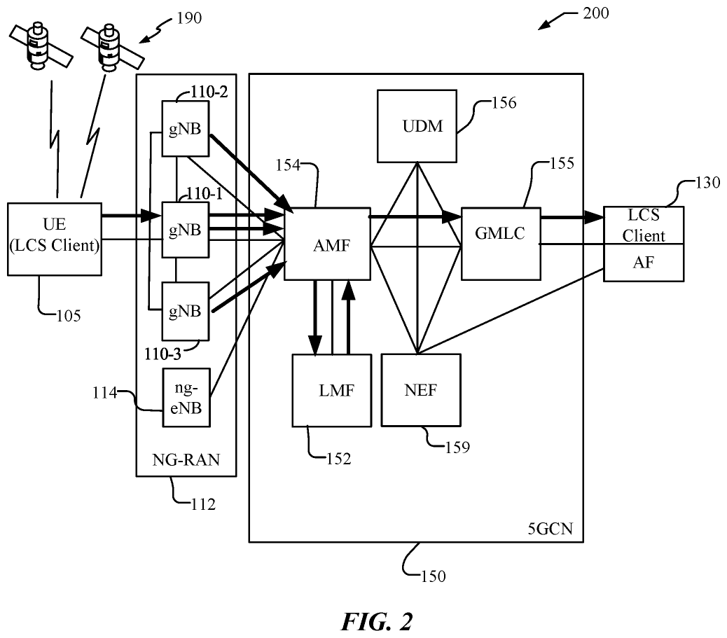

FIG. 2 is a simplified block diagram illustrating an architecture of a communication system 200 capable of providing location services to UE 105 as discussed herein. Communication system 200 may be one example of the communication system 100 in FIG. 1. The non-roaming communication system 200 comprises a UE 105 and components of a Fifth Generation (5G) network comprising a Next Generation Radio Access Network (NG-RAN) 112, which includes base stations (BSs) sometimes referred to as New Radio (NR) NodeBs or gNBs 110-1, 110-2 and 110-3 (collectively and generically referred to herein as gNBs 110), and a 5G Core Network (5GCN) 150 that is in communication with an external client 130. A 5G network may also be referred to as a New Radio (NR) network; NG-RAN 112 may be referred to as an NR RAN or a 5G RAN; and 5GC 150 may be referred to as a Next Generation (NG) Core network (NGC). As an example, NG-RAN 112 may include one or more next generation eNBs (ng-eNBs) 114 which provide LTE wireless access to UE 105. Standardization of an NG-RAN and 5GC has been performed by 3GPP. The communication system 200 may further utilize information from satellite vehicles (SVs) 190 for a Global Navigation Satellite System (GNSS) like GPS, GLONASS, Galileo or Beidou or some other local or regional Satellite Positioning System (SPS) such as IRNSS, EGNOS or WAAS. Additional components of the communication system 200 are described below. The communication system 200 may include additional or alternative components.

It should be noted that FIG. 2 provides only a generalized illustration of various components, any or all of which may be utilized as appropriate, and each of which may be duplicated or omitted as necessary. Specifically, although only one UE 105 is illustrated, it will be understood that many UEs (e.g., hundreds, thousands, millions, etc.) may utilize the communication system 200. Similarly, the communication system 200 may include a larger or smaller number of SVs 190, gNBs 110, ng-eNBs 114, external clients 130, and/or other components. The illustrated connections that connect the various components in the communication system 200 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 2 illustrates a 5G-based network, similar network implementations and configurations may be used for other communication technologies, such as 3G, Long Term Evolution (LTE), IEEE 802.11 WiFi etc.

The UE 105, as used herein, may be any electronic device and may be referred to as a device, a mobile device, a wireless device, a mobile terminal, a terminal, a mobile station (MS), a Secure User Plane Location (SUPL) Enabled Terminal (SET), or by some other name. Moreover, UE 105 may correspond to a smart watch, digital glasses, fitness monitor, smart car, smart appliance, cellphone, smartphone, laptop, tablet, PDA, tracking device, control device or some other portable or moveable device. The UE 105 may include a single entity or may include multiple entities such as in a personal area network where a user may employ audio, video and/or data I/O devices and/or body sensors and a separate wireline or wireless modem. Typically, though not necessarily, the UE 105 may support wireless communication using one or more Radio Access Technologies (RATs) such as GSM, Code Division Multiple Access (CDMA), Wideband CDMA (WCDMA), LTE, High Rate Packet Data (HRPD), IEEE 802.11 WiFi (also referred to as Wi-Fi), Bluetooth® (BT), Worldwide Interoperability for Microwave Access (WiMAX), 5G new radio (NR) (e.g., using the NG-RAN 112 and 5GC 150), etc. The UE 105 may also support wireless communication using a Wireless Local Area Network (WLAN) which may connect to other networks (e.g. the Internet) using a Digital Subscriber Line (DSL) or packet cable for example. The use of one or more of these RATs may allow the UE 105 to communicate with an external client 130, which may be an LCS client or an application function (AF), (e.g. via elements of 5GC 150 not shown in FIG. 2, or possibly via a Gateway Mobile Location Center (GMLC) 155) and/or allow the external client 130 to receive location information regarding the UE 105 (e.g., via the GMLC 155 or Network Exposure Function (NEF) 159).

The UE 105 may enter a connected state with a wireless communication network that may include the NG-RAN 112. In one example, the UE 105 may communicate with a cellular communication network by transmitting wireless signals to, or receiving wireless signals from a cellular transceiver, in the NG-RAN 112, such as a gNB 110 or ng-eNB 114. A transceiver provides user and control planes protocol terminations toward the UE 105 and may be referred to as a base station, a base transceiver station, a radio base station, a radio transceiver, a radio network controller, a transceiver function, a base station subsystem (BSS), an extended service set (ESS), or by some other suitable terminology.

In particular implementations, the UE 105 may have circuitry and processing resources capable of obtaining location related measurements. Location related measurements obtained by UE 105 may include measurements of signals received from SVs 190 belonging to an SPS or Global Navigation Satellite System (GNSS) such as GPS, GLONASS, Galileo or Beidou and/or may include measurements of signals received from terrestrial transmitters fixed at known locations (e.g., such as gNBs 110 or ng-eNB 114). UE 105 or a separate location server (e.g. LMF 152), to which UE 105 may send the measurements, may then obtain a location estimate for the UE 105 based on these location related measurements using any one of several position methods such as, for example, GNSS, Assisted GNSS (A-GNSS), Advanced Forward Link Trilateration (AFLT), Observed Time Difference Of Arrival (OTDOA), WLAN (also referred to as WiFi) positioning, or Enhanced Cell ID (ECID) or combinations thereof. In some of these techniques (e.g. A-GNSS, AFLT and OTDOA), pseudoranges or timing differences may be measured by UE 105 relative to three or more terrestrial transmitters (e.g. gNBs 110) fixed at known locations or relative to four or more satellites 190 with accurately known orbital data, or combinations thereof, based at least in part, on pilots, positioning reference signals (PRS) or other positioning related signals transmitted by the transmitters or satellites and received at the UE 105. Here, a location server, such as the LMF 152, may be capable of providing positioning assistance data to UE 105 including, for example, information regarding signals to be measured (e.g., expected signal timing, signal coding, signal frequencies, signal Doppler, muting configuration), locations and identities of terrestrial transmitters (e.g. gNBs 110) and/or signal, timing and orbital information for GNSS SVs 190 to facilitate positioning techniques such as A-GNSS, AFLT, TDOA, RTT, ECID, etc. The facilitation may include improving signal acquisition and measurement accuracy by UE 105 and, in some cases, enabling UE 105 to compute its estimated location based on the location measurements. For example, location servers may comprise an almanac which indicates locations and identities of cellular transceivers and/or local transceivers in a particular region or regions such as a particular venue, and may provide information descriptive of signals transmitted by a cellular base station or access point (AP) (e.g. a gNB 110) such as transmission power and signal timing. A UE 105 may obtain measurements of signal strengths (e.g. received signal strength indication (RSSI)) for signals received from cellular transceivers and/or local transceivers and/or may obtain a signal to noise ratio (SN), a reference signal received power (RSRP), a reference signal received quality (RSRQ), a time of arrival (TOA), or a round trip signal propagation time (RTT) between UE 105 and a cellular transceiver (e.g. a gNB 110) or a local transceiver (e.g. a WiFi AP). A UE 105 may transfer these measurements to a location server, such as LMF 152, to determine a location for UE 105, or in some implementations, may use these measurements together with assistance data (e.g. terrestrial almanac data or GNSS satellite data such as GNSS Almanac and/or GNSS Ephemeris information) received from a location server (e.g. LMF 152) or broadcast by a base station (e.g. a gNB 110 or ng-eNB 114) in NG-RAN 112 to determine a location for UE 105.

The UE 105 may measure one or more of a Reference Signal Time Difference (RSTD), a Receive-Transmit (Rx-Tx) time difference, an Angle of Arrival (AOA), a Round Trip signal propagation Time (RTT), an Angle of Departure (AOD), a Reference Signal Strength Indication (RSSI), a Reference Signal Received Power (RSRP), a Reference Signal Received Quality (RSRQ). For example, in the case of OTDOA, UE 105 may measure a Reference Signal Time Difference (RSTD) between signals such as a position reference signal (PRS), Cell specific Reference Signal (CRS), or Tracking Reference Signal (TRS) transmitted by nearby pairs of transceivers and/or base stations (e.g. gNBs 110). An RSTD measurement may provide the time of arrival difference between signals (e.g. TRS, CRS or PRS) received at UE 105 from two different transceivers. The UE 105 may return the measured RSTDs to a location server (e.g. LMF 152) which may compute an estimated location for UE 105 based on known locations and known signal timing for the measured transceivers. In some implementations of OTDOA, the signals used for RSTD measurements (e.g. PRS or CRS signals) may be accurately synchronized by the transceivers to a common universal time such as GPS time or Coordinated Universal Time (UTC), e.g., using a GPS receiver at each transceiver to accurately obtain the common universal time.

An estimate of a location of the UE 105 may be referred to as a location, location estimate, location fix, fix, position, position estimate or position fix, and may be geographic, thus providing location coordinates for the UE 105 (e.g., latitude and longitude) which may or may not include an altitude component (e.g., height above sea level, height above or depth below ground level, floor level or basement level). Alternatively, a location of the UE 105 may be expressed as a civic location (e.g., as a postal address or the designation of some point or small area in a building such as a particular room or floor). A location of the UE 105 may also be expressed as an area or volume (defined either geographically or in civic form) within which the UE 105 is expected to be located with some probability or confidence level (e.g., 67%, 95%, etc.). A location of the UE 105 may further be a relative location comprising, for example, a distance and direction or relative X, Y (and Z) coordinates defined relative to some origin at a known location which may be defined geographically, in civic terms, or by reference to a point, area, or volume indicated on a map, floor plan or building plan. In the description contained herein, the use of the term location may comprise any of these variants unless indicated otherwise. When computing the location of a UE, it is common to solve for local x, y, and possibly z coordinates and then, if needed, convert the local coordinates into absolute ones (e.g. for latitude, longitude and altitude above or below mean sea level).

As shown in FIG. 2, pairs of gNBs 110 in NG-RAN 112 may be connected to one another, e.g., directly as shown in FIG. 2 or indirectly via other gNBs 110. Access to the 5G network is provided to UE 105 via wireless communication between the UE 105 and one or more of the gNBs 110, which may provide wireless communication access to the 5GC 150 on behalf of the UE 105 using 5G (e.g. NR). In FIG. 2, the serving gNB for UE 105 is assumed to be gNB 110-1, although other gNBs (e.g. gNB 110-2 and/or gNB 110-3) may act as a serving gNB if UE 105 moves to another location or may act as a secondary gNB to provide additional throughout and bandwidth to UE 105. Some gNBs 110 in FIG. 2 (e.g. gNB 110-2 or gNB 110-3) may be configured to function as positioning-only beacons which may transmit signals (e.g. directional PRS) to assist positioning of UE 105 but may not receive signals from UE 105 or from other UEs.

As noted, while FIG. 2 depicts nodes configured to communicate according to 5G communication protocols, nodes configured to communicate according to other communication protocols, such as, for example, the LTE protocol, may be used. Such nodes, configured to communicate using different protocols, may be controlled, at least in part, by the 5GC 150. Thus, the NG-RAN 112 may include any combination of gNBs, eNBs, or other types of base stations or access points. As an example, NG-RAN 112 may include one or more next generation eNBs (ng-eNBs) 114 which provide LTE wireless access to UE 105 and may connect to entities in 5GC 150 such as AMF 154.

The gNBs 110 and/or the ng-eNB 114 can communicate with the Access and Mobility Management Function (AMF) 154, which, for positioning functionality, communicates with a Location Management Function (LMF) 152. The AMF 154 may support mobility of the UE 105, including cell change and handover and may participate in supporting a signaling connection to the UE 105 and possibly helping establish and release Protocol Data Unit (PDU) sessions for UE 105. Other functions of AMF 154 may include: termination of a control plane (CP) interface from NG-RAN 112; termination of Non-Access Stratum (NAS) signaling connections from UEs such as UE 105, NAS ciphering and integrity protection; registration management; connection management; reachability management; mobility management; access authentication and authorization.

The LMF 152 may support positioning of the UE 105 when UE 105 accesses the NG-RAN 112 and may support position procedures/methods such as Assisted GNSS (A-GNSS), Observed Time Difference of Arrival (OTDOA), Real Time Kinematics (RTK), Precise Point Positioning (PPP), Differential GNSS (DGNSS), Enhanced Cell ID (ECID), angle of arrival (AOA), angle of departure (AOD), WLAN positioning, and/or other position methods. The LMF 152 may also process location services requests for the UE 105, e.g., received from the AMF 154. In some embodiments, a node/system that implements the LMF 152 may additionally or alternatively implement other types of location-support modules, such as an Enhanced Serving Mobile Location Center (E-SMLC) or a Secure User Plane Location (SUPL) Location Platform (SLP). It will be noted that in some embodiments, at least part of the positioning functionality (including derivation of UE 105's location) may be performed at the UE 105 (e.g., using measurements of signals transmitted by wireless nodes, and assistance data provided to the UE 105). The LMF 152 may be referred to by other names such as a Location Manager (LM), Location Function (LF), commercial LMF (CLMF) or value added LMF (VLMF). In some implementations, a Location Management Component (LMC) within a node in the NG-RAN 112, such as in serving gNB 110-1, may perform a location server functions. An LMC may be referred to by other names such as a “location function”, “location management function” (LMF), local LMF, RAN LMF, NG-RAN LMF.

The GMLC 155 may support a location request for the UE 105 received from an external client 130 and may forward such a location request to the AMF 154, which may in turn forward the location request to the LMF 152. A location response from the LMF 152 (e.g. containing a location estimate for the UE 105) may be similarly returned to the GMLC 155 via the AMF 154, and the GMLC 155 may then return the location response (e.g., containing the location estimate) to the external client 130. GMLC 155 may contain subscription information for an external client 130 and may authenticate and authorize a location request for UE 105 from external client 130. GMLC 155 may further initiate a location session for UE 105 by sending a location request for UE 105 to AMF 154 and may include in the location request an identity for UE 105 and the type of location being requested (e.g. such as a current location or a sequence of periodic or triggered locations).

The LMF 152 and the gNBs 110 may communicate using a New Radio Positioning Protocol A (which may be referred to as NPPa or NRPPa). NRPPa may be defined in 3GPP Technical Specification (TS) 38.455, with NRPPa messages being transferred between the gNBs 110 and the LMF 152 via the AMF 154. The LMF 152 and UE 105 may communicate using the LTE Positioning Protocol (LPP) defined in 3GPP TS 36.355, where LPP messages are transferred between the UE 105 and the LMF 152 via the AMF 154 and a serving gNB 110-1 for UE 105. For example, LPP messages may be transferred between the LMF 152 and the AMF 154 using service based operations and may be transferred between the AMF 154 and the UE 105 using a 5G Non-Access Stratum (NAS) protocol. The LPP protocol may be used to support positioning of UE 105 using UE assisted and/or UE based position methods such as A-GNSS, RTK, WLAN, OTDOA and/or ECID. The NRPPa protocol may be used to support positioning of UE 105 using network based position methods such as ECID (when used with measurements obtained by a gNB 110) and/or may be used by LMF 152 to obtain location related information from gNBs 110 such as parameters defining positioning reference signal (PRS) transmission from gNBs 110 for support of OTDOA.

With a UE assisted position method, UE 105 may obtain location measurements (e.g. measurements of RSSI, RTT, RSTD, AOA, AOD, RSRP and/or RSRQ for gNBs 110, ng-eNBs 114 or WLAN APs, or measurements of GNSS pseudorange, code phase and/or carrier phase for SVs 190) and send the measurements to a location server (e.g. LMF 152) for computation of a location estimate for UE 105. With a UE based position method, UE 105 may obtain location measurements (e.g. which may be the same as or similar to location measurements for a UE assisted position method) and may compute a location of UE 105 (e.g. with the help of assistance data received from a location server such as LMF 152 or broadcast by gNBs 110, ng-eNBs 114 or other base stations or APs). With a network based position method, one or more base stations (e.g. gNBs 110 and/or ng-eNBs 114) or APs may obtain location measurements (e.g. measurements of RSSI, RTT, RSRP, RSRQ or TOA for signals transmitted by UE 105) and/or may receive measurements obtained by UE 105, and may send the measurements to a location server (e.g. LMF 152) for computation of a location estimate for UE 105.

Information provided by the gNBs 110 to the LMF 152 using NRPPa may include timing and configuration information for PRS transmission and location coordinates of the gNBs 110. The LMF 152 can then provide some or all of this information to the UE 105 as assistance data in an LPP message via the NG-RAN 112 and the 5GC 150.

An LPP message sent from the LMF 152 to the UE 105 may instruct the UE 105 to do any of a variety of things, depending on desired functionality. For example, the LPP message could contain an instruction for the UE 105 to obtain measurements for GNSS (or A-GNSS), WLAN, and/or OTDOA (or some other position method). In the case of OTDOA, the LPP message may instruct the UE 105 to obtain one or more measurements (e.g. RSTD measurements) of PRS signals transmitted within particular cells supported by particular gNBs 110 (or supported by one or more ng-eNBs 114 or eNBs). The UE 105 may send the measurements back to the LMF 152 in an LPP message (e.g. inside a 5G NAS message) via the serving gNB 110-1 and the AMF 154. Additionally, the LPP message may be a periodic and triggered location request instructing the UE 105 to perform and report periodic or triggered positioning measurements.

In some embodiments, LPP may be augmented by or replaced by an NR or NG positioning protocol (NPP or NRPP) which supports position methods such as OTDOA and ECID for NR radio access. For example, an LPP message may contain an embedded NPP message or may be replaced by an NPP message.

When NG-RAN 112 includes one or more ng-eNBs 114, an ng-eNB 114 may communicate with LMF 152 using NRPPa in order to support positioning of UE 105 (e.g. using a network based position method) and/or may enable transfer of LPP and/or NPP messages between UE 105 and LMF 152 via the ng-eNB 114 and AMF 154. An ng-eNB 114 and/or a gNB 110 in NG-RAN 112 may also broadcast positioning assistance data to UEs such as UE 105.

As illustrated, a Unified Data Management (UDM) 156 may be connected to the GMLC 155. The UDM 156 is analogous to a Home Subscriber Server (HSS) for LTE access, and if desired, the UDM 156 may be combined with an HSS. The UDM 156 is a central database that contains user-related and subscription-related information for UE 105 and may perform the following functions: UE authentication, UE identification, access authorization, registration and mobility management, subscription management and Short Message Service management. Additionally, the GMLC 155 may be connected to a Location Retrieval Function (LRF) (not shown), which handles retrieval of location information for the UE 105 and may be used to provide location information for UE 105 to an external client 130 that is a Public Safety Answering Point, e.g. following an emergency call from UE 105 to the P SAP.

To support services including location services from external clients 130 for Internet of Things (IoT) UEs, a Network Exposure Function (NEF) 159 may be included. The NEF 159, for example, may function to obtain a current or last known location for a UE 105, may obtain an indication of a change in location for a UE 105, or an indication of when a UE 105 becomes available (or reachable). An external client 130 (e.g. an external client 130 that is an Application Function) may access NEF 159 in order to obtain location information for UE 105. The NEF 159 may be connected to the GMLC 155 to support last known location, current location and/or deferred periodic and triggered location for the UE 105. If desired, the NEF 159 may include, or may be combined with, the GMLC 155, and may then obtain location information for UE 105 from LMF 152 via AMF 154.

During positioning, there are a large number of “hops” or communication between network elements in the communications system 200 from the time the LMF 152 sends the location request to the UE 105, to the time when an external client 130 receives a positioning estimate. For example, as illustrated with arrows, the UE 105 communicates with the serving gNB 110-1, which forwards the communication to the AMF 154. Each gNB 110 may additionally separately communicate with the AMF 154. The AMF 154 provides the measurement information from the UE 105 and each gNB 110 to the LMF 152, which processes the measurement information and determines a position estimate for the UE 105, which is returned to the AMF 154. The AMF 154 provides the position estimate to the GMLC 155, which is forwarded to the external client 130. Assuming, for example, a 3 msec average latency for each hop, and a 1 msec of positioning calculation at the LMF 152, there may be a latency of 25 msec.

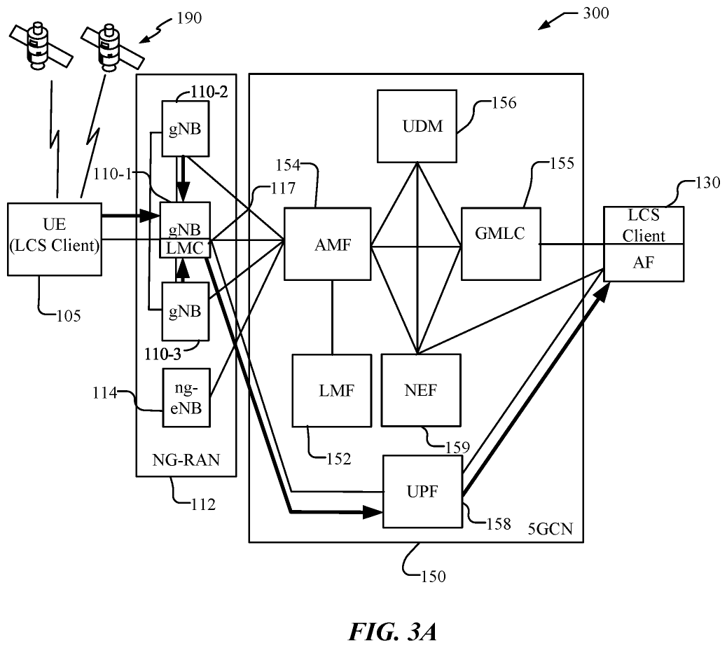

FIG. 3A illustrates a simplified block diagram illustrating an architecture of a communication system 300 that is similar to the communication system 200 shown in FIG. 2, like designated elements being the same. The communication system 300 supports reduced latency for positioning.

As illustrated, the communication system 300 includes a User Plane Function (UPF) 158 that is connected to the gNB 110-1 and the external client 130. The UPF 158 may support voice and data bearers for UE 105 and may enable UE 105 voice and data access to other networks such as the internet. UPF 158 functions may include: external PDU session point of interconnect to a Data Network, packet (e.g. Internet Protocol (IP)) routing and forwarding, packet inspection and user plane part of policy rule enforcement, Quality of Service (QoS) handling for user plane, downlink packet buffering and downlink data notification triggering.

As illustrated, the serving gNB 110-1 may include LMC 117, which may perform one or more location server functions. The LMC 117 may support some or all of the same functions as LMF 152, with the difference that LMC 117 is located in NG-RAN 112, whereas LMF 152 is located in 5GCN 150. Positioning of a UE 105 by a serving gNB 110 can be used to provide a location service to a UE 105, serving AMF 154 or LMF 152 and to improve NG-RAN operation—e.g. by reducing the latency of position determination and increasing the number of UEs 105 for which location can be supported.

FIG. 3B shows an architecture diagram of an NG-RAN node 110 that may be within an NG-RAN 112 in FIG. 2 or 3A, e.g., as a separate entity or as part of another gNB. The NG-RAN node 110 may be a gNB, according to one implementation. The architecture shown in FIG. 3B, for example, may be applicable to any gNB 110 in FIG. 2 or 3A.

As illustrated, gNB 110 may include a gNB Central Unit (gNB-CU) 182, a gNB Distributed Unit (gNB-DU) 184, a gNB Remote Unit (gNB-RU) 186, which may be physically co-located in the gNB 110 or may be physically separate. The gNB-CU 182 is a logical or physical node hosting support for Radio Resource Control (RRC), Service Data Adaptation Protocol (SDAP) and Packet Data Convergence Protocol (PDCP) protocols of the gNB 110 used over the NR Uu air interface and controlling the operation of one or more gNB-DUs and/or gNB-RUs. The gNB-CU 182 terminates an F1 interface connected with a gNB-DU and in some implementations, an F1 interface connected with a gNB-RU. As illustrated, the gNB-CU 182 may communicate with an AMF via an NG interface. The gNB-CU 182 may further communicate with one or more other gNBs 110 via an Xn interface. The gNB-DU 184 is a logical or physical node hosting support for Radio Link Control (RLC), Medium Access Control (MAC) and Physical (PHY) protocol layers used over the NR Uu air interface of the gNB 110, operation of which is partly controlled by gNB-CU 182. The gNB-DU terminates the F1 interface connected with the gNB-CU 182, and may terminate a lower layer split point interface Fx with a gNB-RU. The gNB-RU 186 may be based on a lower layer function split and is a logical or physical node hosting support for lower layer functions, such as PHY and Radio Frequency (RF) protocol layers used over the NR Uu air interface of the gNB 110, operation of which is partly controlled by gNB-CU 182 and/or gNB-DU 184. The gNB-RU 186 terminates the Fx interface connected with the gNB-DU 184 and in some implementations may terminate the F1 interface connected with the gNB-CU 182.

The gNB-CU 182 requests positioning measurements (e.g. E-CID) to the gNB-DU 184 and/or gNB-RU 186. The gNB-DU 184 and/or gNB-RU 186 may report the measurements back to the gNB-CU 182. A gNB-DU 184 or gNB-RU 186 may include positioning measurement functionality. It should be understood that a separate measurement node is not precluded.

Additionally, as illustrated in FIG. 3B, gNB 110 may include a Transmission Point (TP) 192 and a Reception Point (RP) 196 combined into a Transmission Reception Point (TRP) 194, which may be physically or logically located in the gNB 110. The gNB-CU 182 may be configured to communicate with the TP 192 and RP 196, e.g., via F1 interfaces. The gNB-CU 182, thus, controls one or more TPs 192 and RPs 196 which are accessible from the gNB-CU 182 via an F1 interface.

In some embodiments, the NG-RAN node 110 (or gNB 110) may comprise a subset of the elements shown in FIG. 3B. For example, the NG-RAN node 110 may comprise the gNB-CU 182 but may not include one or more of gNB-DU 184 and gNB-RU 186, RP 196, or TP 192. Alternatively, NG-RAN node 110 may include one or more of gNB-DU 184 and, RP 196 or TP 192 but may not include gNB-RU 186. Further, the elements shown in FIG. 3B may be logically separate but physically co-located or may be partially or completely physically separate. For example, one or more of gNB-DU 184 and/or gNB-RU 186, RP 196 or TP 192 may be physically separate from gNB-CU 182 or may be physically combined with gNB-CU 182. In the case of physical separation, the F1 or Fx interface may define signaling over a physical link or connection between two separated elements. In some implementations, gNB-CU 182 may be split into a control plane portion (referred to as a CU-CP or gNB-CU-CP) and a user plane portion (referred to as CU-UP or gNB-CU-UP). In this case, both the gNB-CU-CP and gNB-CU-UP may interact with gNB-DU 184 and/or gNB-RU 186 to support NR Uu air interface signaling for control plane and user plane, respectively. However, only the gNB-CU-CP may interact with TPs 192 and RPs 196 to support and control location related communication.

Protocol layering between the gNB-CU 182 and the TP 192, and RP 196 may be based on F1 C as defined in 3GPP TS 38.470, which uses an F1 Application Protocol (F1AP) at the top level as specified in 3GPP TS 38.473. New messages to support positioning could be added directly into F1AP or could be introduced in a new location specific protocol which is transported using F1AP.

The location procedures with the gNB-CU 182 may comprise all location related procedures on NG, Xn, and NR-Uu interfaces. For example, the location procedures between AMF 154 and the NG-RAN node 110 may use NGAP. The location procedures between NG-RAN node 110 and other NG-RAN nodes, e.g., gNBs 110, may use XnAP or a protocol above XnAP, such as an extended NR Positioning Protocol A (NRPPa) as defined in 3GPP TS 38.455. The location procedures between NG-RAN node 110 and UE 104 may use RRC and/or LPP.

The corresponding messages to support positioning may be carried inside a transparent F1AP message transfer container. For example, the Transfer of an NGAP Location Reporting Control and NAS Transport message may be carried in an UL/DL NGAP Message Transfer. The Transfer of location related XnAP messages may be carried in an UL/DL XnAP Message Transfer. The Transfer of location related RRC(LPP) messages may be carried in an UL/DL RRC (LPP) Message Transfer.

As illustrated, with a location function in the NG-RAN 112, the number of “hops” or communications between network elements for positioning of the UE 105 is reduced relative to the communications system 200 shown in FIG. 2. For example, as illustrated with arrows, the UE 105 communicates with the serving gNB 110-1, and the gNBs 110-2 and 110-3 communicate with the serving gNB 110-1, which includes the LMC 117. The LMC 117 may determine a position estimate for the UE 105 based on the positioning measurements provided by the UE 105 and gNBs 110. The serving gNB 110-1 with the LMC 117 communicates with the UPF 158, which forwards the communication to the external client 130. By reducing the distances travelled between network nodes, the protocol conversions and message encoding and decoding, and the number of active network elements/routers/switches traversed between the UE 105 and external client 130, the latency and network resources used relative to the communication system 200 may be reduced.

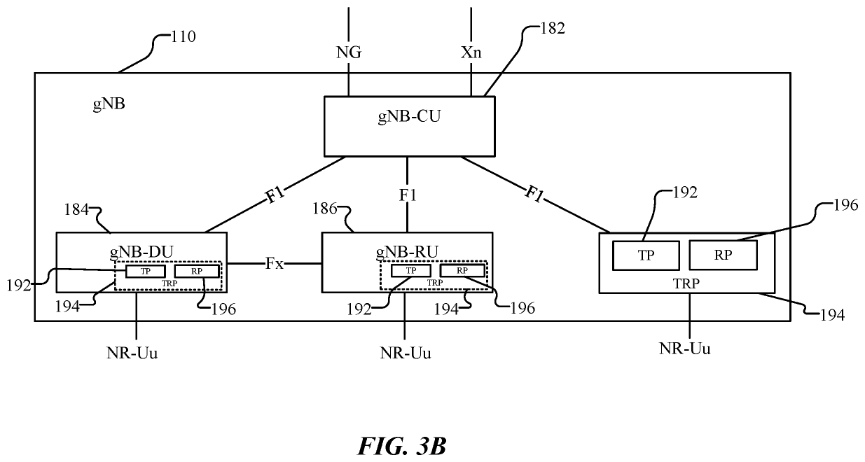

FIG. 4 shows a block diagram of a design 400 of base station 110 and UE 105, which may be one of the base stations and one of the UEs in FIGS. 1, 2, and 3. Base station 110 may be equipped with T antennas 434a through 434t, and UE 105 may be equipped with R antennas 452a through 452r, where in general T≥1 and R≥1.

At base station 110, a transmit processor 420 may receive data from a data source 412 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 420 may also process system information (e.g., for semi-static resource partitioning information (SRPI) and/or the like) and control information (e.g., CQI requests, grants, upper layer signaling, and/or the like) and provide overhead symbols and control symbols. Transmit processor 420 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 430 may perform spatial processing (e.g., precoding) on the data symbols, the control symbols, the overhead symbols, and/or the reference symbols, if applicable, and may provide T output symbol streams to T modulators (MODs) 432a through 432t. Each modulator 432 may process a respective output symbol stream (e.g., for OFDM and/or the like) to obtain an output sample stream. Each modulator 432 may further process (e.g., convert to analog, amplify, filter, and upconvert) the output sample stream to obtain a downlink signal. T downlink signals from modulators 432a through 432t may be transmitted via T antennas 434a through 434t, respectively. According to various aspects described in more detail below, the synchronization signals can be generated with location encoding to convey additional information.

At UE 105, antennas 452a through 452r may receive the downlink signals from base station 110 and/or other base stations and may provide received signals to demodulators (DEMODs) 454a through 454r, respectively. Each demodulator 454 may condition (e.g., filter, amplify, down convert, and digitize) a received signal to obtain input samples. Each demodulator 454 may further process the input samples (e.g., for OFDM and/or the like) to obtain received symbols. A MIMO detector 456 may obtain received symbols from all R demodulators 454a through 454r, perform MIMO detection on the received symbols if applicable, and provide detected symbols. A receive processor 458 may process (e.g., demodulate and decode) the detected symbols, provide decoded data for UE 105 to a data sink 460, and provide decoded control information and system information to a controller/processor 480. A channel processor may determine reference signal received power (RSRP), received signal strength indicator (RSSI), reference signal received quality (RSRQ), channel quality indicator (CQI), and/or the like. In some aspects, one or more components of UE 105 may be included in a housing.

On the uplink, at UE 105, a transmit processor 464 may receive and process data from a data source 462 and control information (e.g., for reports comprising RSRP, RSSI, RSRQ, CQI, and/or the like) from controller/processor 480. Transmit processor 464 may also generate reference symbols for one or more reference signals. The symbols from transmit processor 464 may be precoded by a TX MIMO processor 466 if applicable, further processed by modulators 454a through 454r (e.g., for DFT-s-OFDM, CP-OFDM, and/or the like), and transmitted to base station 110. At base station 110, the uplink signals from UE 105 and other UEs may be received by antennas 434, processed by demodulators 432, detected by a MIMO detector 436 if applicable, and further processed by a receive processor 438 to obtain decoded data and control information sent by UE 105. Receive processor 438 may provide the decoded data to a data sink 439 and the decoded control information to controller/processor 440. Base station 110 may include communication unit 444 and communicate to location server 152 via communication unit 444 (and any intervening network components, e.g., such as AMF 154 (shown in FIG. 2). Location server 152 may include communication unit 494, controller/processor 490, and memory 492.

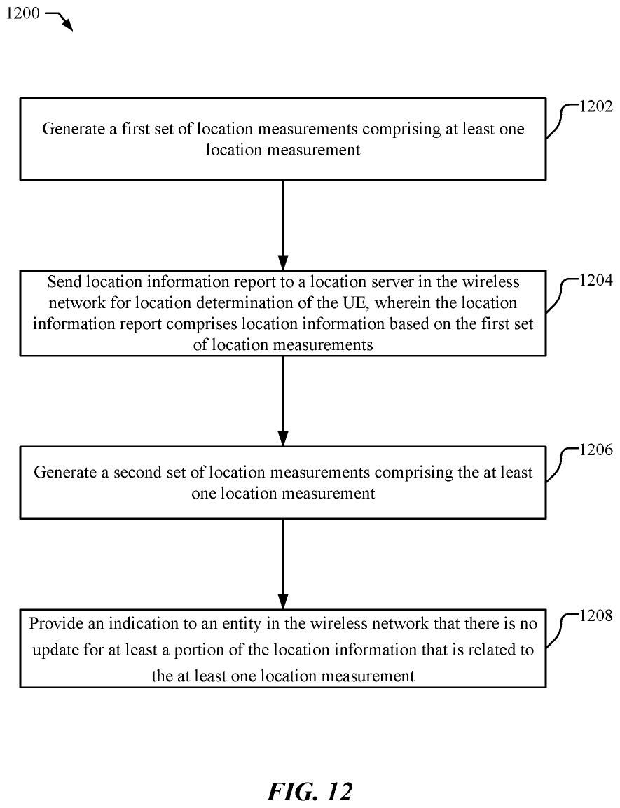

Controller/processor 440 of base station 110, controller/processor 480 of UE 105, controller/processor 490 of location server 152, and/or any other component(s) of FIG. 4 may perform one or more techniques associated with support positioning of the UE using indications that there is no update to positioning information, as described in more detail elsewhere herein. For example, controller/processor 480 of UE 105, controller/processor 440 of base station 110, controller/processor 490 of location server 152, and/or any other component(s) of FIG. 4 may perform or direct operations of, for example, process 1200, 1300, and 1400 of FIGS. 12, 13, and 14, and/or other processes as described herein. Memories 442, 482, and 492 may store data and program codes for base station 110, UE 105, and location server 152, respectively. In some aspects, memory 442 and/or memory 482 and/or memory 392 may comprise a non-transitory computer-readable medium storing one or more instructions for wireless communication. For example, the one or more instructions, when executed by one or more processors of the UE 105, base station 110, and/or location server 152 may perform or direct operations of, for example, process 1200, 1300, and 1400 of FIGS. 12, 13, and 14 and/or other processes as described herein. A scheduler 446 may schedule UEs for data transmission on the downlink and/or uplink.

As indicated above, FIG. 4 is provided as an example. Other examples may differ from what is described with regard to FIG. 4.

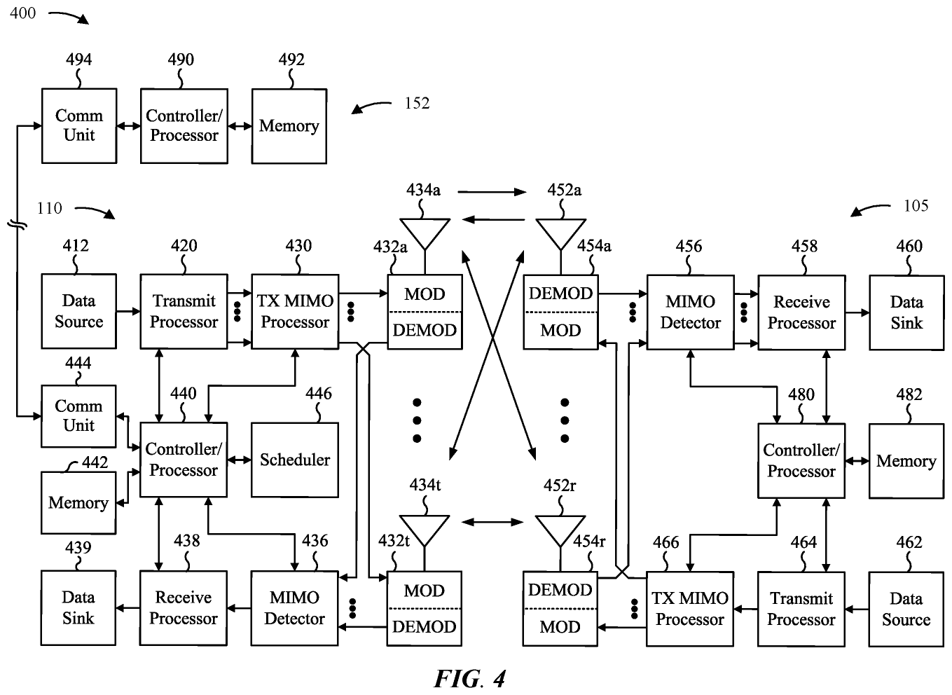

FIG. 5 illustrates a simple message flow 500 for location information between the UE 105 and a location server 502, which may be the location server 152 shown in FIGS. 1, 2, and 3A, or the LMC 117 shown in FIG. 3A.

At stage 1, the location server 502 sends a RequestLocationInformation message to the UE 105 to request location information from the UE 105. The request may indicate the type of location information needed and potentially the associated quality of service (QoS). For example, the request may be for a periodic and triggered location.

At stage 2, the UE 105 sends a ProvideLocationInformation message to the location server 502 to transfer location information, e.g., after generating the requested positioning measurements and/or location estimate if requested. The location information transferred may match or be a subset of the location information requested in stage 1. In some implementations, the server may allow location information in addition to that requested to be sent from the UE 105. If stage 3 does not occur, the message at stage 2 may set the endTransaction IE to TRUE.

At stage 3, if requested in stage 1, e.g., in a periodic or triggered location requestion, the UE 105 sends additional ProvideLocationInformation messages to the location server 502 to transfer location information after generating the requested positioning measurements and/or location estimate if requested. The location information transferred may match or be a subset of the location information requested in stage 1. In some implementations, the server may allow location information in addition to that requested to be sent from the UE 105. The last message may include the endTransaction IE set to TRUE.

The request for location information, e.g., provided at stage 1 of FIG. 5, may include an indication of the type of location information needed, and may indicate whether the periodic or triggered reporting is requested. For example, an information element (IE) may be used to indicate that triggered reporting is requested. For example, triggered reporting may be indicated based on cell change, e.g., the UE 105 is required to provide requested location information each time the primary cell has changed. Other types of trigger events may be specified if desired. The triggered reporting indication may further include a reporting duration parameter, which is the maximum duration of triggered reporting in seconds. For example, a value of zero may indicate an unlimited (i.e. “infinite”) duration. The UE 105 may continue triggered reporting for the reporting duration or until an LPP Abort or LPP Error message is received. The triggered reporting field may not be used by the location server and may be ignored by the UE 105 if the periodical reporting is requested.

A periodic and triggered location request may include an indication for periodical reporting. For example, an information element (IE) may be used to indicate that periodic reporting is requested. For example, the UE 105 may be provided with a reporting amount, which indicates the number of periodic location information reports requested. For example, enumerated values correspond to 1, 2, 4, 8, 16, 32, 64, or infinite/indefinite number of reports. If the reporting amount is ‘infinite/indefinite’, the UE 105 may continue periodic reporting until an LPP Abort message is received. Additionally, the UE 105 may be provided with a reporting interval that indicates the interval between location information reports and the response time requirement for the first location information report. For example, enumerated values of the reporting intervals may include 1, 2, 4, 8, 10, 16, 20, 32, and 64 seconds. Measurement reports containing no measurements or no location estimate are currently required when a reporting interval expires before a UE 105 is able to obtain new measurements or obtain a new location estimate. There is currently no provision for a UE 105 to send an indication that no report is provided.

The request for location information, e.g., provided at stage 1 of FIG. 5, may further include the quality of service (QoS) associated with the location information. The QoS information element may include a number of sub-fields. In the case of measurements, some of the sub-fields apply to the location estimate that could be obtained by the location server from the measurements provided by the UE 105 assuming that the measurements are the only sources of error. For example, various fields may include the maximum horizontal error in the location estimate at an indicated confidence level, whether a vertical coordinate is required, the maximum vertical error in the location estimate at an indicated confidence level if a vertical coordinate is requested. The QoS information element may further include a responseTime field that includes a time subfield, which indicates the maximum response time as measured between receipt of the RequestLocationInformation and transmission of a ProvideLocationInformation. The maximum response time, for example, may be an integer number of seconds between 1 and 128 or a units of 10-seconds, between 10 and 1280 seconds. If the location request includes periodical reporting, the response time field may not be included by the location server and may be ignored by the UE 105. The responseTime field further includes a responseTimeEarlyFix subfield that indicates the maximum response time as measured between receipt of the RequestLocationInformation and transmission of a ProvideLocationInformation containing early location measurements or an early location estimate. When the response time early fix IE is included, a UE 105 may send a ProvideLocationInformation (or more than one ProvideLocationInformation if location information will not fit into a single message) containing early location information according to the responseTimeEarlyFix IE and a subsequent ProvideLocationInformation (or more than one ProvideLocationInformation if location information will not fit into a single message) containing final location information according to the time IE. A UE 105 may omit sending a ProvideLocationInformation if the early location information is not available at the expiration of the time value in the responseTimeEarlyFix IE. A location server may set the responseTimeEarlyFix IE to a value less than that for the time IE. A UE 105 may ignore the responseTimeEarlyFix IE if its value is not less than that for the time IE.

A QoS information element may further include a velocityRequest field that indicates whether velocity (or measurements related to velocity) is requested, a horizontalAccuracyExt field that indicates the maximum horizontal error in the location estimate at an indicated confidence level, and a verticalAccuracyExt field that indicates the maximum vertical error in the location estimate at an indicated confidence level and is only applicable when a vertical coordinate is requested.

All QoS requirements are to be obtained by the UE 105 to the degree possible but the UE 105 is permitted to return a response that does not fulfill all QoS requirements if some were not attainable. Currently, however, the single exception is time which the UE 105 is required to always fulfill—even if that means not fulfilling other QoS requirements.

Thus, currently, a UE is required to always send a position report by the maximum response time, per QoS requirements and at the interval required for the periodical reporting. There is no provision for the UE 105 to provide no positioning report. Positioning reports, however, may be relatively large. Table 2 below, for example, illustrates positioning information provided in an NR-DL-TDOA-SignalMeasurementInformation IE.

TABLE 2
NR-DL-TDOA-SignalMeasurementInformation-r16 ::= SEQUENCE {

| | |
|---|---|
| dl-PRS-ReferenceInfo-r16 | DL-PRS-ID-Info-r16, |
| nr-DL-TDOA-MeasList-r16 | NR-DL-TDOA-MeasList-r16, |

...
}
DL-PRS-ID-Info-r16 ::= SEQUENCE {

| | |
|---|---|
| dl-PRS-ID-r16 | INTEGER (0..255), |
| nr-DL-PRS-ResourceID-List-r16 | SEQUENCE (SIZE |

```
      (1..nrMaxResourceIDs-r16)) OF NR-DL-PRS-ResourceID-r16
      OPTIONAL,
```

| | |
|---|---|
| nr-DL-PRS-ResourceSetID-r16 | NR-DL-PRS-ResourceSetID-r16 |

```
      OPTIONAL
}
NR-DL-TDOA-MeasList-r16 ::= SEQUENCE (SIZE(1..nrMaxTRPs-r16)) OF
      NR-DL-TDOA-MeasElement-r16
NR-DL-TDOA-MeasElement-r16 ::= SEQUENCE {
```

| dl-PRS-ID-r16 | INTEGER (0..255), | |
|---|---|---|
| nr-PhysCellID-r16 | NR-PhysCellID-r16 | OPTIONAL, |
| nr-CellGlobalID-r16 | NCGI-r15 | OPTIONAL, |
| nr-ARFCN-r16 | ARFCN-ValueNR-r15 | OPTIONAL, |

| | |
|---|---|
| nr-DL-PRS-ResourceID-r16 | NR-DL-PRS-ResourceID-r16 |

OPTIONAL,

| | |
|---|---|
| nr-DL-PRS-ResourceSetID-r16 | NR-DL-PRS-ResourceSetID-r16 |

OPTIONAL,

| | |
|---|---|
| nr-TimeStamp-r16 | NR-TimeStamp-r16, |
| nr-RSTD-r16 | CHOICE { |
| k0-r16 | INTEGER (0..1970049), |
| k1-r16 | INTEGER (0..985025), |
| k2-r16 | INTEGER (0..492513), |
| k3-r16 | INTEGER (0..246257), |
| k4-r16 | INTEGER (0..123129), |
| k5-r16 | INTEGER (0..61565), |

```
    ...
  }
```

| nr-AdditionalPathList-r16 | NR-AdditionalPathList-r16 | OPTIONAL, |
|---|---|---|
| nr-TimingQuality-r16 | NR-TimingQuality-r16, | |
| nr-DL-PRS-RSRP-Result-r16 | INTEGER (0..126) | OPTIONAL, |

nr-DL-TDOA-AdditionalMeasurements-r16

| | |
|---|---|
| NR-DL-TDOA-AdditionalMeasurements-r16 | OPTIONAL, |

...
}

Table 3 below, for example, illustrates additional positioning information that may be provided in an NR-DL-TDOA-AdditionalMeasurement IE.

TABLE 3
NR-DL-TDOA-AdditionalMeasurements-r16 ::= SEQUENCE (SIZE (1..3)) OF
NR-DL-TDOA-AdditionalMeasurementElement-r16
NR-DL-TDOA-AdditionalMeasurementElement-r16 ::= SEQUENCE {

| | |
|---|---|
| nr-DL-PRS-ResourceID-r16 | NR-DL-PRS-ResourceID-r16 |

OPTIONAL,

| | |
|---|---|
| nr-DL-PRS-ResourceSetID-r16 | NR-DL-PRS-ResourceSetID-r16 |

OPTIONAL,

| | |
|---|---|
| nr-TimeStamp-r16 | NR-TimeStamp-r16, |
| nr-RSTD-ResultDiff-r16 | CHOICE { |
| k0-r16 | INTEGER (0..8191), |
| k1-r16 | INTEGER (0..4095), |
| k2-r16 | INTEGER (0..2047), |
| k3-r16 | INTEGER (0..1023), |
| k4-r16 | INTEGER (0..511), |
| k5-r16 | INTEGER (0..255), |

```
    ...
  },
```

| | |
|---|---|
| nr-TimingQuality-r16 | NR-TimingQuality-r16, |
| nr-DL-PRS-RSRP-ResultDiff-r16 | INTEGER (0..61) |

OPTIONAL,

| | |
|---|---|
| nr-AdditionalPathList-r16 | NR-AdditionalPathList-r16 |

OPTIONAL,
...
}

Table 4 below, for example, illustrates the number of TRPs, PRS resources, and PRS resource sets, which may be included in each positioning information report.

TABLE 4

| | |
|---|---|
| nrMaxTRPs-r16 | INTEGER := 256 |

```
NR-DL-PRS-ResourceID-r16 ::= INTEGER (0.. nrMaxNumDL-PRS-
  ResourcesPerSet-1)
nrMaxNumDL-PRS-ResourcesPerSet = 64
NR-DL-PRS-ResourceSetID-r16 ::= INTEGER (0.. nrMaxNumDL-PRS-
  ResourceSetsPerTRP-1)
```

| | |
|---|---|
| nrMaxNumDL-PRS-ResourceSetsPerTRP | INTEGER ::= 8 |

Thus, the TDOA measurement report may be resource intensive. Table 5, for example, illustrates the various fields, usage, bit length, and whether a field is optional in a TDOA measurement report.

TABLE 5

| Field | Usage | Bit-Length | Optional |
|---|---|---|---|
| DL-PRS-IdInfo-r16 | Reference PRS-ID | 8 | No |
| Quality Metric of | Quality of the | 7 | No |
| Reference TOA | Reference TOA | | |
| PRS-ID | PRS ID of the TRP | 8 | No |
| | of the target cell | | |
| nr-RSTD-r16 | RSTD value | 3 + [16-21] = [19-24] | No |
| nr-TimeStamp-r16 | Time stamp | [14, 17]: 10 bits (SFN) + | No |
| | | {4, 5, 6, 7} bits for different | |
| | | SCS | |
| Quality Metric for | Quality metric | 7 | No |
| RSTD | | | |
| nr-DL-PRS- | PRS resource set of | 6 | Yes |
| ResourceId-r16 | the Target cell | | |
| NR-DL-PRS- | Resource of the | 3 | Yes |
| ResourceSetId-r16 | target cell | | |
| DL-PRS-IdInfo-r16 | Reference | <=64*6 + 3 = 387 | Yes |
| | Resource/Set for the | | |
| | RSTD | | |

For each RSTD, there may be up to 63 PRS-ID, RSTD, RSTD, TimeStamp, Quality Metric, PRS-ResourceID, and PRS-ResourceSetID per layer. As illustrated, for each RSTD, Quality Metric, and Time-stamp, the mandatory fields correspond to 48-56 bits. The Quality Metric for Reference TOA is 7 bits and the Reference PRS-ID is 8 bits. Thus, for example, for reporting 10 RSTDs, there may be between 495-575 bits depending on the RSTD granularity and the sub-carrier spacing (SCS).

Accordingly, it can be seen that the requirement that UE must always send a position report by the maximum response time, per QoS requirements, and at the interval required for the periodical reporting is resource intensive. In cases where the UE 105 has little or no change in location between position reports, for example, there will be little or no difference in the positioning measurements. Currently, however, the UE 105 is required to use network resources to report the subsequent positioning measurements. Moreover, due to the number of “hops” or communications between network entities, as illustrated in FIG. 2, there may be a relatively large latency for the external client 130 to receive an indication that there is no change in position for the UE 105.

In one implementation, when the UE 105 determines that there is little or no change in one or more location measurements between measurement reports, e.g., stage 2 and stage 3 shown in FIG. 5, the UE 105 may provide an indication to an entity in the wireless network that there is no update for the one or more location measurements.

For example, for a UE 105 that is not moving, or moving less than a threshold, or a UE 105 that can meet the configured or requested accuracy QoS with a lower reporting periodicity than is configured or requested, the UE 105 may send a physical layer waveform to a network entity, e.g., the serving base station 110-1 or location server 152 that indicates that there is “No update in Positioning Measurement”, or “No changes within a specific tolerance”. The indication that there is no update in one or more location measurements may be transmitted in a physical layer waveform, such a Physical Uplink Control Channel (PUCCH) message or a Physical Uplink Shared Channel (PUSCH) message.

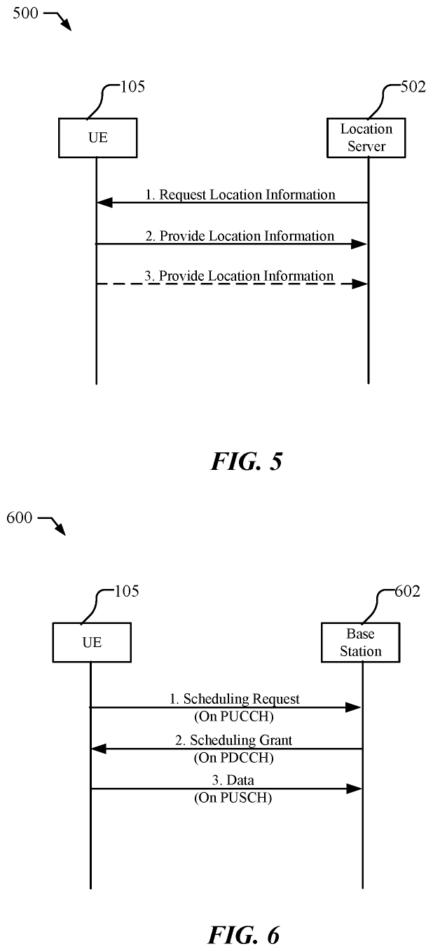

FIG. 6 illustrates a simple message flow 600 illustrating transmission of PUCCH and PUSCH messages between the UE 105 and a base station 602, which may be the serving gNB 110-1, shown in FIGS. 1, 2, and 3A, as part of a scheduling procedure.

At stage 1 of FIG. 6, the UE 105 may send a scheduling request (SR) to the base station 602 on a PUCCH channel. The SR is a special Physical Layer message with which the UE 105 requests the base station 602 to send an uplink (UL) Grant so that UE 105 may transmit PUSCH messages that may include data. For example, whenever there is data to be transmitted, which may include positioning information, the UE 105 requests that the base station 602 providing an uplink grant using the SR message over PUCCH channel.

At stage 2, the base station 602 replies to the UE with an uplink grant in DCI 0_0 or DCI 0_1 message over a Physical Downlink Control Channel (PDCCH) channel.

At stage 3, the UE 105 may transmit data over the PUSCH channel.

Thus, in one implementation, the indication that there is no update in one or more location measurements may be transmitted to the serving base station 110-1 in a PUCCH message, e.g., similar to the SR message in stage 1 of FIG. 6. For example, a new PUCCH format may be used for the UE 105 to report that there is no update to the one or more location measurements. The indication that there is no update, for example, may be provided with a single bit, e.g., in the preamble, that indicates that there is no update for all of the location measurements.

In one implementation, the indication that there is no update in one or more location measurements may be transmitted to the serving base station 110-1 in a PUSCH channel, which may be a semi-persistent PUSCH channel, e.g., according to a grant configuration, such as illustrated at stage 3 of FIG. 6. For example, the serving base station 602 may configure the UE 105 with a configuration grant PUSCH (CG-PUSCH), and whenever the UE 105 considers that an indication that there is no update in one or more location measurements needs to be sent, the UE 105 may use the available PUSCH resource to transmit the indication. The indication that there is no update, for example, may be provided with a single bit, e.g., in the preamble, that indicates that there is no update for all of the location measurements.

In one implementation, the indication that there is no update in one or more location measurements may be transmitted to the serving base station 110-1 in a combination of a PUCCH channel and a CG-PUSCH channel. For example, the UE 105 may inform the network entity that there are no updates to the one or more location measurements using the PUCCH channel, and may send an on-demand request using the PUSCH channel with what should be the next opportunity or what should be the periodicity of the report in the future. In some implementations, the UE 105 may inform the network entity that there are no updates to the one or more location measurements using the CG-PUSCH channel, and may send an on-demand request using the PUCCH channel with what should be the next opportunity or what should be the periodicity of the report in the future.

In some implementations, the indication that there is no update may be provided with a single bit, e.g., in the preamble, that indicates that there is no update for all of the location measurements. In another implementation, the bit may be used to signal that the UE 105 will only send the measurements that have changed compared to the previous report, and that the remaining measurements are still valid.

In one implementation, the indication that there is no update in one or more location measurements may be transmitted to the serving base station 110-1 in a PUSCH channel that carries the positioning report. For example, the UE 105 may indicate that there is no update to the location measurements by transmitting only the DeModulation Reference Signal (DMRS) of the PUSCH and providing no data symbols.

In implementations, where the indication that there is no update is provided to the serving base station 110-1, as opposed to the location server 152, the serving base station 110-1 may inform the location server 152 that no update is provided by the UE 105 through NRPPa signaling.

In one implementation, the indication that there is no update in one or more location measurements may be transmitted to the location server 152. The UE 105, for example, may send a bitmap that includes an indication, e.g., by setting a bit to 1, for each measurement that is the same as before or, e.g., setting the bit to 0, for the measurements that are not the same. The length of the bitmap, for TDOA, for example, may be equal to nrMaxTRPs-r16 as shown in Tables 2 and 4, but it may also be the same as the number of MeasElements that were included in the previous report.

In one implementation, the indication that there is no update in one or more location measurements may be provided the location server 152 by not sending a positioning report to the location server 152 by the by the end of a configured report expiration timer. The location server 152 may determine that the positioning measurement is the same as a previous one, e.g., using the “reportTime” as an expiration timer. For example, if the location server 152 has not received any report by the end of the configured report expiration timer, e.g., the “reportTime”, the location server 152 may determine that measurements have not changed. The location server 152 and the serving base station 110-1 may communicate to confirm that the UE 105 is still connected.

The UE 105 may determine that there is little or no change in the one or more location measurements based on determining that movement, e.g., a change in location, of the UE is below a threshold, or that the difference in location measurements is below a threshold, or that an accuracy quality of service is satisfied without updating the location information. The UE 105 may be configured with the tolerance that the measurements need to be within, in order to be allowed to not report within the configured “reportTime”. For example, the location server 152 may provide the thresholds or req

The UE 105 may be configured (or allowed) to avoid skipping a report for at most X times consecutively. For example, the location server 152 may provide a number of consecutive location information reports that the UE 105 may provide an indication of no update.

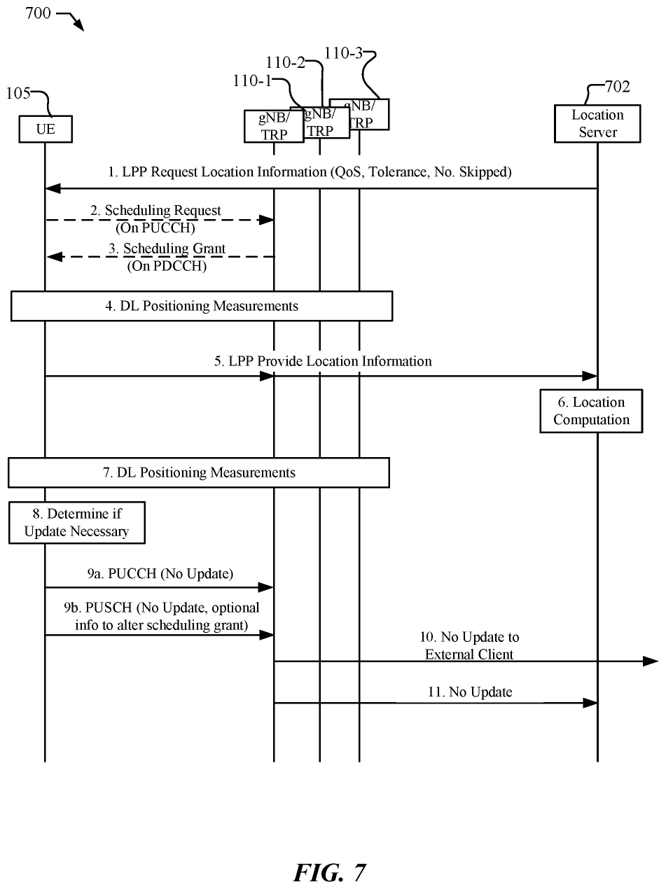

FIG. 7 is a message flow 700 illustrating the messaging between the UE 105, the serving gNB/TRP 110-1, and location server 702. The serving gNB 110-1 and neighboring gNBs 110-2, 110-3 may be sometimes collectively referred to as gNBs 110. The location server 702, for example, may be the LMF 152, or LMC 117 illustrated in FIGS. 1, 2, and 3A, or another entity, such as an E-SMLC or SLP. The procedure illustrated in FIG. 7 may be used with DL terrestrial positioning measurements from gNBs 110, such as RSTD, RSRP, Rx-Tx time difference measurements for TDOA, AoD, and Multi-RTT positioning techniques, and/or GNSS measurements. It should be understood that FIG. 7 illustrates messages that may be transmitted during a position session but may not include all messages or actions performed during the positioning session. For example, capability messages and assistance data may be transmitted between the location server 702 and UE 105.

At stage 1 in FIG. 7, the location server 702 sends an LPP Request Location Information message to the UE 105. The message may include, e.g., the type of location measurements, the desired accuracy, response time, etc. The message may indicate that periodic or triggered location reports are requested. For example, the message may include the quality of service (QoS), the tolerance (e.g., thresholds for determining that no update should be provided), and the number of consecutive location information reports that may be skipped.

At stage 2, the UE 105 may send a scheduling request (SR) to the base station 110-1 on a PUCCH channel. The SR may be sent to obtain an UL grant so that UE 105 may can transmit PUSCH messages that may include positioning information data.

At stage 3, the serving gNB 110-1 may reply to the UE 105 with an uplink scheduling grant in DCI 0_0 or DCI 0_1 message over a Physical Downlink Control Channel (PDCCH) channel.

At stage 4, the UE 105 performs the requested measurements using signals, e.g., PRS, transmitted by the gNBs 110 and/or signals transmitted from GNSS SVs 190, not shown in FIG. 7. For example, location measurements may be one or more of a Reference Signal Time Difference (RSTD), a Receive-Transmit (Rx-Tx) time difference, an Angle of Arrival (AOA), a Round Trip signal propagation Time (RTT), an Angle of Departure (AOD), a Reference Signal Strength Indication (RSSI), a Reference Signal Received Power (RSRP), a Reference Signal Received Quality (RSRQ) or GNSS measurements. In some implementations, the UE 105 may further determine a location estimate based on the positioning measurements.

At stage 5, the UE 105 may provide location information to the location server 702, via the serving gNB 110-1. For example, the location information may be in a LPP Provide Location Information that is transmitted to the serving gNB 110-1 and the serving gNB 110-1 forwards to the location server 702. For example, the UE 105 may provide the positioning measurements acquired at stage 4. Alternatively, the UE 105 may determine a position estimate based on positioning measurements acquired at state 4 and assistance data received from the location server 152, and may provide the position estimate, and optionally, the positioning measurements to the location server 702.

At stage 6, the location server 702 may determine (or verify) the UE location using the received location information from stage 5. For example, the location server 702 may calculate a position estimate for the UE 105 based on the positioning measurements provided at stage 5, along with any additional information provided by gNBs 110. Where the UE 105 provides a position estimate at state 5, the location server 702 may verify the position estimate, based on positioning measurements provided by the UE 105 at stage 5, along with any additional information provided by gNBs 110.

At stage 7, for a periodic or triggered location request, the UE 105 performs requested measurements using signals, e.g., PRS, transmitted by the gNBs 110 and/or signals transmitted from GNSS SVs 190, not shown in FIG. 7. For example, location measurements may be one or more of a Reference Signal Time Difference (RSTD), a Receive-Transmit (Rx-Tx) time difference, an Angle of Arrival (AOA), a Round Trip signal propagation Time (RTT), an Angle of Departure (AOD), a Reference Signal Strength Indication (RSSI), a Reference Signal Received Power (RSRP), a Reference Signal Received Quality (RSRQ) or GNSS measurements. In some implementations, the UE 105 may further determine a location estimate based on the positioning measurements.

At stage 8, the UE 105 may determine if an update to the location information is necessary. For example, the UE 105 may determine if a change in location of the UE 105 between generating the first set of location measurements, e.g., at stage 4, and generating the second set of location measurements, at state 7, is below a threshold. For example, the UE 105 may determine based on inertial measurement sensors, whether movement or a change in location of the UE 105 exceeds a threshold provided with the request for location information at stage 1. In another example, the UE 105 may determine whether a change in location measurements from stage 4 with respect to the location measurements at stage 7 is exceeds a threshold provided with the request for location information at stage 1. In another example, the UE 105 may determine whether the accuracy quality of service requirement, e.g. received with the request for location information at stage 1, is satisfied without updating the at least one positioning measurement.

At stage 9a, the UE 105 may provide an indication that there is no update to at least a portion of the location information, such as one or more location measurements and/or a location estimate, to the serving gNB 110-1 in in a PUCCH channel. The PUCCH message, for example, may be similar to a SR message in stage 1 of FIG. 6. For example, a new PUCCH format may be used for the UE 105 to report that there is no update to the one or more location measurements. The indication that there is no update, for example, may be provided with a single bit, e.g., in the preamble, that indicates that there is no update for all of the location measurements. In another implementation, a bit may can be used to signal that the UE 105 will only send the measurements that have changed compared to the previous report, and that the remaining measurements are still valid, e.g., are unchanged.

At stage 9b, the UE 105 may provide an indication that there is no update to at least a portion of the location information, such as one or more location measurements and/or a location estimate, to the serving gNB 110-1 in in a PUSCH channel. For example, the indication that there is no update may be provided in a semi-persistent PUSCH channel, e.g., according to a grant configuration, such as provide in the scheduling grant at stage 3. For example, the serving base station 110-1 may configure the UE 105 with a configuration grant PUSCH (CG-PUSCH) at stage 3, and the UE 105 may consider, based on the determination from stage 8, that an indication that there is no update in one or more location measurements needs to be sent and may use the available PUSCH resource to transmit the indication. The indication that there is no update, for example, may be provided with a single bit, e.g., in the preamble, that indicates that there is no update for all of the location measurements. In another implementation, a bit may can be used to signal that the UE 105 will only send the measurements that have changed compared to the previous report, and that the remaining measurements are still valid, e.g., are unchanged. In another implementation, the indication that there is no update may be a message, such as a DMRS message, that includes no data symbols.

In some implementations, both stage 9a and 9b may be used to transmit the indication that there is no update in one or more location measurements. For example, the UE 105 may inform the serving gNB 110-1 that there are no updates to the one or more location measurements using the PUCCH channel in stage 9a, and may send an on-demand request using the PUSCH channel in stage 9b with what should be the next opportunity or what should be the periodicity of the report in the future. In some implementations, the UE 105 may inform the serving base station 110-1 that there are no updates to the one or more location measurements using the CG-PUSCH channel, and may send an on-demand request using the PUCCH channel with what should be the next opportunity or what should be the periodicity of the report in the future.

For example, in one implementation, the indication that there is no update in one or more location measurements may be transmitted to the serving gNB 110-1 in a PUSCH channel, e.g., in stage 9, that carries a positioning report. For example, the UE 105 may indicate that there is no update to the location measurements by transmitting only the DeModulation Reference Signal (DMRS) of the PUSCH and providing no data symbols in the report provided at stage 9.

At stage 10, the serving gNB 110-1 may provide an update to the externa client 130 (not shown in FIG. 7) to indicate that change in the position of the UE 105 has occurred. For example, the LMC 117 in the serving gNB 110-1 may receive the positioning measurements, or the indication of no change in the positioning measurements, and may provide an indication that the position of the UE 105 has not changed with respect to the previously determined position of the UE 105. The LMC 117 in the serving gNB 110-1 may cause the serving gNB-1 to provide an indication to the external client 130, e.g., via the UPF 158 (as shown in FIG. 3A), the that position of the UE 105 has not changed.

At stage 11, the serving gNB 110-1 may further provide an indication to the location server 702 that no update of the positioning measurements have been made.

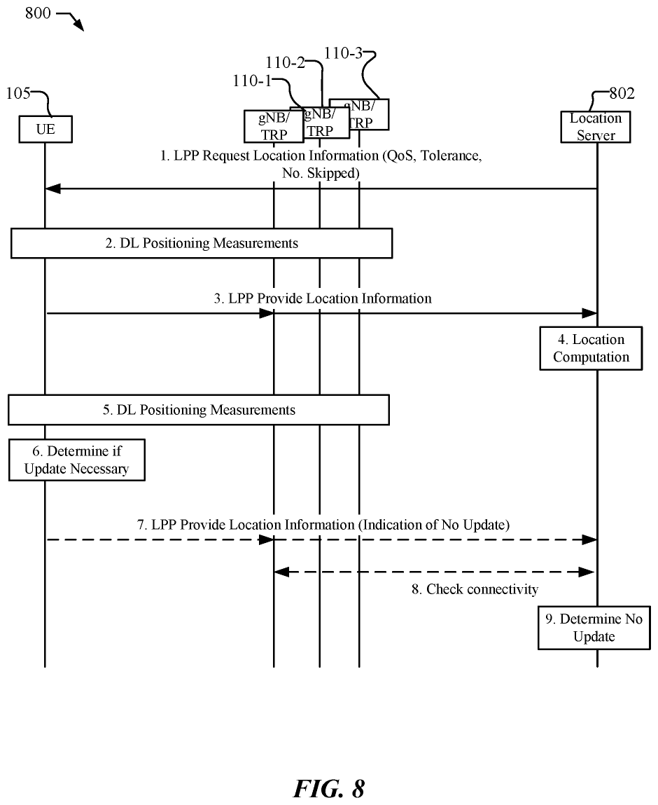

FIG. 8 is a message flow 800 illustrating the messaging between the UE 105, the serving gNB/TRP 110-1, and location server 802. The location server 802, for example, may be the LMF 152, or LMC 117 illustrated in FIGS. 1, 2, and 3A, or another entity, such as an E-SMLC or SLP. The message flow 800 of FIG. 8 is similar to the message flow 700 shown in FIG. 7, but the UE 105 provides an indication that there is no update in one or more location measurements to the location server 802, rather than the serving gNB 110-1. It should be understood that FIG. 8 illustrates messages that may be transmitted during a position session but may not include all messages or actions performed during the positioning session. For example, capability messages and assistance data may be transmitted between the location server 802 and UE 105.

At stage 1 in FIG. 8, the location server 802 sends an LPP Request Location Information message to the UE 105. The message may include, e.g., the type of location measurements, the desired accuracy, response time, etc. The message may indicate that periodic or triggered location reports are requested. For example, the message may include the quality of service (QoS), the tolerance (e.g., thresholds for determining that no update should be provided), and the number of consecutive location information reports that may be skipped.

At stage 2, the UE 105 performs the requested measurements using signals, e.g., PRS, transmitted by the gNBs 110 and/or signals transmitted from GNSS SVs 190, not shown in FIG. 8. For example, location measurements may be one or more of a Reference Signal Time Difference (RSTD), a Receive-Transmit (Rx-Tx) time difference, an Angle of Arrival (AOA), a Round Trip signal propagation Time (RTT), an Angle of Departure (AOD), a Reference Signal Strength Indication (RSSI), a Reference Signal Received Power (RSRP), a Reference Signal Received Quality (RSRQ) or GNSS measurements. In some implementations, the UE 105 may further determine a location estimate based on the positioning measurements.

At stage 3, the UE 105 may provide location information to the location server 802, via the serving gNB 110-1. For example, the location information may be in a LPP Provide Location Information that is transmitted to the serving gNB 110-1 and the serving gNB 110-1 forwards to the location server 802. For example, the UE 105 may provide the positioning measurements acquired at stage 2. Alternatively, the UE 105 may determine a position estimate based on positioning measurements acquired at state 2 and assistance data received from the location server 152, and may provide the position estimate, and optionally, the positioning measurements to the location server 802.

At stage 4, the location server 802 may determine (or verify) the UE location using the received location information from stage 3. For example, the location server 802 may calculate a position estimate for the UE 105 based on the positioning measurements provided at stage 3, along with any additional information provided by gNBs 110. Where the UE 105 provides a position estimate at stage 3, the location server 802 may verify the position estimate, based on positioning measurements provided by the UE 105 at stage 3, along with any additional information provided by gNBs 110.

At stage 5, for a periodic or triggered location request, the UE 105 performs requested measurements using signals, e.g., PRS, transmitted by the gNBs 110 and/or signals transmitted from GNSS SVs 190, not shown in FIG. 8. For example, location measurements may be one or more of a Reference Signal Time Difference (RSTD), a Receive-Transmit (Rx-Tx) time difference, an Angle of Arrival (AOA), a Round Trip signal propagation Time (RTT), an Angle of Departure (AOD), a Reference Signal Strength Indication (RSSI), a Reference Signal Received Power (RSRP), a Reference Signal Received Quality (RSRQ) or GNSS measurements. In some implementations, the UE 105 may further determine a location estimate based on the positioning measurements.

At stage 6, the UE 105 may determine if an update to the location information is necessary. For example, the UE 105 may determine if a change in location of the UE 105 between generating the first set of location measurements, e.g., at stage 2, and generating the second set of location measurements, at stage 5, is below a threshold. For example, the UE 105 may determine based on inertial measurement sensors, whether movement, e.g., a change in location, of the UE 105 exceeds a threshold provided with the request for location information at stage 1. In another example, the UE 105 may determine whether a change in location measurements from stage 2 with respect to the location measurements at stage 5 is exceeds a threshold provided with the request for location information at stage 1. In another example, the UE 105 may determine whether the accuracy quality of service requirement, e.g. received with the request for location information at stage 1, is satisfied without updating the at least one positioning measurement.

At stage 7, the UE 105 may provide an indication that there is no update to at least a portion of the location information, such as one or more location measurements and/or a location estimate, to the location server 702, via the serving gNB 110-1. For example, the indication may be in a LPP Provide Location Information that is transmitted to the serving gNB 110-1 and the serving gNB 110-1 forwards to the location server 702. For example, the UE 105 may send a bitmap that includes an indication, e.g., by setting a bit to 1, for each measurement that is the same as before or, e.g., setting the bit to 0, for the measurements that are not the same. The length of the bitmap, for example, may be equal to number of different positioning measurements. For example, the UE 105 may provide an indication that there is no update in one or more location measurements to the location server 802 by providing a bit indicating each location measurement that is not being updated, or by providing a single bit that indicate that all location measurements are not being updated. In one implementation, the indication that there is no update in one or more location measurements may be provided to the location server 802 by not sending a positioning report to the location server 152 by the end of a configured report expiration timer, e.g., reportTime. If the location server 152 has not received a positioning report by the end of the configured report expiration timer, e.g., the “reportTime”, the location server 152 may it determine that measurements has not changed since the previous positioning measurement report.

At stage 8, the location server 802 may communicate with the serving gNB 110-1 to determine whether the UE 105 remains in a connected state.

At stage 9, the location server 802 may determine that there is no update to the one or more location measurements to the location server 802. The location server 802 may provide a communication to an external client 130 (not shown) indicating that there is no update of the positioning measurements for the UE 105.

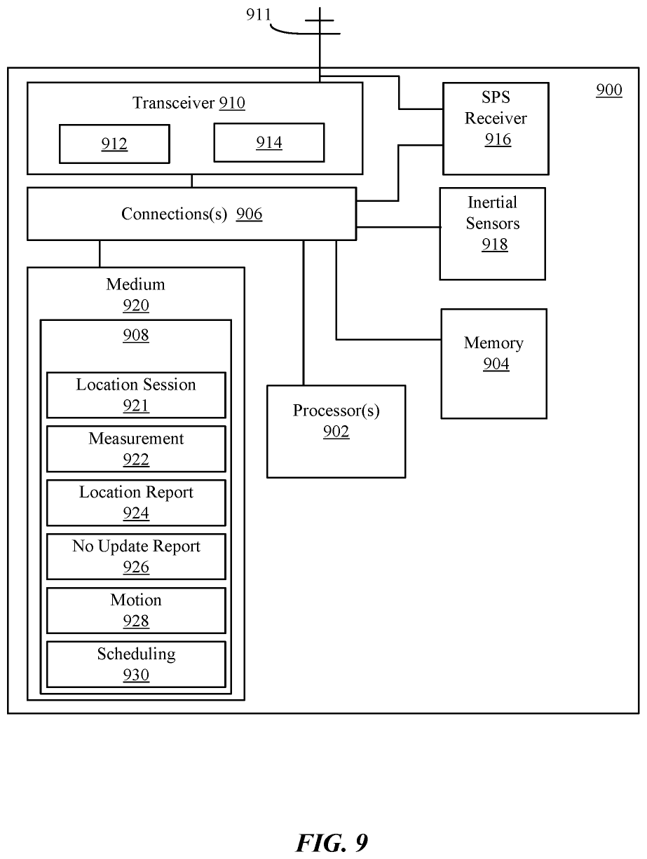

FIG. 9 shows a schematic block diagram illustrating certain exemplary features of a UE 900, e.g., which may be UE 105 shown in FIG. 1, enabled to support positioning of the UE using indications that there is no update to positioning information, as described herein. The UE 900 may perform the process flow shown in FIG. 12. UE 900 may, for example, include one or more processors 902, memory 904, an external interface such as a wireless transceiver 910 (e.g., wireless network interface), a satellite positioning system receiver (SPS) 916, and inertial sensors 918, which may be operatively coupled with one or more connections 906 (e.g., buses, lines, fibers, links, etc.) to non-transitory computer readable medium 920 and memory 904. The UE 900 may further include additional items, which are not shown, such as a user interface that may include e.g., a display, a keypad or other input device, such as virtual keypad on the display, through which a user may interface with the UE, etc. The inertial sensors 918 may include, e.g., accelerometers, gyroscopes, magnetometer, barometer, etc., which may be used for determining a change in location of the UE 900. In certain example implementations, all or part of UE 900 may take the form of a chipset, and/or the like. Transceiver 910 may, for example, include a transmitter 912 enabled to transmit one or more signals over one or more types of wireless communication networks and a receiver 914 to receive one or more signals transmitted over the one or more types of wireless communication networks.

In some embodiments, UE 900 may include antenna 911, which may be internal or external. UE antenna 911 may be used to transmit and/or receive signals processed by transceiver 910. In some embodiments, UE antenna 911 may be coupled to transceiver 910 and SPS receiver 916, or a separate antenna may be used for SPS receiver 916. In some embodiments, measurements of signals received (transmitted) by UE 900 may be performed at the point of connection of the UE antenna 911 and transceiver 910. For example, the measurement point of reference for received (transmitted) RF signal measurements may be an input (output) terminal of the receiver 914 (transmitter 912) and an output (input) terminal of the UE antenna 911. In a UE 900 with multiple UE antennas 911 or antenna arrays, the antenna connector may be viewed as a virtual point representing the aggregate output (input) of multiple UE antennas. In some embodiments, UE 900 may measure received signals including signal strength and TOA measurements and the raw measurements may be processed by the one or more processors 902.

The one or more processors 902 may be implemented using a combination of hardware, firmware, and software. For example, the one or more processors 902 may be configured to perform the functions discussed herein by implementing one or more instructions or program code 908 on a non-transitory computer readable medium, such as medium 920 and/or memory 904. In some embodiments, the one or more processors 902 may represent one or more circuits configurable to perform at least a portion of a data signal computing procedure or process related to the operation of UE 900.

The medium 920 and/or memory 904 may store instructions or program code 908 that contain executable code or software instructions that when executed by the one or more processors 902 cause the one or more processors 902 to operate as a special purpose computer programmed to perform the techniques disclosed herein. As illustrated in UE 900, the medium 920 and/or memory 904 may include one or more components or modules that may be implemented by the one or more processors 902 to perform the methodologies described herein. While the components or modules are illustrated as software in medium 920 that is executable by the one or more processors 902, it should be understood that the components or modules may be stored in memory 904 or may be dedicated hardware either in the one or more processors 902 or off the processors. A number of software modules and data tables may reside in the medium 920 and/or memory 904 and be utilized by the one or more processors 902 in order to manage both communications and the functionality described herein. It should be appreciated that the organization of the contents of the medium 920 and/or memory 904 as shown in UE 900 is merely exemplary, and as such the functionality of the modules and/or data structures may be combined, separated, and/or be structured in different ways depending upon the implementation of the UE 900.

The medium 920 and/or memory 904 may include a location session module 921 that when implemented by the one or more processors 902 configures the one or more processors 902 to engage in a positioning session for the UE. For example, the one or more processors 902 may be configured to receive and transmit positioning messages with a location server or base station for positioning, via the transceiver 910, e.g., including request for location information which may be a request for periodic or triggered positioning, and may include configurations used for not updating positioning measurements, such as QoS parameters, thresholds of a change in location or change in measurements, and the number of consecutive location information reports for which no update may be provided, a tolerance that the measurements need to be within to not update, etc.

The medium 920 and/or memory 904 may include a measurement module 922 that when implemented by the one or more processors 902 configures the one or more processors 902 to receive signals, e.g., via transceiver 910 and/or SPS receiver 916, and to measure the signals to generate one or more location measurements, such as reference signal time difference (RSTD) measurements, reference signal received power (RSRP) measurements, time difference between reception and transmission of signals (Rx-Tx), GNSS measurements, etc. The measurement module 922 may further configure the one or more processors 902 to determine an estimate of the position of the UE 900 based on location measurements, such as time difference of arrival (TDOA), Angle of Departure (AoD), Round Trip Time (RTT) or multi cell RTT (multi-RTT), A-GNSS, etc.

The medium 920 and/or memory 904 may include a location report module 924 that when implemented by the one or more processors 902 configures the one or more processors 902 to transmit location reports, including location information such as one more location measurements and/or position estimate, to a location server via the transceiver 910.

The medium 920 and/or memory 904 may include a no update report module 926 that when implemented by the one or more processors 902 configures the one or more processors 902 to provide an indication to an entity in the wireless network, such as the location server or a serving base station, that there is no update for at least one location measurement. For example, the one or more processors 902 may be configured to provide an indication that there is no update using one of radio resource control (RRC), Long Term Evolution (LTE) positioning protocol (LPP), medium access control-control element (MAC-CE), or downlink control information (DCI). The one or more processors 902 may be configured to provide the indication that there is no update for a location measurement by setting a bit in a message that indicates that there is no update for all location measurements or that there is no update for a particular location measurement. The one or more processors 902 may be configured to provide the indication that there is no update for a location measurement by not sending a location information report to the location server by an end of a configured report expiration time. The one or more processors 902 may be configured to provide the indication that there is no update for a location measurement to a serving base station as a Physical layer waveform, such as a PUCCH message or a CG-PUSCH message. The one or more processors 902 may be configured to providing information to the serving base station to modify a configured grant based on, e.g., a next opportunity to transmit a location information report or a change in periodicity for transmitting location information reports. For example, the indication that there is no update for the at least one location measurement may be a DMRS message that includes no data symbols. The one or more processors 902 may be configured to provide the indication that there is no update for a location measurement to a location server and using bit in a location information report to indicate that there is no update for all measurement elements in the location information report or to indicate that there is no update for a particular measurement element in the location information report.

The medium 920 and/or memory 904 may include a motion module 928 that when implemented by the one or more processors 902 configures the one or more processors 902 to determine when there is little or no change in location of the UE between location measurements so that the no update is necessary for a location report. For example, the motion module 928 may configure the one or more processors 902 to use data from transceivers 910, the SPS receiver 916, and/or the inertial sensors 918 to determine if a change in location of the UE 900 is below a threshold, which may be a network configured threshold. The motion module 928 may configure the one or more processors 902 to determine if a change in one or more location measurements is below a threshold, which may be a network configured threshold.

The medium 920 and/or memory 904 may include a scheduling module 930 that when implemented by the one or more processors 902 configures the one or more processors 902 to, e.g., request and receive scheduling grants from a serving base station, e.g., to transmit location information reports.

The methodologies described herein may be implemented by various means depending upon the application. For example, these methodologies may be implemented in hardware, firmware, software, or any combination thereof. For a hardware implementation, the one or more processors 902 may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine readable medium tangibly embodying instructions may be used in implementing the methodologies described herein. For example, software codes may be stored in a non-transitory computer readable medium 920 or memory 904 that is connected to and executed by the one or more processors 902. Memory may be implemented within the one or more processors or external to the one or more processors. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or program code 908 on a non-transitory computer readable medium, such as medium 920 and/or memory 904. Examples include computer readable media encoded with a data structure and computer readable media encoded with a computer program code 908. For example, the non-transitory computer readable medium including program code 908 stored thereon may include program code 908 to support positioning of the UE using an indication of no updates for positioning measurements in a manner consistent with disclosed embodiments. Non-transitory computer readable medium 920 includes physical computer storage media. A storage medium may be any available medium that can be accessed by a computer. By way of example, and not limitation, such non-transitory computer readable media can comprise RAM, ROM, EEPROM, CD-ROM or other optical disk storage, magnetic disk storage or other magnetic storage devices, or any other medium that can be used to store desired program code 908 in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer readable media.

In addition to storage on computer readable medium 920, instructions and/or data may be provided as signals on transmission media included in a communication apparatus. For example, a communication apparatus may include a transceiver 910 having signals indicative of instructions and data. The instructions and data are configured to cause one or more processors to implement the functions outlined in the claims. That is, the communication apparatus includes transmission media with signals indicative of information to perform disclosed functions.

Memory 904 may represent any data storage mechanism. Memory 904 may include, for example, a primary memory and/or a secondary memory. Primary memory may include, for example, a random access memory, read only memory, etc. While illustrated in this example as being separate from one or more processors 902, it should be understood that all or part of a primary memory may be provided within or otherwise co-located/coupled with the one or more processors 902. Secondary memory may include, for example, the same or similar type of memory as primary memory and/or one or more data storage devices or systems, such as, for example, a disk drive, an optical disc drive, a tape drive, a solid state memory drive, etc.

In certain implementations, secondary memory may be operatively receptive of, or otherwise configurable to couple to a non-transitory computer readable medium 920. As such, in certain example implementations, the methods and/or apparatuses presented herein may take the form in whole or part of a computer readable medium 920 that may include computer implementable program code 908 stored thereon, which if executed by one or more processors 902 may be operatively enabled to perform all or portions of the example operations as described herein. Computer readable medium 920 may be a part of memory 904.

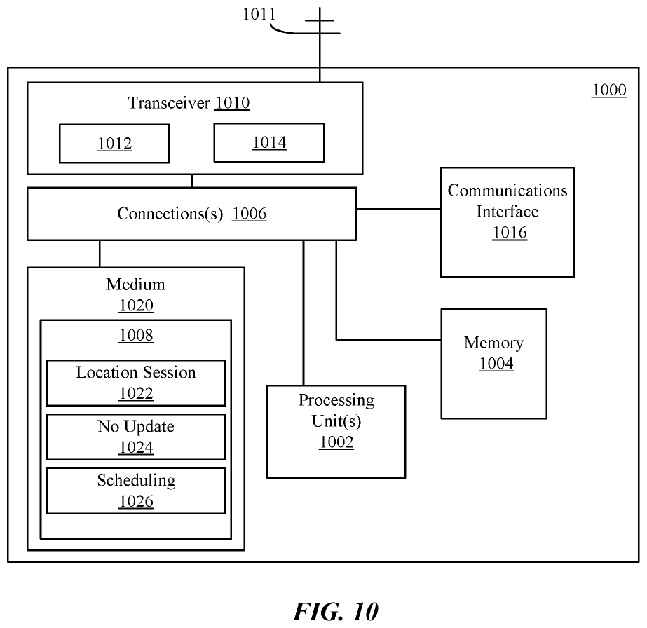

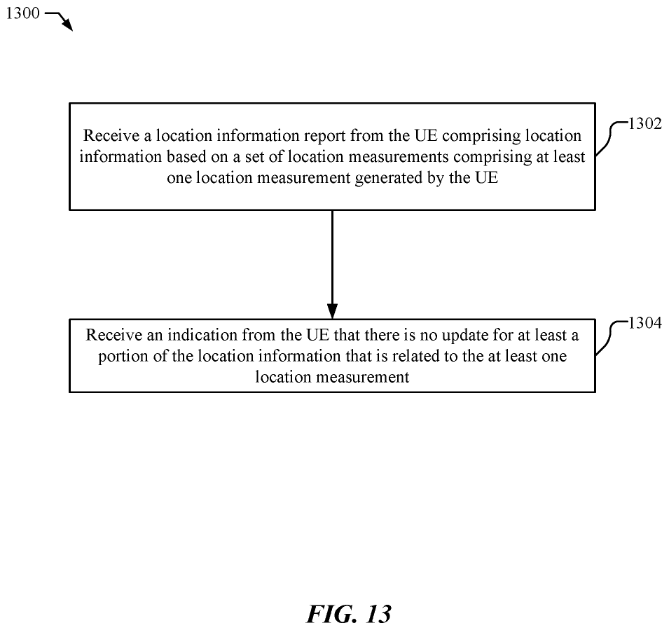

FIG. 10 shows a schematic block diagram illustrating certain exemplary features of a base station 1000 enabled to support positioning of the UE using indications that there is no update to positioning information, as described herein. The base station 1000 may be an eNB or gNB 110, such as illustrated in FIGS. 1, 2, and 3A. The base station 1000 may perform the process flow shown in FIG. 13. Base station 1000 may, for example, include one or more processors 1002, memory 1004, an external interface, which may include a wireless transceiver 1010 (e.g., wireless network interface) and a communications interface 1016 (e.g., wireline or wireless network interface to other base stations and/or entities in the core network such as a location server or UPF 158 for communication with an external client 130), which may be operatively coupled with one or more connections 1006 (e.g., buses, lines, fibers, links, etc.) to non-transitory computer readable medium 1020 and memory 1004. The base station 1000 may further include additional items, which are not shown, such as a user interface that may include e.g., a display, a keypad or other input device, such as virtual keypad on the display, through which a user may interface with the base station. In certain example implementations, all or part of base station 1000 may take the form of a chipset, and/or the like. Transceiver 1010 may, for example, include a transmitter 1012 enabled to transmit one or more signals over one or more types of wireless communication networks and a receiver 1014 to receive one or more signals transmitted over the one or more types of wireless communication networks. The communications interface 1016 may be a wired or wireless interface capable of connecting to other base stations in the RAN or network entities, such as a location server, e.g., E-SMCL, SLP, LMF 152 or LMC 117 shown in FIGS. 1, 2, and 3A.

In some embodiments, base station 1000 may include antenna 1011, which may be internal or external. Antenna 1011 may be used to transmit and/or receive signals processed by transceiver 1010. In some embodiments, antenna 1011 may be coupled to transceiver 1010. In some embodiments, measurements of signals received (transmitted) by base station 1000 may be performed at the point of connection of the antenna 1011 and transceiver 1010. For example, the measurement point of reference for received (transmitted) RF signal measurements may be an input (output) terminal of the receiver 1014 (transmitter 1012) and an output (input) terminal of the antenna 1011. In a base station 1000 with multiple antennas 1011 or antenna arrays, the antenna connector may be viewed as a virtual point representing the aggregate output (input) of multiple antennas. In some embodiments, base station 1000 may measure received signals including signal strength and TOA measurements and the raw measurements may be processed by the one or more processors 1002.

The one or more processors 1002 may be implemented using a combination of hardware, firmware, and software. For example, the one or more processors 1002 may be configured to perform the functions discussed herein by implementing one or more instructions or program code 1008 on a non-transitory computer readable medium, such as medium 1020 and/or memory 1004. In some embodiments, the one or more processors 1002 may represent one or more circuits configurable to perform at least a portion of a data signal computing procedure or process related to the operation of base station 1000.

The medium 1020 and/or memory 1004 may store instructions or program code 1008 that contain executable code or software instructions that when executed by the one or more processors 1002 cause the one or more processors 1002 to operate as a special purpose computer programmed to perform the techniques disclosed herein. As illustrated in base station 1000, the medium 1020 and/or memory 1004 may include one or more components or modules that may be implemented by the one or more processors 1002 to perform the methodologies described herein. While the components or modules are illustrated as software in medium 1020 that is executable by the one or more processors 1002, it should be understood that the components or modules may be stored in memory 1004 or may be dedicated hardware either in the one or more processors 1002 or off the processors. A number of software modules and data tables may reside in the medium 1020 and/or memory 1004 and be utilized by the one or more processors 1002 in order to manage both communications and the functionality described herein. It should be appreciated that the organization of the contents of the medium 1020 and/or memory 1004 as shown in base station 1000 is merely exemplary, and as such the functionality of the modules and/or data structures may be combined, separated, and/or be structured in different ways depending upon the implementation of the base station 1000.

The medium 1020 and/or memory 1004 may include a location session module 1022 that when implemented by the one or more processors 1002 configures the one or more processors 1002 to engage in a location session for the UE. For example, the one or more processors 1002 may be configured to transmit signals, such as PRS for location in the location session, e.g., via the communications interface 1016. The one or more processors 1002 may be configured transmit and receive LLP messages for the UE 105 and location server to engage in a location session. For example, the one or more processors 1002 may be configured to receive location information reports from the UE that include location measurement generated by the UE and to forward the location information reports to the location server. The one or more processors 1002 may be configured to receive an indication from the UE that there is no update for location measurements.

The medium 1020 and/or memory 1004 may include a no update module 1024 that when implemented by the one or more processors 1002 configures the one or more processors 1002 to determine when no update to location measurements is provided by the UE and to send an indication that there is no update to an external client or a location server, e.g., via the communications interface 1016. When the base station sends an indication that there is no update to an external client, the one or more processors 1002 may be further configured to send an additional indication that there is no update to the location server. The indication that there is no update, for example, may be provided as a bit that indicates there is no update for a particular location measurement or a bit that indicates there is no update for all location measurements. The indication that there is no update may be received in a Physical layer waveform, such as a PUCCH message or a PUSCH message. The one or more processors 1002 may be configured to receive information from the UE to modify a configured grant based on, e.g., a next opportunity to transmit a location information report or a change in periodicity for transmitting location information reports. The indication that there is no update for the at least one location measurement may be a DMRS message that includes no data symbols.

The medium 1020 and/or memory 1004 may include a scheduling module 1026 that when implemented by the one or more processors 1002 configures the one or more processors 1002 to, e.g., request and receive scheduling grants from the UE, e.g., to transmit location information reports.

The methodologies described herein may be implemented by various means depending upon the application. For example, these methodologies may be implemented in hardware, firmware, software, or any combination thereof. For a hardware implementation, the one or more processors 1002 may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine readable medium tangibly embodying instructions may be used in implementing the methodologies described herein. For example, software codes may be stored in a non-transitory computer readable medium 1020 or memory 1004 that is connected to and executed by the one or more processors 1002. Memory may be implemented within the one or more processors or external to the one or more processors. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or program code 1008 on a non-transitory computer readable medium, such as medium 1020 and/or memory 1004. Examples include computer readable media encoded with a data structure and computer readable media encoded with a computer program code 1008. For example, the non-transitory computer readable medium including program code 1008 stored thereon may include program code 1008 to support positioning of the UE using indications that there is no update to positioning information in a manner consistent with disclosed embodiments. Non-transitory computer readable medium 1020 includes physical computer storage media. A storage medium may be any available medium that can be accessed by a computer. By way of example, and not limitation, such non-transitory computer readable media can comprise RAM, ROM, EEPROM, CD-ROM or other optical disk storage, magnetic disk storage or other magnetic storage devices, or any other medium that can be used to store desired program code 1008 in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer readable media.

In addition to storage on computer readable medium 1020, instructions and/or data may be provided as signals on transmission media included in a communication apparatus. For example, a communication apparatus may include a transceiver 1010 having signals indicative of instructions and data. The instructions and data are configured to cause one or more processors to implement the functions outlined in the claims. That is, the communication apparatus includes transmission media with signals indicative of information to perform disclosed functions.

Memory 1004 may represent any data storage mechanism. Memory 1004 may include, for example, a primary memory and/or a secondary memory. Primary memory may include, for example, a random access memory, read only memory, etc. While illustrated in this example as being separate from one or more processors 1002, it should be understood that all or part of a primary memory may be provided within or otherwise co-located/coupled with the one or more processors 1002. Secondary memory may include, for example, the same or similar type of memory as primary memory and/or one or more data storage devices or systems, such as, for example, a disk drive, an optical disc drive, a tape drive, a solid state memory drive, etc.

In certain implementations, secondary memory may be operatively receptive of, or otherwise configurable to couple to a non-transitory computer readable medium 1020. As such, in certain example implementations, the methods and/or apparatuses presented herein may take the form in whole or part of a computer readable medium 1020 that may include computer implementable program code 1008 stored thereon, which if executed by one or more processors 1002 may be operatively enabled to perform all or portions of the example operations as described herein. Computer readable medium 1020 may be a part of memory 1004.

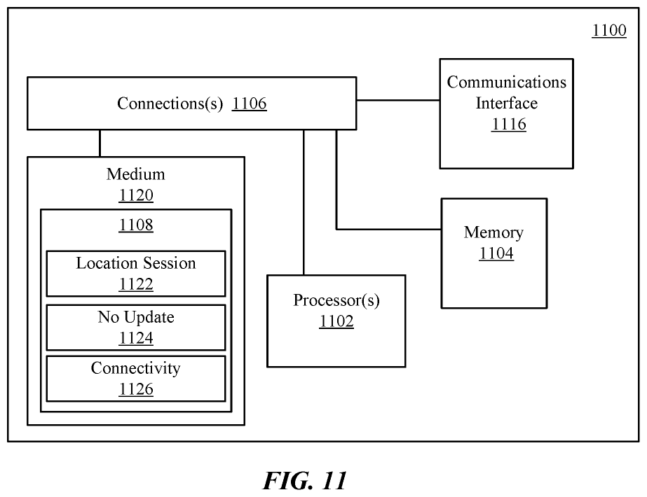

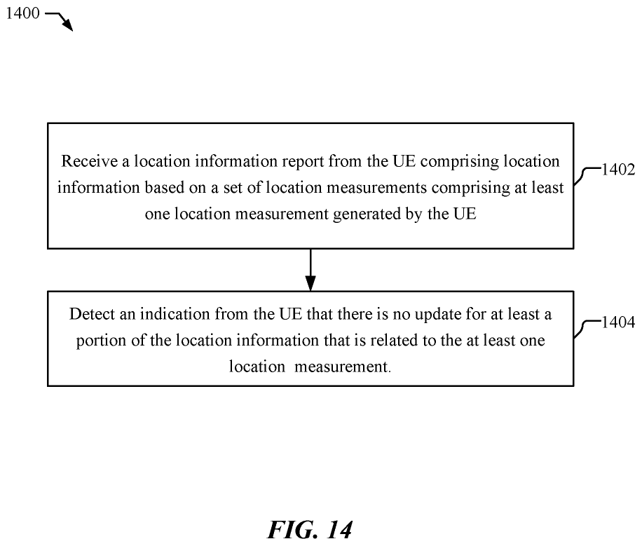

FIG. 11 shows a schematic block diagram illustrating certain exemplary features of a location server 1100 enabled to support positioning of the UE using indications that there is no update to positioning information, as described herein. The location server 1100 may be, e.g., E-SMLC, SLP, LMF 152, or LMC 117, shown in FIGS. 1, 2, and 3A. The location server 1100 may perform the process flow shown in FIG. 14. Location server 1100 may, for example, include one or more processors 1102, memory 1104, and a communications interface 1116 (e.g., wireline or wireless network interface to other network entities, such as core network entities and base stations), which may be operatively coupled with one or more connections 1106 (e.g., buses, lines, fibers, links, etc.) to non-transitory computer readable medium 1120 and memory 1104. The location server 1100 may further include additional items, which are not shown, such as a user interface that may include e.g., a display, a keypad or other input device, such as virtual keypad on the display, through which a user may interface with the location server. In certain example implementations, all or part of location server 1100 may take the form of a chipset, and/or the like. The communications interface 1116 may be a wired or wireless interface capable of connecting to base stations in the RAN or network entities, such as an AMF or MME.

The one or more processors 1102 may be implemented using a combination of hardware, firmware, and software. For example, the one or more processors 1102 may be configured to perform the functions discussed herein by implementing one or more instructions or program code 1108 on a non-transitory computer readable medium, such as medium 1120 and/or memory 1104. In some embodiments, the one or more processors 1102 may represent one or more circuits configurable to perform at least a portion of a data signal computing procedure or process related to the operation of location server 1100.

The medium 1120 and/or memory 1104 may store instructions or program code 1108 that contain executable code or software instructions that when executed by the one or more processors 1102 cause the one or more processors 1102 to operate as a special purpose computer programmed to perform the techniques disclosed herein. As illustrated in location server 1100, the medium 1120 and/or memory 1104 may include one or more components or modules that may be implemented by the one or more processors 1102 to perform the methodologies described herein. While the components or modules are illustrated as software in medium 1120 that is executable by the one or more processors 1102, it should be understood that the components or modules may be stored in memory 1104 or may be dedicated hardware either in the one or more processors 1102 or off the processors. A number of software modules and data tables may reside in the medium 1120 and/or memory 1104 and be utilized by the one or more processors 1102 in order to manage both communications and the functionality described herein. It should be appreciated that the organization of the contents of the medium 1120 and/or memory 1104 as shown in location server 1100 is merely exemplary, and as such the functionality of the modules and/or data structures may be combined, separated, and/or be structured in different ways depending upon the implementation of the location server 1100.

The medium 1120 and/or memory 1104 may include a location session module 1122 that when implemented by the one or more processors 1102 configures the one or more processors 1102 to engage in a location session for the UE. For example, the one or more processors 1102 may be configured to engage in a location session by requesting and receive location capabilities from a UE, via the communications interface 1116. The one or more processors 1102 may be configured to generate and send location assistance data to the UE and/or serving base station, via the communications interface 1116. The one or more processors 1102 may further be configured to request location measurements, such as periodic or triggered location measurements, and to receive location measurement reports that includes location measurements performed by the UE, via the communications interface 1116, from the UE. The one or more processors 1102 may be configured to provide a threshold configuration for the UE to determine when an update to location measurements are not required to be reported in a location measurement report and a number of consecutive location information reports for which no update may be sent. The one or more processors 1102 may be configured to provide an accuracy quality of service requirement, where location measurements are not required to be reported by the UE in a location measurement report when the accuracy quality of service requirement is satisfied without updating the location measurements.

The medium 1120 and/or memory 1104 may include a no update module 1124 that when implemented by the one or more processors 1102 configures the one or more processors 1102 to detect an indication from the UE that there is update to location measurements. The one or more processors 1102, for example, may be configured to detect the indication that there is no update to location measurement by determining that the UE did not send a second location information report by an end of a configured report expiration time. The one or more processors 1102, for example, may be configured to detect the indication that there is no update for the at least one location measurement by receiving an indication from the serving base station that the UE did not update the at least one location measurement, via the communications interface 1116. The one or more processors 1102, for example, may be configured to detect the indication that there is no update to location measurement by receiving an indication that there is no update for the at least one location measurement, via the communications interface 1116. For example, the indication that there is no update to location measurement may be a separate bit, e.g., in a bitmap, that indicates there is no update for a particular location measurement. In another example, the indication that there is no update for location measurements may be a bit that indicates there is no update for all location measurements.

The medium 1120 and/or memory 1104 may include a connectivity module 1126 that when implemented by the one or more processors 1102 configures the one or more processors 1102 to communicate with the serving base station and to receive an indication that the UE is in a connected state after detecting the indication that there is no update to location measurements.

The methodologies described herein may be implemented by various means depending upon the application. For example, these methodologies may be implemented in hardware, firmware, software, or any combination thereof. For a hardware implementation, the one or more processors 1102 may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine readable medium tangibly embodying instructions may be used in implementing the methodologies described herein. For example, software codes may be stored in a non-transitory computer readable medium 1120 or memory 1104 that is connected to and executed by the one or more processors 1102. Memory may be implemented within the one or more processors or external to the one or more processors. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or program code 1108 on a non-transitory computer readable medium, such as medium 1120 and/or memory 1104. Examples include computer readable media encoded with a data structure and computer readable media encoded with a computer program code 1108. For example, the non-transitory computer readable medium including program code 1108 stored thereon may include program code 1108 to support positioning of the UE using indications that there is no update to positioning information in a manner consistent with disclosed embodiments. Non-transitory computer readable medium 1120 includes physical computer storage media. A storage medium may be any available medium that can be accessed by a computer. By way of example, and not limitation, such non-transitory computer readable media can comprise RAM, ROM, EEPROM, CD-ROM or other optical disk storage, magnetic disk storage or other magnetic storage devices, or any other medium that can be used to store desired program code 1108 in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer readable media.

In addition to storage on computer readable medium 1120, instructions and/or data may be provided as signals on transmission media included in a communication apparatus. For example, a communication apparatus may include a communications interface 1116 having signals indicative of instructions and data. The instructions and data are configured to cause one or more processors to implement the functions outlined in the claims. That is, the communication apparatus includes transmission media with signals indicative of information to perform disclosed functions.

Memory 1104 may represent any data storage mechanism. Memory 1104 may include, for example, a primary memory and/or a secondary memory. Primary memory may include, for example, a random access memory, read only memory, etc. While illustrated in this example as being separate from one or more processors 1102, it should be understood that all or part of a primary memory may be provided within or otherwise co-located/coupled with the one or more processors 1102. Secondary memory may include, for example, the same or similar type of memory as primary memory and/or one or more data storage devices or systems, such as, for example, a disk drive, an optical disc drive, a tape drive, a solid state memory drive, etc.

In certain implementations, secondary memory may be operatively receptive of, or otherwise configurable to couple to a non-transitory computer readable medium 1120. As such, in certain example implementations, the methods and/or apparatuses presented herein may take the form in whole or part of a computer readable medium 1120 that may include computer implementable program code 1108 stored thereon, which if executed by one or more processors 1102 may be operatively enabled to perform all or portions of the example operations as described herein. Computer readable medium 1120 may be a part of memory 1104.

FIG. 12 shows a flowchart for an exemplary process 1200 for supporting location services for a user equipment (UE) performed by the UE in a wireless network, such as UE 105, in a manner consistent with disclosed implementations.

At block 1202, the UE generates a first set of location measurements comprising at least one location measurement, e.g., as discussed at stage 4 of FIG. 7 or stage 2 of FIG. 8. A means for generating a first set of location measurements comprising at least one location measurement may include the wireless transceiver 910, the SPS receiver 916, and one or more processors 902 with dedicated hardware or implementing executable code or software instructions in memory 904 and/or medium 920, such as the measurement module 922 in UE 900 shown in FIG. 9.

At block 1204, the UE sends location information report to a location server in the wireless network for location determination of the UE, wherein the location information report comprises location information based on the first set of location measurements, e.g., as discussed at stage 5 of FIG. 7 or stage 3 of FIG. 8. For example, the location information may be at least one of the first set of location measurements, a position estimate determined based on the first set of location measurements, or a combination thereof. A means for sending location information report to a location server in the wireless network for location determination of the UE, wherein the location information report comprises location information based on the first set of location measurements may include the wireless transceiver 910 and one or more processors 902 with dedicated hardware or implementing executable code or software instructions in memory 904 and/or medium 920, such as the location report module 924 in UE 900 shown in FIG. 9.

At block 1206, the UE generates a second set of location measurements comprising the at least one location measurement, e.g., as discussed at stage 7 of FIG. 7 or stage 5 of FIG. 8. A means for generating a second set of location measurements comprising the at least one location measurement may include the wireless transceiver 910, the SPS receiver 916, and one or more processors 902 with dedicated hardware or implementing executable code or software instructions in memory 904 and/or medium 920, such as the measurement module 922 in UE 900 shown in FIG. 9.

At block 1208, the UE provides an indication to an entity in the wireless network that there is no update for at least a portion of the location information that is related to the at least one location measurement, e.g., as discussed at stage 9a and/or stage 9b of FIG. 7 or stage 7 of FIG. 8. For example, the UE may be configured to provide the indication to the entity using one of radio resource control (RRC), Long Term Evolution (LTE) positioning protocol (LPP), medium access control-control element (MAC-CE), or downlink control information (DCI). A means for providing an indication to an entity in the wireless network that there is no update for at least a portion of the location information that is related to the at least one location measurement may include the wireless transceiver 910 and one or more processors 902 with dedicated hardware or implementing executable code or software instructions in memory 904 and/or medium 920, such as the no update report module 926 in UE 900 shown in FIG. 9.

In one implementation, the UE may further determine that a change in location of the UE between generating the first set of location measurements and generating the second set of location measurements is below a threshold, wherein the indication that there is no update for at least the portion of the location information that is related to the at least one location measurement is provided is in response to the change in location being less than the threshold, e.g., as discussed at stage 8 of FIG. 7 or stage 6 of FIG. 8. A means for determining that a change in location of the UE between generating the first set of location measurements and generating the second set of location measurements is below a threshold, wherein providing the indication that there is no update for at least the portion of the location information that is related to the at least one location measurement is in response to the change in location being less than the threshold may include the wireless transceiver 910, the SPS receiver 916, inertial sensors 918, and one or more processors 902 with dedicated hardware or implementing executable code or software instructions in memory 904 and/or medium 920, such as the motion module 928 in UE 900 shown in FIG. 9.

In one implementation, the UE may further determining a change in the at least one location measurement in the first set of location measurements and the at least one location measurement in the second set of location measurements is below a threshold, wherein providing the indication that there is no update for at least the portion of the location information that is related to the at least one location measurement is in response to the change being less than the threshold, e.g., as discussed at stage 8 of FIG. 7 or stage 6 of FIG. 8. The threshold, for example, may be network configured. A means for determining a change in the at least one location measurement in the first set of location measurements and the at least one location measurement in the second set of location measurements is below a threshold, wherein providing the indication that there is no update for at least the portion of the location information that is related to the at least one location measurement is in response to the change being less than the threshold may include the wireless transceiver 910, the SPS receiver 916, and one or more processors 902 with dedicated hardware or implementing executable code or software instructions in memory 904 and/or medium 920, such as the measurement module 922 and the motion module 928 in UE 900 shown in FIG. 9.

In one implementation, the UE may receive an accuracy quality of service requirement and may determine the accuracy quality of service requirement is satisfied without updating the at least the portion of the location information that is related to the at least one location measurement, wherein providing the indication that there is no update for at least the portion of the location information that is related to the at least one location measurement is in response to the determination that the accuracy quality of service requirement is satisfied, e.g., as discussed at stage 8 of FIG. 7 or stage 6 of FIG. 8. A means for receiving an accuracy quality of service requirement may include the wireless transceiver 910 and one or more processors 902 with dedicated hardware or implementing executable code or software instructions in memory 904 and/or medium 920, such as the location session module 921 in UE 900 shown in FIG. 9. A means for determining the accuracy quality of service requirement is satisfied without updating the at least the portion of the location information that is related to the at least one location measurement, wherein providing the indication that there is no update for at least the portion of the location information that is related to the at least one location measurement is in response to the determination that the accuracy quality of service requirement is satisfied may include the wireless transceiver 910, the SPS receiver 916, and one or more processors 902 with dedicated hardware or implementing executable code or software instructions in memory 904 and/or medium 920, such as the motion module 928 in UE 900 shown in FIG. 9.

The UE may receive a configuration for a number of consecutive location information reports for which an indication of no update may be sent, e.g., as discussed at stage 1 of FIG. 7 or stage 1 of FIG. 8. A means for receiving a configuration for a number of consecutive location information reports for which an indication of no update may be sent may include the wireless transceiver 910 and one or more processors 902 with dedicated hardware or implementing executable code or software instructions in memory 904 and/or medium 920, such as the location session module 921 in UE 900 shown in FIG. 9.

In one implementation, the UE may receive a location request for periodic or triggered location measurements, wherein the sending the location information report and providing an indication that there is no update for at least the portion of the location information that is related to the at least one location measurement is in response to the location request for periodic or triggered location measurements, e.g., as discussed at stage 1 of FIG. 7 or stage 1 of FIG. 8. A means for receiving a location request for periodic or triggered location measurements, wherein the sending the location information report and providing an indication that there is no update for at least the portion of the location information that is related to the at least one location measurement is in response to the location request for periodic or triggered location measurements may include the wireless transceiver 910 and one or more processors 902 with dedicated hardware or implementing executable code or software instructions in memory 904 and/or medium 920, such as the location session module 921 in UE 900 shown in FIG. 9.

In one implementation, the indication that there is no update for at least the portion of the location information that is related to the at least one location measurement may be a bit that indicates there is no update for the at least one location measurement, e.g., as discussed at stage 9a and/or stage 9b of FIG. 7 or stage 7 of FIG. 8. For example, the indication that there is no update for at least the portion of the location information that is related to the at least one location measurement may be a bit that indicates there is no update for all location information in the location information report.

In one implementation, the indication that there is no update for at least the portion of the location information that is related to the at least one location measurement may be not sending a second location information report to the location server by an end of a configured report expiration time, e.g., as discussed at stage 7 of FIG. 8.

In one implementation, the entity in the wireless network to which the UE provides the indication that there is no update for at least the portion of the location information that is related to the at least one location measurement may be a serving base station, and the indication that there is no update for the at least one location measurement comprises a Physical layer waveform sent to the serving base station, e.g., as discussed at stage 9a and/or stage 9b of FIG. 7.

For example, the Physical layer waveform may be a Physical Uplink Control Channel (PUCCH) message, e.g., as discussed at stage 9a of FIG. 7. In one example, the UE may receive a configured grant from the serving base station for transmitting location information reports, and the UE may transmit a Configured Grant Physical Uplink Shared Channel (CG-PUSCH) message providing information to the serving base station to modify the configured grant, e.g., as discussed at stage 3 and stage 9b of FIG. 7. For example, the information to modify the configured grant may be a next opportunity to transmit a location information report or a change in periodicity for transmitting location information reports. A means for receiving a configured grant from the serving base station for transmitting location information reports may include the wireless transceiver 910 and one or more processors 902 with dedicated hardware or implementing executable code or software instructions in memory 904 and/or medium 920, such as the scheduling module 930 in UE 900 shown in FIG. 9. A means for transmitting a Configured Grant Physical Uplink Shared Channel (CG-PUSCH) message providing information to the serving base station to modify the configured grant may include the wireless transceiver 910 and one or more processors 902 with dedicated hardware or implementing executable code or software instructions in memory 904 and/or medium 920, such as the no update report module 926 in UE 900 shown in FIG. 9.

For example, the Physical layer waveform may be a Physical Uplink Shared Channel (PUSCH) message, e.g., as discussed at stage 9b of FIG. 7. For example, the UE may receive a configured grant from the serving base station for transmitting location information reports, wherein the PUSCH message with the indication that there is no update for at least the portion of the location information that is related to the at least one location measurement is transmitted in response to the configured grant, e.g., as discussed at stage 3 and stage 9b of FIG. 7. The PUSCH message, for example, may be a Demodulation Reference Signal (DMRS) and the indication that there is no update for at least the portion of the location information that is related to the at least one location measurement may be the PUSCH message including no data symbols. A means for receiving a configured grant from the serving base station for transmitting location information reports, wherein the PUSCH message with the indication that there is no update for at least the portion of the location information that is related to the at least one location measurement is transmitted in response to the configured grant may include the wireless transceiver 910 and one or more processors 902 with dedicated hardware or implementing executable code or software instructions in memory 904 and/or medium 920, such as the scheduling module 930 in UE 900 shown in FIG. 9.

In one implementation, the entity in the wireless network to which the UE provides the indication that there is no update for at least the portion of the location information that is related to the at least one location measurement may be the location server, and the indication that there is no update for at least the portion of the location information that is related to the at least one location measurement may be a bit in the location information report to the location server that indicates there is no update for at least the portion of the location information that is related to the at least one location measurement, e.g., as discussed at stage 7 of FIG. 8. For example, the bit in the location information report to the location server may indicate that there is no update for all measurement elements in the location information report. In another example, the bit in the location information report to the location server may indicate that there is no update for one measurement element and that other measurement elements in the location information report are updated.

FIG. 13 shows a flowchart for an exemplary process 1300 for supporting location services for a user equipment (UE) performed by a serving base station for the UE in a wireless network, such as base station 110-1, in a manner consistent with disclosed implementations.

At block 1302, the base station receives a location information report from the UE comprising location information based on a set of location measurements comprising at least one location measurement generated by the UE, e.g., as discussed at stage 5 of FIG. 7 and stage 3 of FIG. 8. For example, the location information may be at least one of the set of location measurements, a position estimate determined by the UE based on the set of location measurements, or a combination thereof. A means for receiving a location information report from the UE comprising location information based on a set of location measurements comprising at least one location measurement generated by the UE may include the wireless transceiver 1010 and one or more processors 1002 with dedicated hardware or implementing executable code or software instructions in memory 1004 and/or medium 1020, such as the location session module 1022 in base station 1000 shown in FIG. 10.

At block 1304, the base station receives an indication from the UE that there is no update for at least a portion of the location information that is related to the at least one location measurement, e.g., as discussed at stage 9a and/or stage 9b of FIG. 7 and stage 7 of FIG. 8. A means for receiving an indication from the UE that there is no update for at least a portion of the location information that is related to the at least one location measurement may include the wireless transceiver 1010 and one or more processors 1002 with dedicated hardware or implementing executable code or software instructions in memory 1004 and/or medium 1020, such as the location session module 1022 in base station 1000 shown in FIG. 10.

In one implementation, the base station may send the location information report to a location server, and may send a second indication that there is no update for at least the portion of the location information that is related to the at least one location measurement to an external client, e.g., as discussed at stage 5 and stage 10 of FIG. 7. A means for sending the location information report to a location server may include the communications interface 1016 and one or more processors 1002 with dedicated hardware or implementing executable code or software instructions in memory 1004 and/or medium 1020, such as the location session module 1022 in base station 1000 shown in FIG. 10. A means for sending a second indication that there is no update for at least the portion of the location information that is related to the at least one location measurement to an external client may include the communications interface 1016 and one or more processors 1002 with dedicated hardware or implementing executable code or software instructions in memory 1004 and/or medium 1020, such as the no update module 1024 in base station 1000 shown in FIG. 10. The base station may send a third indication to the location server that the UE did not update the at least the portion of the location information that is related to at least one location measurement, e.g., as discussed at stage 11 of FIG. 7. A means for sending a third indication to the location server that the UE did not update the at least the portion of the location information that is related to at least one location measurement may include the communications interface 1016 and one or more processors 1002 with dedicated hardware or implementing executable code or software instructions in memory 1004 and/or medium 1020, such as the no update module 1024 in base station 1000 shown in FIG. 10.

In one implementation, the base station may send the location information report to a location server, and send the indication that there is no update for at least the portion of the location information that is related to the at least one location measurement to the location server, e.g., as discussed at stages 3 and 7 of FIG. 8. A means for sending the location information report to a location server, and sending the indication that there is no update for at least the portion of the location information that is related to the at least one location measurement to the location server may include the communications interface 1016 and one or more processors 1002 with dedicated hardware or implementing executable code or software instructions in memory 1004 and/or medium 1020, such as the location session module 1022 in base station 1000 shown in FIG. 10.

In one implementation, the location information report and the indication that there is no update for at least the portion of the location information that is related to the at least one location measurement are for periodic or triggered location measurements, e.g., as discussed at stage 1 of FIGS. 7 and 8.

In one implementation, the indication that there is no update for at least the portion of the location information that is related to the at least one location measurement may include a bit that indicates there is no update for the at least one location measurement, e.g., as discussed at stage 9a and/or stage 9b of FIG. 7 and stage 7 of FIG. 8.

In one implementation, the indication that there is no update for at least the portion of the location information that is related to the at least one location measurement may include a bit that indicates there is no update for all of the location information in the location information report, e.g., as discussed at stage 9a and/or stage 9b of FIG. 7 and stage 7 of FIG. 8.

In one implementation, the indication that there is no update for at least the portion of the location information that is related to the at least one location measurement may be a Physical layer waveform, e.g., as discussed at stages 9a and 9b of FIG. 7.

For example, the Physical layer waveform may be a Physical Uplink Control Channel (PUCCH) message, e.g., as discussed at stage 9a of FIG. 7. In one implementation, the base station may send a configured grant to the UE for transmitting location information reports and may receive a Configured Grant Physical Uplink Shared Channel (CG-PUSCH) message from the UE providing information to modify the configured grant, e.g., as discussed at stages 3 and 9b of FIG. 7. A means for sending a configured grant to the UE for transmitting location information reports may include the wireless transceiver 1010 and one or more processors 1002 with dedicated hardware or implementing executable code or software instructions in memory 1004 and/or medium 1020, such as the scheduling module 1026 in base station 1000 shown in FIG. 10. A means for receiving a Configured Grant Physical Uplink Shared Channel (CG-PUSCH) message from the UE providing information to modify the configured grant may include the wireless transceiver 1010 and one or more processors 1002 with dedicated hardware or implementing executable code or software instructions in memory 1004 and/or medium 1020, such as the no update module 1024 in base station 1000 shown in FIG. 10. For example, the information to modify the configured grant comprises a next opportunity to transmit a location information report or a change in periodicity for transmitting location information reports, e.g., as discussed at stage 9b of FIG. 7.

For example, the Physical layer waveform may be a Physical Uplink Shared Channel (PUSCH) message, e.g., as discussed at stage 9b of FIG. 7. The base station may send a configured grant to the UE for transmitting location information reports, wherein the PUSCH message with the indication that there is no update for at least the portion of the location information that is related to the at least one location measurement is transmitted in response to the configured grant, e.g., as discussed at stages 3 and 9b of FIG. 7. A means for sending a configured grant to the UE for transmitting location information reports, wherein the PUSCH message with the indication that there is no update for at least the portion of the location information that is related to the at least one location measurement is transmitted in response to the configured grant may include the wireless transceiver 1010 and one or more processors 1002 with dedicated hardware or implementing executable code or software instructions in memory 1004 and/or medium 1020, such as the scheduling module 1026 in base station 1000 shown in FIG. 10. The PUSCH message may include a Demodulation Reference Signal (DMRS) and the indication that there is no update for at least the portion of the location information that is related to the at least one location measurement may be the PUSCH message including no data symbols, e.g., as discussed at stage 9b of FIG. 7.

FIG. 14 shows a flowchart for an exemplary process 1400 for supporting location services for a user equipment (UE) performed by a location server in a wireless network, such as an E-SMLC, SLP, LMF 152, or LMC 117, shown in FIGS. 1, 2, and 3A, in a manner consistent with disclosed implementations.

At block 1402, the location server receives a location information report from the UE comprising location information based on a set of location measurements comprising at least one location measurement generated by the UE, e.g., as discussed at stage 5 of FIG. 7 and stage 3 of FIG. 8. For example, the location information may be at least one of the set of location measurements, a position estimate determined by the UE based on the set of location measurements, or a combination thereof. A means for receiving a location information report from the UE comprising location information based on a set of location measurements comprising at least one location measurement generated by the UE may include the communications interface 1116 and one or more processors 1102 with dedicated hardware or implementing executable code or software instructions in memory 1104 and/or medium 1120, such as the location session module 1122 in location server 1100 shown in FIG. 11.

At block 1404, the location server detects an indication from the UE that there is no update for at least a portion of the location information that is related to the at least one location measurement, e.g., as discussed at stage 11 of FIG. 7 and stage 7 of FIG. 8. A means for detecting an indication from the UE that there is no update for at least a portion of the location information that is related to the at least one location measurement may include the communications interface 1116 and one or more processors 1102 with dedicated hardware or implementing executable code or software instructions in memory 1104 and/or medium 1120, such as the no update module 1124 in location server 1100 shown in FIG. 11.

In one implementation, the location server may send a location request for periodic or triggered location measurements to the UE, wherein the location information report is sent by the UE in response to the location request for periodic or triggered location measurements, e.g., as discussed at stage 1 of FIGS. 7 and 8. A means for sending a location request for periodic or triggered location measurements to the UE, wherein the location information report is sent by the UE in response to the location request for periodic or triggered location measurements may include the communications interface 1116 and one or more processors 1102 with dedicated hardware or implementing executable code or software instructions in memory 1104 and/or medium 1120, such as the location session module 1122 in location server 1100 shown in FIG. 11.

In one implementation, the location server may send the UE a threshold configuration for the UE to determine when an update to at least the portion of the location information is not required, e.g., as discussed at stage 1 of FIGS. 7 and 8. A means for sending the UE a threshold configuration for the UE to determine when an update to at least the portion of the location information is not required may include the communications interface 1116 and one or more processors 1102 with dedicated hardware or implementing executable code or software instructions in memory 1104 and/or medium 1120, such as the location session module 1122 in location server 1100 shown in FIG. 11.

In one implementation, the location server may send the UE a number of consecutive location information reports for which no update may be sent, e.g., as discussed at stage 1 of FIGS. 7 and 8. A means for sending the UE a number of consecutive location information reports for which no update may be sent may include the communications interface 1116 and one or more processors 1102 with dedicated hardware or implementing executable code or software instructions in memory 1104 and/or medium 1120, such as the location session module 1122 in location server 1100 shown in FIG. 11.

In one implementation, the location server may send the UE an accuracy quality of service requirement, wherein an update to the at least the portion of the location information is not required to be reported in a location measurement report when the accuracy quality of service requirement is satisfied without updating the at least the portion of the location information, e.g., as discussed at stage 1 of FIGS. 7 and 8. A means for sending the UE an accuracy quality of service requirement, wherein an update to the at least the portion of the location information is not required to be reported in a location measurement report when the accuracy quality of service requirement is satisfied without updating the at least the portion of the location information may include the communications interface 1116 and one or more processors 1102 with dedicated hardware or implementing executable code or software instructions in memory 1104 and/or medium 1120, such as the location session module 1122 in location server 1100 shown in FIG. 11.

In one implementation, the location server may detect the indication that there is no update for at least the portion of the location information that is related to the at least one location measurement by determining that the UE did not send a second location information report by an end of a configured report expiration time, e.g., as discussed at stage 7 of FIG. 8. A means for determining that the UE did not send a second location information report by an end of a configured report expiration time may include the communications interface 1116 and one or more processors 1102 with dedicated hardware or implementing executable code or software instructions in memory 1104 and/or medium 1120, such as the no update module 1124 in location server 1100 shown in FIG. 11.

In one implementation, the location server may receive an indication from a serving base station that the UE is in a connected state after detecting the indication that there is no update for at least the portion of the location information that is related to the at least one location measurement, e.g., as discussed at stage 8 of FIG. 8. A means for receiving an indication from a serving base station that the UE is in a connected state after detecting the indication that there is no update for at least the portion of the location information that is related to the at least one location measurement may include the communications interface 1116 and one or more processors 1102 with dedicated hardware or implementing executable code or software instructions in memory 1104 and/or medium 1120, such as the connectivity module 1126 in location server 1100 shown in FIG. 11.

In one implementation, the location server may detect the indication that there is no update for at least the portion of the location information that is related to the at least one location measurement by receiving an indication from a serving base station that the UE did not update the at least the portion of the location information that is related to at least one location measurement, e.g., as discussed at stage 11 of FIG. 7. A means for receiving an indication from a serving base station that the UE did not update at least the portion of the location information that is related to the at least one location measurement may include the communications interface 1116 and one or more processors 1102 with dedicated hardware or implementing executable code or software instructions in memory 1104 and/or medium 1120, such as the no update module 1124 in location server 1100 shown in FIG. 11.

In one implementation, the location server may detect the indication that there is no update for at least the portion of the location information that is related to the at least one location measurement by receiving an indication that there is no update at least the portion of the location information that is related to for the at least one location measurement from the UE, e.g., as discussed at stage 11 of FIG. 7 and stage 7 of FIG. 8. A means for receiving an indication that there is no update for at least the portion of the location information that is related to the at least one location measurement from the UE may include the communications interface 1116 and one or more processors 1102 with dedicated hardware or implementing executable code or software instructions in memory 1104 and/or medium 1120, such as the no update module 1124 in location server 1100 shown in FIG. 11. For example, the indication that there is no update for at least the portion of the location information that is related to the at least one location measurement may be a bit that indicates there is no update for the at least one location measurement, e.g., as discussed stage 7 of FIG. 8. In another example, the indication that there is no update for at least the portion of the location information that is related to the at least one location measurement may be a bit that indicates there is no update for all location information in the location information report, e.g., as discussed at stage 7 of FIG. 8.

Reference throughout this specification to “one example”, “an example”, “certain examples”, or “exemplary implementation” means that a particular feature, structure, or characteristic described in connection with the feature and/or example may be included in at least one feature and/or example of claimed subject matter. Thus, the appearances of the phrase “in one example”, “an example”, “in certain examples” or “in certain implementations” or other like phrases in various places throughout this specification are not necessarily all referring to the same feature, example, and/or limitation. Furthermore, the particular features, structures, or characteristics may be combined in one or more examples and/or features.

Some portions of the detailed description included herein are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilising terms such as “processing,” “computing,” “calculating,” “determining” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter.

The terms, “and”, “or”, and “and/or” as used herein may include a variety of meanings that also are expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe a plurality or some other combination of features, structures or characteristics. Though, it should be noted that this is merely an illustrative example and claimed subject matter is not limited to this example.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein.

In view of this description embodiments may include different combinations of features. Implementation examples are described in the following numbered clauses:

Clause 1. A method performed by a user equipment (UE) in a wireless network for supporting location services for the UE comprising: generating a first set of location measurements comprising at least one location measurement; sending a location information report to a location server in the wireless network for location determination of the UE, wherein the location information report comprises location information based on the first set of location measurements; generating a second set of location measurements comprising the at least one location measurement; and providing an indication to an entity in the wireless network that there is no update for at least a portion of the location information that is related to the at least one location measurement.

Clause 2. The method of clause 1, wherein the location information comprises at least one of the first set of location measurements, a position estimate determined based on the first set of location measurements, or a combination thereof.

Clause 3. The method of any of clauses 1-2, further comprising determining that a change in location of the UE between generating the first set of location measurements and generating the second set of location measurements is below a threshold, wherein providing the indication that there is no update for at least the portion of the location information that is related to the at least one location measurement is in response to the change in location being less than the threshold.

Clause 4. The method any of clauses 1-3, further comprising determining a change in the at least one location measurement in the first set of location measurements and the at least one location measurement in the second set of location measurements is below a threshold, wherein providing the indication that there is no update for at least the portion of the location information that is related to the at least one location measurement is in response to the change being less than the threshold.

Clause 5. The method of clause 4, wherein the threshold is network configured.

Clause 6. The method of any of clauses 1-5, wherein the UE is configured to provide the indication to the entity using one of radio resource control (RRC), Long Term Evolution (LTE) positioning protocol (LPP), medium access control-control element (MAC-CE), or downlink control information (DCI).

Clause 7. The method of any of clauses 1-6, further comprising: receiving an accuracy quality of service requirement; and determining the accuracy quality of service requirement is satisfied without updating the at least the portion of the location information that is related to the at least one location measurement, wherein providing the indication that there is no update for at least the portion of the location information that is related to the at least one location measurement is in response to the determination that the accuracy quality of service requirement is satisfied.

Clause 8. The method of any of clauses 1-7, further comprising receiving a configuration for a number of consecutive location information reports for which the indication of no update may be sent.

Clause 9. The method of any of clauses 1-8, further comprising receiving a location request for periodic or triggered location measurements, wherein the sending the location information report and providing the indication that there is no update for at least the portion of the location information that is related to the at least one location measurement is in response to the location request for periodic or triggered location measurements.

Clause 10. The method of any of clauses 1-9, wherein the indication that there is no update for at least the portion of the location information that is related to the at least one location measurement comprises a bit that indicates there is no update for the at least one location measurement.

Clause 11. The method of any of clauses 1-10, wherein the indication that there is no update for at least the portion of the location information that is related to the at least one location measurement comprises a bit that indicates there is no update for all location information in the location information report.

Clause 12. The method of any of clauses 1-11, wherein the indication that there is no update for at least the portion of the location information that is related to the at least one location measurement comprises not sending a second location information report to the location server by an end of a configured report expiration time.

Clause 13. The method of any of clauses 10-12, wherein the entity in the wireless network is a serving base station, and the indication that there is no update for at least the portion of the location information that is related to the at least one location measurement comprises a Physical layer waveform sent to the serving base station.

Clause 14. The method of clause 13, wherein the Physical layer waveform comprises a Physical Uplink Control Channel (PUCCH) message.

Clause 15. The method of any of clauses 13-14, further comprising: receiving a configured grant from the serving base station for transmitting location information reports; transmitting a Configured Grant Physical Uplink Shared Channel (CG-PUSCH) message providing information to the serving base station to modify the configured grant.

Clause 16. The method of clause 15, wherein the information to modify the configured grant comprises a next opportunity to transmit a location information report or a change in periodicity for transmitting location information reports.

Clause 17. The method of clause 13, wherein the Physical layer waveform comprises a Physical Uplink Shared Channel (PUSCH) message.

Clause 18. The method of clause 17, further comprising receiving a configured grant from the serving base station for transmitting location information reports, wherein the PUSCH message with the indication that there is no update for at least the portion of the location information that is related to the at least one location measurement is transmitted in response to the configured grant.

Clause 19. The method of any of clauses 17-18, wherein the PUSCH message comprises a Demodulation Reference Signal (DMRS) and wherein the indication that there is no update for at least the portion of the location information that is related to the at least one location measurement comprises the PUSCH message including no data symbols.

Clause 20. The method of any of clauses 1-19, wherein the entity in the wireless network is the location server, and the indication that there is no update for at least the portion of the location information that is related to the at least one location measurement comprises a bit in the location information report to the location server that indicates there is no update for the at least one location measurement.

Clause 21. The method of clause 20, wherein the bit in the location information report to the location server indicates that there is no update for all measurement elements in the location information report.

Clause 22. The method of clause 20, wherein the bit in the location information report to the location server indicates that there is no update for one measurement element and that other measurement elements in the location information report are updated.

Clause 23. A user equipment (UE) configured for supporting location services in a wireless network comprising: at least one wireless transceiver configured to wirelessly communicate with at least one wireless network; at least one memory; and at least one processor coupled to the at least one wireless transceiver and the at least one memory and configured to: generate a first set of location measurements comprising at least one location measurement; send, via the at least one wireless transceiver, location information report to a location server in the wireless network for location determination of the UE, wherein the location information report comprises location information based on the first set of location measurements; generate a second set of location measurements comprising the at least one location measurement; and provide, via the at least one wireless transceiver, an indication to an entity in the wireless network that there is no update for at least a portion of the location information that is related to the at least one location measurement.

Clause 24. The UE of clause 23, wherein the location information comprises at least one of the first set of location measurements, a position estimate determined based on the first set of location measurements, or a combination thereof.

Clause 25. The UE of any of clauses 23-24, wherein the at least one processor is further configured to determine that a change in location of the UE between generating the first set of location measurements and generating the second set of location measurements is below a threshold, wherein the at least one processor is configured to provide the indication that there is no update for at least the portion of the location information that is related to the at least one location measurement is in response to the change in location being less than the threshold.

Clause 26. The UE of any of clauses 23-25, wherein the at least one processor is further configured to determine a change in the at least one location measurement in the first set of location measurements and the at least one location measurement in the second set of location measurements is below a threshold, wherein the at least one processor is configured to provide the indication that there is no update for at least the portion of the location information that is related to the at least one location measurement is in response to the change being less than the threshold.

Clause 27. The UE of clause 26, wherein the threshold is network configured.

Clause 28. The UE of any of clauses 23-27, wherein the UE is configured to provide the indication to the entity using one of radio resource control (RRC), Long Term Evolution (LTE) positioning protocol (LPP), medium access control-control element (MAC-CE), or downlink control information (DCI).

Clause 29. The UE of any of clauses 23-28, wherein the at least one processor is further configured to: receive, via the at least one wireless transceiver, an accuracy quality of service requirement; and determine the accuracy quality of service requirement is satisfied without updating the at least the portion of the location information that is related to the at least one location measurement, wherein providing the indication that there is no update for at least the portion of the location information that is related to the at least one location measurement is in response to the determination that the accuracy quality of service requirement is satisfied.

Clause 30. The UE of any of clauses 23-29, wherein the at least one processor is further configured to receive a configuration for a number of consecutive location information reports for which the indication of no update may be sent.

Clause 31. The UE of any of clauses 23-30, wherein the at least one processor is further configured to receive, via the at least one wireless transceiver, a location request for periodic or triggered location measurements, wherein the at least one processor is configured to send the location information report and provide the indication that there is no update for at least the portion of the location information that is related to the at least one location measurement in response to the location request for periodic or triggered location measurements.

Clause 32. The UE of any of clauses 23-31, wherein the indication that there is no update for at least the portion of the location information that is related to the at least one location measurement comprises a bit that indicates there is no update for the at least one location measurement.

Clause 33. The UE of any of clauses 23-32, wherein the indication that there is no update for at least the portion of the location information that is related to the at least one location measurement comprises a bit that indicates there is no update for all location information in the location information report.

Clause 34. The UE of any of clauses 23-33, wherein the at least one processor is further configured to provide the indication that there is no update for at least the portion of the location information that is related to the at least one location measurement by being configured to not send a second location information report to the location server by an end of a configured report expiration time.

Clause 35. The UE of any of clauses 23-34, wherein the entity in the wireless network is a serving base station, and the indication that there is no update for at least the portion of the location information that is related to the at least one location measurement comprises a Physical layer waveform sent to the serving base station.

Clause 36. The UE of clause 35, wherein the Physical layer waveform comprises a Physical Uplink Control Channel (PUCCH) message.

Clause 37. The UE of any of clauses 35-36, wherein the at least one processor is further configured to: receive, via the at least one wireless transceiver, a configured grant from the serving base station for transmitting location information reports; transmit a Configured Grant Physical Uplink Shared Channel (CG-PUSCH) message providing information to the serving base station to modify the configured grant.

Clause 38. The UE of clause 37, wherein the information to modify the configured grant comprises a next opportunity to transmit a location information report or a change in periodicity for transmitting location information reports.

Clause 39. The UE of clause 35, wherein the Physical layer waveform comprises a Physical Uplink Shared Channel (PUSCH) message.

Clause 40. The UE of clause 39, wherein the at least one processor is further configured to receive a configured grant from the serving base station for transmitting location information reports, wherein the PUSCH message with the indication that there is no update for at least the portion of the location information that is related to the at least one location measurement is transmitted in response to the configured grant.

Clause 41. The UE of any of clauses 39-40, wherein the PUSCH message comprises a Demodulation Reference Signal (DMRS) and wherein the indication that there is no update for at least the portion of the location information that is related to the at least one location measurement comprises the PUSCH message including no data symbols.

Clause 42. The UE of any of clauses 23-41, wherein the entity in the wireless network is the location server, and the indication that there is no update for at least the portion of the location information that is related to the at least one location measurement comprises a bit in the location information report to the location server that indicates there is no update for the at least one location measurement.

Clause 43. The UE of clause 42, wherein the bit in the location information report to the location server indicates that there is no update for all measurement elements in the location information report.

Clause 44. The UE of any of clauses 42-43, wherein the bit in the location information report to the location server indicates that there is no update for one measurement element and that other measurement elements in the location information report are updated.

Clause 45. A user equipment (UE) configured for supporting location services in a wireless network comprising: means for generating a first set of location measurements comprising at least one location measurement; means for sending a location information report to a location server in the wireless network for location determination of the UE, wherein the location information report comprises location information based on the first set of location measurements; means for generating a second set of location measurements comprising the at least one location measurement; and means for providing an indication to an entity in the wireless network that there is no update for at least a portion of the location information that is related to the at least one location measurement.

Clause 46. The UE of clause 45, wherein the location information comprises at least one of the first set of location measurements, a position estimate determined based on the first set of location measurements, or a combination thereof.

Clause 47. The UE of any of clauses 45-46, further comprising means for determining that a change in location of the UE between generating the first set of location measurements and generating the second set of location measurements is below a threshold, wherein the means for providing the indication that there is no update for at least the portion of the location information that is related to the at least one location measurement provides the indication in response to the change in location being less than the threshold.

Clause 48. The UE of any of clauses 45-47, further comprising means for determining a change in the at least one location measurement in the first set of location measurements and the at least one location measurement in the second set of location measurements is below a threshold, wherein the means for providing the indication that there is no update for at least the portion of the location information that is related to the at least one location measurement provides the indication in response to the change being less than the threshold.

Clause 49. The UE of clause 48, wherein the threshold is network configured.

Clause 50. The UE of any of clauses 45-49, wherein the UE is configured to provide the indication to the entity using one of radio resource control (RRC), Long Term Evolution (LTE) positioning protocol (LPP), medium access control-control element (MAC-CE), or downlink control information (DCI).

Clause 51. The UE of any of clauses 45-50, further comprising: means for receiving an accuracy quality of service requirement; and means for determining the accuracy quality of service requirement is satisfied without updating the at least the portion of the location information that is related to the at least one location measurement, wherein the means for providing the indication that there is no update for at least the portion of the location information that is related to the at least one location measurement provides the response in response to the determination that the accuracy quality of service requirement is satisfied.

Clause 52. The UE of any of clauses 45-51, further comprising means for receiving a configuration for a number of consecutive location information reports for which the indication of no update may be sent.

Clause 53. The UE of any of clauses 45-52, further comprising means for receiving a location request for periodic or triggered location measurements, wherein the means for sending the location information report and the means for providing the indication that there is no update for at least the portion of the location information that is related to the at least one location measurement provide the indication in response to the location request for periodic or triggered location measurements.

Clause 54. The UE of any of clauses 45-53, wherein the indication that there is no update for at least the portion of the location information that is related to the at least one location measurement comprises a bit that indicates there is no update for the at least one location measurement.

Clause 55. The UE of any of clauses 45-54, wherein the indication that there is no update for at least the portion of the location information that is related to the at least one location measurement comprises a bit that indicates there is no update for all location information in the location information report.

Clause 56. The UE of any of clauses 45-55, wherein the indication that there is no update for at least the portion of the location information that is related to the at least one location measurement comprises not sending a second location information report to the location server by an end of a configured report expiration time.

Clause 57. The UE of any of clauses 45-56, wherein the entity in the wireless network is a serving base station, and the indication that there is no update for at least the portion of the location information that is related to the at least one location measurement comprises a Physical layer waveform sent to the serving base station.

Clause 58. The UE of clause 57, wherein the Physical layer waveform comprises a Physical Uplink Control Channel (PUCCH) message.

Clause 59. The UE of any of clauses 57-58, further comprising: means for receiving a configured grant from the serving base station for transmitting location information reports; means for transmitting a Configured Grant Physical Uplink Shared Channel (CG-PUSCH) message providing information to the serving base station to modify the configured grant.

Clause 60. The UE of clause 59, wherein the information to modify the configured grant comprises a next opportunity to transmit a location information report or a change in periodicity for transmitting location information reports.

Clause 61. The UE of clause 57, wherein the Physical layer waveform comprises a Physical Uplink Shared Channel (PUSCH) message.

Clause 62. The UE of clause 61, further comprising means for receiving a configured grant from the serving base station for transmitting location information reports, wherein the PUSCH message with the indication that there is no update for at least the portion of the location information that is related to the at least one location measurement is transmitted in response to the configured grant.

Clause 63. The UE of any of clauses 61-62, wherein the PUSCH message comprises a Demodulation Reference Signal (DMRS) and wherein the indication that there is no update for at least the portion of the location information that is related to the at least one location measurement comprises the PUSCH message including no data symbols.

Clause 64. The UE of any of clauses 45-63, wherein the entity in the wireless network is the location server, and the indication that there is no update for at least the portion of the location information that is related to the at least one location measurement comprises a bit in the location information report to the location server that indicates there is no update for the at least one location measurement.

Clause 65. The UE of clause 64, wherein the bit in the location information report to the location server indicates that there is no update for all measurement elements in the location information report.

Clause 66. The UE of any of clauses 64-65, wherein the bit in the location information report to the location server indicates that there is no update for one measurement element and that other measurement elements in the location information report are updated.

Clause 67. A non-transitory storage medium including program code stored thereon, the program code is operable to configure at least one processor in a user equipment (UE) for supporting location services in a wireless network, the program code comprising instructions to: generate a first set of location measurements comprising at least one location measurement; send location information report to a location server in the wireless network for location determination of the UE, wherein the location information report comprises location information based on the first set of location measurements; generate a second set of location measurements comprising the at least one location measurement; and provide an indication to an entity in the wireless network that there is no update for at least a portion of the location information that is related to the at least one location measurement.

Clause 68. The non-transitory storage medium of clause 67, wherein the location information comprises at least one of the first set of location measurements, a position estimate determined based on the first set of location measurements, or a combination thereof.

Clause 69. The non-transitory storage medium of any of clauses 67-68, wherein the program code further comprises instructions to determine that a change in location of the UE between generating the first set of location measurements and generating the second set of location measurements is below a threshold, wherein the program code comprises instructions to provide the indication that there is no update for at least the portion of the location information that is related to the at least one location measurement in response to the change in location being less than the threshold.

Clause 70. The non-transitory storage medium of any of clauses 67-69, wherein the program code further comprises instructions to determine a change in the at least one location measurement in the first set of location measurements and the at least one location measurement in the second set of location measurements is below a threshold, wherein the program code comprises instructions to provide the indication that there is no update for at least the portion of the location information that is related to the at least one location measurement in response to the change being less than the threshold.

Clause 71. The non-transitory storage medium of any of clauses 67-70, wherein the threshold is network configured.

Clause 72. The non-transitory storage medium of clause 71, wherein the UE is configured to provide the indication to the entity using one of radio resource control (RRC), Long Term Evolution (LTE) positioning protocol (LPP), medium access control control element (MAC-CE), or downlink control information (DCI).

Clause 73. The non-transitory storage medium of any of clauses 67-72, wherein the program code further comprises instructions to: receive an accuracy quality of service requirement; and determine the accuracy quality of service requirement is satisfied without updating the at least the portion of the location information that is related to the at least one location measurement, wherein providing the indication that there is no update for at least the portion of the location information that is related to the at least one location measurement is in response to the determination that the accuracy quality of service requirement is satisfied.

Clause 74. The non-transitory storage medium of any of clauses 67-73, wherein the program code further comprises instructions to receive a configuration for a number of consecutive location information reports for which the indication of no update may be sent.

Clause 75. The non-transitory storage medium of any of clauses 67-74, wherein the program code further comprises instructions to receive a location request for periodic or triggered location measurements, wherein the program code comprises instructions to send the location information report and provide the indication that there is no update for at least the portion of the location information that is related to the at least one location measurement in response to the location request for periodic or triggered location measurements.

Clause 76. The non-transitory storage medium of any of clauses 67-75, wherein the indication that there is no update for at least the portion of the location information that is related to the at least one location measurement comprises a bit that indicates there is no update for the at least one location measurement.

Clause 77. The non-transitory storage medium of any of clauses 67-76, wherein the indication that there is no update for at least the portion of the location information that is related to the at least one location measurement comprises a bit that indicates there is no update for all location information in the location information report.

Clause 78. The non-transitory storage medium of any of clauses 67-77, wherein the program code further comprises instructions to provide the indication that there is no update for at least the portion of the location information that is related to the at least one location measurement comprises instructions to not send a second location information report to the location server by an end of a configured report expiration time.

Clause 79. The non-transitory storage medium of any of clauses 67-78, wherein the entity in the wireless network is a serving base station, and the indication that there is no update for at least the portion of the location information that is related to the at least one location measurement comprises a Physical layer waveform sent to the serving base station.

Clause 80. The non-transitory storage medium of clause 79, wherein the Physical layer waveform comprises a Physical Uplink Control Channel (PUCCH) message.

Clause 81. The non-transitory storage medium of any of clauses 79-80, wherein the program code further comprises instructions to: receive a configured grant from the serving base station for transmitting location information reports; transmit a Configured Grant Physical Uplink Shared Channel (CG-PUSCH) message providing information to the serving base station to modify the configured grant.

Clause 82. The non-transitory storage medium of clause 81, wherein the information to modify the configured grant comprises a next opportunity to transmit a location information report or a change in periodicity for transmitting location information reports.

Clause 83. The non-transitory storage medium of clause 79, wherein the Physical layer waveform comprises a Physical Uplink Shared Channel (PUSCH) message.

Clause 84. The non-transitory storage medium of clause 83, wherein the program code further comprises instructions to receive a configured grant from the serving base station for transmitting location information reports, wherein the PUSCH message with the indication that there is no update for at least the portion of the location information that is related to the at least one location measurement is transmitted in response to the configured grant.

Clause 85. The non-transitory storage medium of any of clauses 83-84, wherein the PUSCH message comprises a Demodulation Reference Signal (DMRS) and wherein the indication that there is no update for at least the portion of the location information that is related to the at least one location measurement comprises the PUSCH message including no data symbols.

Clause 86. The non-transitory storage medium of any of clauses 67-85, wherein the entity in the wireless network is the location server, and the indication that there is no update for at least the portion of the location information that is related to the at least one location measurement comprises a bit in the location information report to the location server that indicates there is no update for the at least one location measurement.

Clause 87. The non-transitory storage medium of clause 86, wherein the bit in the location information report to the location server indicates that there is no update for all measurement elements in the location information report.

Clause 88. The non-transitory storage medium of any of clauses 86-87, wherein the bit in the location information report to the location server indicates that there is no update for one measurement element and that other measurement elements in the location information report are updated.

Clause 89. A method performed by a base station serving a user equipment (UE) in a wireless network for supporting location services for the UE comprising: receiving a location information report from the UE comprising location information based on a set of location measurements comprising at least one location measurement generated by the UE; and receiving an indication from the UE that there is no update for at least a portion of the location information that is related to the at least one location measurement.

Clause 90. The method of clause 89, wherein the location information comprises at least one of the set of location measurements, a position estimate determined by the UE based on the set of location measurements, or a combination thereof.

Clause 91. The method of any of clauses 89-90, further comprising sending the location information report to a location server, and sending a second indication that there is no update for at least the portion of the location information that is related to the at least one location measurement to an external client.

Clause 92. The method of clause 91, further comprising sending a third indication to the location server that the UE did not update the at least the portion of the location information that is related to the at least one location measurement.

Clause 93. The method of any of clauses 89-92, further comprising sending the location information report to a location server, and sending the indication that there is no update for at least the portion of the location information that is related to the at least one location measurement to the location server.

Clause 94. The method of any of clauses 89-93, wherein the location information report and the indication that there is no update for at least the portion of the location information that is related to the at least one location measurement are for periodic or triggered location measurements.

Clause 95. The method of any of clauses 89-94, wherein the indication that there is no update for at least the portion of the location information that is related to the at least one location measurement comprises a bit that indicates there is no update for the at least one location measurement.

Clause 96. The method of any of clauses 89-95, wherein the indication that there is no update for at least the portion of the location information that is related to the at least one location measurement comprises a bit that indicates there is no update for all of the location information in the location information report.

Clause 97. The method of any of clauses 89-96, wherein the indication that there is no update for at least the portion of the location information that is related to the at least one location measurement comprises a Physical layer waveform.

Clause 98. The method of clause 97, wherein the Physical layer waveform comprises a Physical Uplink Control Channel (PUCCH) message.

Clause 99. The method of any of clauses 97-98, further comprising: sending a configured grant to the UE for transmitting location information reports; receiving a Configured Grant Physical Uplink Shared Channel (CG-PUSCH) message from the UE providing information to modify the configured grant.

Clause 100. The method of clause 99, wherein the information to modify the configured grant comprises a next opportunity to transmit a location information report or a change in periodicity for transmitting location information reports.

Clause 101. The method of clause 97, wherein the Physical layer waveform comprises a Physical Uplink Shared Channel (PUSCH) message.

Clause 102. The method of clause 101, further comprising sending a configured grant to the UE for transmitting location information reports, wherein the PUSCH message with the indication that there is no update for at least the portion of the location information that is related to the at least one location measurement is transmitted in response to the configured grant.

Clause 103. The method of any of clauses 101-102, wherein the PUSCH message comprises a Demodulation Reference Signal (DMRS) and wherein the indication that there is no update for at least the portion of the location information that is related to the at least one location measurement comprises the PUSCH message including no data symbols.

Clause 104. A base station configured for supporting location services for a user equipment (UE), the base station serving the UE in a wireless network, comprising: an external interface configured to wirelessly communicate with entities in the wireless network; at least one memory; at least one processor coupled to the external interface and the at least one memory, wherein the at least one processor is configured to: receive a location information report from the UE comprising location information based on a set of location measurements comprising at least one location measurement generated by the UE; and receive an indication from the UE that there is no update for at least a portion of the location information that is related to the at least one location measurement.

Clause 105. The base station of clause 104, wherein the location information comprises at least one of the set of location measurements, a position estimate determined by the UE based on the set of location measurements, or a combination thereof.

Clause 106. The base station of any of clauses 104-105, wherein the at least one processor is further configured to send the location information report to a location server, and send a second indication that there is no update for at least the portion of the location information that is related to the at least one location measurement to an external client.

Clause 107. The base station of clause 106, wherein the at least one processor is further configured to send a third indication to the location server that the UE did not update the at least the portion of the location information that is related to the at least one location measurement.

Clause 108. The base station of any of clauses 104-107, wherein the at least one processor is further configured to send the location information report to a location server, and send the indication that there is no update for at least the portion of the location information that is related to the at least one location measurement to the location server.

Clause 109. The base station of any of clauses 104-108, wherein the location information report and the indication that there is no update for at least the portion of the location information that is related to the at least one location measurement are for periodic or triggered location measurements.

Clause 110. The base station of any of clauses 104-109, wherein the indication that there is no update for at least the portion of the location information that is related to the at least one location measurement comprises a bit that indicates there is no update for the at least one location measurement.

Clause 111. The base station of any of clauses 104-110, wherein the indication that there is no update for at least the portion of the location information that is related to the at least one location measurement comprises a bit that indicates there is no update for all of the location information in the location information report.

Clause 112. The base station of any of clauses 104-111, wherein the indication that there is no update for at least the portion of the location information that is related to the at least one location measurement comprises a Physical layer waveform.

Clause 113. The base station of clause 112, wherein the Physical layer waveform comprises a Physical Uplink Control Channel (PUCCH) message.

Clause 114. The base station of any of clauses 112-113, wherein the at least one processor is further configured to: send a configured grant to the UE for transmitting location information reports; receive a Configured Grant Physical Uplink Shared Channel (CG-PUSCH) message from the UE providing information to modify the configured grant.

Clause 115. The base station of clause 114, wherein the information to modify the configured grant comprises a next opportunity to transmit a location information report or a change in periodicity for transmitting location information reports.

Clause 116. The base station of clause 112, wherein the Physical layer waveform comprises a Physical Uplink Shared Channel (PUSCH) message.

Clause 117. The base station of clause 116, wherein the at least one processor is further configured to send a configured grant to the UE for transmitting location information reports, wherein the PUSCH message with the indication that there is no update for at least the portion of the location information that is related to the at least one location measurement is transmitted in response to the configured grant.

Clause 118. The base station of any of clauses 116-117, wherein the PUSCH message comprises a Demodulation Reference Signal (DMRS) and wherein the indication that there is no update for at least the portion of the location information that is related to the at least one location measurement comprises the PUSCH message including no data symbols.

Clause 119. A base station configured for supporting location services for a user equipment (UE), the base station serving the UE in a wireless network, comprising: means for receiving a location information report from the UE comprising location information based on a set of location measurements comprising at least one location measurement generated by the UE; and means for receiving an indication from the UE that there is no update for at least a portion of the location information that is related to the at least one location measurement.

Clause 120. The base station of clause 119, wherein the location information comprises at least one of the set of location measurements, a position estimate determined by the UE based on the set of location measurements, or a combination thereof.

Clause 121. The base station of any of clauses 119-120, further comprising means for sending the location information report to a location server, and means for sending a second indication that there is no update for at least the portion of the location information that is related to the at least one location measurement to an external client.

Clause 122. The base station of clause 121, further comprising means for sending a third indication to the location server that the UE did not update the at least the portion of the location information that is related to the at least one location measurement.

Clause 123. The base station of any of clauses 119-122, further comprising means for sending the location information report to a location server, and means for sending the indication that there is no update for at least the portion of the location information that is related to the at least one location measurement to the location server.

Clause 124. The base station of any of clauses 119-123, wherein the location information report and the indication that there is no update for at least the portion of the location information that is related to the at least one location measurement are for periodic or triggered location measurements.

Clause 125. The base station of any of clauses 119-124, wherein the indication that there is no update for at least the portion of the location information that is related to the at least one location measurement comprises a bit that indicates there is no update for the at least one location measurement.

Clause 126. The base station of any of clauses 119-125, wherein the indication that there is no update for at least the portion of the location information that is related to the at least one location measurement comprises a bit that indicates there is no update for all of the location information in the location information report.

Clause 127. The base station of any of clauses 119-126, wherein the indication that there is no update for at least the portion of the location information that is related to the at least one location measurement comprises a Physical layer waveform.

Clause 128. The base station of clause 127, wherein the Physical layer waveform comprises a Physical Uplink Control Channel (PUCCH) message.

Clause 129. The base station of any of clauses 127-128, further comprising: means for sending a configured grant to the UE for transmitting location information reports; means for receiving a Configured Grant Physical Uplink Shared Channel (CG-PUSCH) message from the UE providing information to modify the configured grant.

Clause 130. The base station of clause 129, wherein the information to modify the configured grant comprises a next opportunity to transmit a location information report or a change in periodicity for transmitting location information reports.

Clause 131. The base station of clause 127, wherein the Physical layer waveform comprises a Physical Uplink Shared Channel (PUSCH) message.

Clause 132. The base station of clause 131, further comprising means for sending a configured grant to the UE for transmitting location information reports, wherein the PUSCH message with the indication that there is no update for at least the portion of the location information that is related to the at least one location measurement is transmitted in response to the configured grant.

Clause 133. The base station of any of clauses 131-132, wherein the PUSCH message comprises a Demodulation Reference Signal (DMRS) and wherein the indication that there is no update for at least the portion of the location information that is related to the at least one location measurement comprises the PUSCH message including no data symbols.

Clause 134. A non-transitory storage medium including program code stored thereon, the program code is operable to configure at least one processor in a base station for supporting location services for a user equipment (UE), the base station serving the UE in a wireless network, the program code comprising instructions to: receive a location information report from the UE comprising location information based on a set of location measurements comprising at least one location measurement generated by the UE; and receive an indication from the UE that there is no update for at least a portion of the location information that is related to the at least one location measurement.

Clause 135. The non-transitory storage medium of clause 134, wherein the location information comprises at least one of the set of location measurements, a position estimate determined by the UE based on the set of location measurements, or a combination thereof.

Clause 136. The non-transitory storage medium of any of clauses 134-135, wherein the program code further comprises instructions to send the location information report to a location server, and send a second indication that there is no update for at least the portion of the location information that is related to the at least one location measurement to an external client.

Clause 137. The non-transitory storage medium of clause 136, wherein the program code further comprises instructions to send a third indication to the location server that the UE did not update the at least the portion of the location information that is related to the at least one location measurement.

Clause 138. The non-transitory storage medium of any of clauses 134-137, wherein the program code further comprises instructions to send the location information report to a location server, and send the indication that there is no update for at least the portion of the location information that is related to the at least one location measurement to the location server.

Clause 139. The non-transitory storage medium of any of clauses 134-138, wherein the location information report and the indication that there is no update for at least the portion of the location information that is related to the at least one location measurement are for periodic or triggered location measurements.

Clause 140. The non-transitory storage medium of any of clauses 134-139, wherein the indication that there is no update for at least the portion of the location information that is related to the at least one location measurement comprises a bit that indicates there is no update for the at least one location measurement.

Clause 141. The non-transitory storage medium of any of clauses 134-140, wherein the indication that there is no update for at least the portion of the location information that is related to the at least one location measurement comprises a bit that indicates there is no update for all of the location information in the location information report.

Clause 142. The non-transitory storage medium of any of clauses 134-141, wherein the indication that there is no update for at least the portion of the location information that is related to the at least one location measurement comprises a Physical layer waveform.

Clause 143. The non-transitory storage medium of clause 142, wherein the Physical layer waveform comprises a Physical Uplink Control Channel (PUCCH) message.

Clause 144. The non-transitory storage medium of any of clauses 142-143, wherein the program code further comprises instructions to: send a configured grant to the UE for transmitting location information reports; receive a Configured Grant Physical Uplink Shared Channel (CG-PUSCH) message from the UE providing information to modify the configured grant.

Clause 145. The non-transitory storage medium of clause 144, wherein the information to modify the configured grant comprises a next opportunity to transmit a location information report or a change in periodicity for transmitting location information reports.

Clause 146. The non-transitory storage medium of clause 142, wherein the Physical layer waveform comprises a Physical Uplink Shared Channel (PUSCH) message.

Clause 147. The non-transitory storage medium of clause 146, wherein the program code further comprises instructions to send a configured grant to the UE for transmitting location information reports, wherein the PUSCH message with the indication that there is no update for at least the portion of the location information that is related to the at least one location measurement is transmitted in response to the configured grant.

Clause 148. The non-transitory storage medium of any of clauses 146-147, wherein the PUSCH message comprises a Demodulation Reference Signal (DMRS) and wherein the indication that there is no update for at least the portion of the location information that is related to the at least one location measurement comprises the PUSCH message including no data symbols.

Clause 149. A method performed by a location server in a wireless network for supporting location services for a user equipment (UE) comprising: receiving a location information report from the UE comprising location information based on a set of location measurements comprising at least one location measurement generated by the UE; and detecting an indication from the UE that there is no update for at least a portion of the location information that is related to the at least one location measurement.

Clause 150. The method of clause 149, wherein the location information comprises at least one of the set of location measurements, a position estimate determined by the UE based on the set of location measurements, or a combination thereof.

Clause 151. The method of any of clauses 149-150, further comprising sending a location request for periodic or triggered location measurements to the UE, wherein the location information report is sent by the UE in response to the location request for periodic or triggered location measurements.

Clause 152. The method of any of clauses 149-151, further comprising sending the UE a threshold configuration for the UE to determine when an update to at least the portion of the location information is not required.

Clause 153. The method of any of clauses 149-152, further comprising sending the UE a number of consecutive location information reports for which no update may be sent.

Clause 154. The method of any of clauses 149-153, further comprising sending the UE an accuracy quality of service requirement, wherein an update to the at least the portion of the location information is not required to be reported in a location measurement report when the accuracy quality of service requirement is satisfied without updating the at least the portion of the location information.

Clause 155. The method of any of clauses 149-154, wherein detecting the indication that there is no update for at least the portion of the location information that is related to the at least one location measurement comprises determining that the UE did not send a second location information report by an end of a configured report expiration time.

Clause 156. The method of clause 155, further comprising receiving the indication from a serving base station that the UE is in a connected state after detecting the indication that there is no update for at least the portion of the location information that is related to the at least one location measurement.

Clause 157. The method of any of clauses 149-156, wherein detecting the indication that there is no update for at least the portion of the location information that is related to the at least one location measurement comprises receiving the indication from a serving base station that the UE did not update the at least the portion of the location information that is related to the at least one location measurement.

Clause 158. The method of any of clauses 149-157, wherein detecting the indication that there is no update for at least the portion of the location information that is related to the at least one location measurement comprises receiving the indication that there is no update for at least the portion of the location information that is related to the at least one location measurement from the UE.

Clause 159. The method of clause 158, wherein the indication that there is no update for at least the portion of the location information that is related to the at least one location measurement comprises a bit that indicates there is no update for the at least one location measurement.

Clause 160. The method of clause 158, wherein the indication that there is no update for at least the portion of the location information that is related to the at least one location measurement comprises a bit that indicates there is no update for all location information in the location information report.

Clause 161. A location server configured for supporting location services for a user equipment (UE) in a wireless network comprising: an external interface configured to communicate with entities in the wireless network; at least one memory; at least one processor coupled to the external interface and the at least one memory, wherein the at least one processor is configured to: receive a location information report from the UE comprising location information based on a set of location measurements comprising at least one location measurement generated by the UE; and detect an indication from the UE that there is no update for at least a portion of the location information that is related to the at least one location measurement.

Clause 162. The location server of clause 161, wherein the location information comprises at least one of the set of location measurements, a position estimate determined by the UE based on the set of location measurements, or a combination thereof.

Clause 163. The location server of any of clauses 161-162, wherein the at least one processor is further configured to send a location request for periodic or triggered location measurements to the UE, wherein the location information report is sent by the UE in response to the location request for periodic or triggered location measurements.

Clause 164. The location server of any of clauses 161-163, wherein the at least one processor is further configured to send the UE a threshold configuration for the UE to determine when an update to at least the portion of the location information is not required.

Clause 165. The location server of any of clauses 161-164, wherein the at least one processor is further configured to send the UE a number of consecutive location information reports for which no update may be sent.

Clause 166. The location server of any of clauses 161-165, wherein the at least one processor is further configured to send the UE an accuracy quality of service requirement, wherein an update to the at least the portion of the location information is not required to be reported in a location measurement report when the accuracy quality of service requirement is satisfied without updating at least the portion of the location information.

Clause 167. The location server of any of clauses 161-166, wherein the at least one processor is configured to detect the indication that there is no update for at least the portion of the location information that is related to the at least one location measurement by being configured to determine that the UE did not send a second location information report by an end of a configured report expiration time.

Clause 168. The location server of clause 167, wherein the at least one processor is further configured to receive the indication from a serving base station that the UE is in a connected state after the indication that there is no update for at least the portion of the location information that is related to the at least one location measurement is detected.

Clause 169. The location server of any of clauses 161-168, wherein the at least one processor is configured to detect the indication that there is no update for at least the portion of the location information that is related to the at least one location measurement by being configured to receive the indication from a serving base station that the UE did not update the at least the portion of the location information that is related to the at least one location measurement.

Clause 170. The location server of any of clauses 161-169, wherein the at least one processor is configured to detect the indication that there is no update for at least the portion of the location information that is related to the at least one location measurement by being configured to receive the indication that there is no update for at least the portion of the location information that is related to the at least one location measurement from the UE.

Clause 171. The location server of clause 170, wherein the indication that there is no update for at least the portion of the location information that is related to the at least one location measurement comprises a bit that indicates there is no update for the at least one location measurement.

Clause 172. The location server of clause 170, wherein the indication that there is no update for at least the portion of the location information that is related to the at least one location measurement comprises a bit that indicates there is no update for all location information in the location information report.

Clause 173. A location server configured for supporting location services for a user equipment (UE) in a wireless network comprising: means for receiving a location information report from the UE comprising location information based on a set of location measurements comprising at least one location measurement generated by the UE; and means for detecting an indication from the UE that there is no update for at least a portion of the location information that is related to the at least one location measurement.

Clause 174. The location server of clause 173, wherein the location information comprises at least one of the set of location measurements, a position estimate determined by the UE based on the set of location measurements, or a combination thereof.

Clause 175. The location server of any of clauses 173-174, further comprising means for sending a location request for periodic or triggered location measurements to the UE, wherein the location information report is sent by the UE in response to the location request for periodic or triggered location measurements.

Clause 176. The location server of any of clauses 173-175, further comprising means for sending the UE a threshold configuration for the UE to determine when an update to at least the portion of the location information is not required.

Clause 177. The location server of any of clauses 173-176, further comprising means for sending the UE a number of consecutive location information reports for which no update may be sent.

Clause 178. The location server of any of clauses 173-177, further comprising means for sending the UE an accuracy quality of service requirement, wherein an update to the at least the portion of the location information is not required to be reported in a location measurement report when the accuracy quality of service requirement is satisfied without updating the at least the portion of the location information.

Clause 179. The location server of any of clauses 173-178, wherein the means for detecting the indication that there is no update for at least the portion of the location information that is related to the at least one location measurement determines that the UE did not send a second location information report by an end of a configured report expiration time.

Clause 180. The location server of clause 179, further comprising means for receiving the indication from a serving base station that the UE is in a connected state after detecting the indication that there is no update for at least the portion of the location information that is related to the at least one location measurement.

Clause 181. The location server of any of clauses 173-180, wherein the means for detecting the indication that there is no update for at least the portion of the location information that is related to the at least one location measurement comprises means for receiving the indication from a serving base station that the UE did not update the at least the portion of the location information that is related to the at least one location measurement.

Clause 182. The location server of any of clauses 173-181, wherein means for detecting the indication that there is no update for at least the portion of the location information that is related to the at least one location measurement comprises means for receiving the indication that there is no update for at least the portion of the location information that is related to the at least one location measurement from the UE.

Clause 183. The location server of clause 182, wherein the indication that there is no update for at least the portion of the location information that is related to the at least one location measurement comprises a bit that indicates there is no update for the at least one location measurement.

Clause 184. The location server of clause 182, wherein the indication that there is no update for at least the portion of the location information that is related to the at least one location measurement comprises a bit that indicates there is no update for all location information in the location information report.

Clause 185. A non-transitory storage medium including program code stored thereon, the program code is operable to configure at least one processor in a location server for supporting location services for a user equipment (UE) in a wireless network, the program code comprises instructions to: receive a location information report from the UE comprising location information based on a set of location measurements comprising at least one location measurement generated by the UE; and detect an indication from the UE that there is no update for at least a portion of the location information that is related to the at least one location measurement.

Clause 186. The non-transitory storage medium of clause 185, wherein the location information comprises at least one of the set of location measurements, a position estimate determined by the UE based on the set of location measurements, or a combination thereof.

Clause 187. The non-transitory storage medium of any of clauses 185-186, wherein the program code further comprises instructions to send a location request for periodic or triggered location measurements to the UE, wherein the location information report is sent by the UE in response to the location request for periodic or triggered location measurements.

Clause 188. The non-transitory storage medium of any of clauses 185-187, wherein the program code further comprises instructions to send the UE a threshold configuration for the UE to determine when an update to at least the portion of the location information is not required.

Clause 189. The non-transitory storage medium of any of clauses 185-188, wherein the program code further comprises instructions to send the UE a number of consecutive location information reports for which no update may be sent.

Clause 190. The non-transitory storage medium of any of clauses 185-189, wherein the program code further comprises instructions to send the UE an accuracy quality of service requirement, wherein an update to the at least the portion of the location information is not required to be reported in a location measurement report when the accuracy quality of service requirement is satisfied without updating at least the portion of the location information.

Clause 191. The non-transitory storage medium of any of clauses 185-190, wherein the instructions to detect the indication that there is no update for at least the portion of the location information that is related to the at least one location measurement comprises instructions to determine that the UE did not send a second location information report by an end of a configured report expiration time.

Clause 192. The non-transitory storage medium of clause 191, wherein the program code further comprises instructions to receive the indication from a serving base station that the UE is in a connected state after the indication that there is no update for at least the portion of the location information that is related to the at least one location measurement is detected.

Clause 193. The non-transitory storage medium of any of clauses 185-192, wherein the instructions to detect the indication that there is no update for at least the portion of the location information that is related to the at least one location measurement comprises instructions to receive the indication from a serving base station that the UE did not update the at least the portion of the location information that is related to the at least one location measurement.

Clause 194. The non-transitory storage medium of any of clauses 185-193, wherein the instructions to detect the indication that there is no update for at least the portion of the location information that is related to the at least one location measurement comprises instructions to receive the indication that there is no update for at least the portion of the location information that is related to the at least one location measurement from the UE.

Clause 195. The non-transitory storage medium of clause 194, wherein the indication that there is no update for at least the portion of the location information that is related to the at least one location measurement comprises a bit that indicates there is no update for the at least one location measurement.

Clause 196. The non-transitory storage medium of clause 194, wherein the indication that there is no update for at least the portion of the location information that is related to the at least one location measurement comprises a bit that indicates there is no update for all location information in the location information report.

Therefore, it is intended that claimed subject matter not be limited to the particular examples disclosed, but that such claimed subject matter may also include all aspects falling within the scope of appended claims, and equivalents thereof.

What is claimed is:

1. A method performed by a user equipment (UE) in a wireless network for supporting location services for the UE comprising:
generating a first set of location measurements comprising at least one location measurement;
sending a location information report to a location server in the wireless network for location determination of the UE, wherein the location information report comprises location information based on the first set of location measurements;
generating a second set of location measurements comprising the at least one location measurement; and
providing an indication to an entity in the wireless network that there is no update for at least a portion of the location information that is related to the at least one location measurement.

2. The method of claim 1, wherein the location information comprises at least one of the first set of location measurements, a position estimate determined based on the first set of location measurements, or a combination thereof.

3. The method of claim 1, further comprising determining that a change in location of the UE between generating the first set of location measurements and generating the second set of location measurements is below a threshold, wherein providing the indication that there is no update for at least the portion of the location information that is related to the at least one location measurement is in response to the change in location being less than the threshold.

4. The method of claim 1, further comprising determining a change in the at least one location measurement in the first set of location measurements and the at least one location measurement in the second set of location measurements is below a threshold, wherein providing the indication that there is no update for at least the portion of the location information that is related to the at least one location measurement is in response to the change being less than the threshold.

5. The method of claim 1, further comprising:
receiving an accuracy quality of service requirement; and
determining the accuracy quality of service requirement is satisfied without updating the at least the portion of the location information that is related to the at least one location measurement, wherein providing the indication that there is no update for at least the portion of the location information that is related to the at least one location measurement is in response to the determination that the accuracy quality of service requirement is satisfied.

6. The method of claim 1, further comprising receiving a configuration for a number of consecutive location information reports for which the indication of no update may be sent.

7. The method of claim 1, further comprising receiving a location request for periodic or triggered location measurements, wherein the sending the location information report and providing the indication that there is no update for at least the portion of the location information that is related to the at least one location measurement is in response to the location request for periodic or triggered location measurements.

8. The method of claim 1, wherein the indication that there is no update for at least the portion of the location information that is related to the at least one location measurement comprises a bit that indicates there is no update for the at least one location measurement.

9. The method of claim 1, wherein the indication that there is no update for at least the portion of the location information that is related to the at least one location measurement comprises a bit that indicates there is no update for all location information in the location information report.

10. The method of claim 1, wherein the indication that there is no update for at least the portion of the location information that is related to the at least one location measurement comprises not sending a second location information report to the location server by an end of a configured report expiration time.

11. The method of claim 1, wherein the entity in the wireless network is a serving base station, and the indication that there is no update for at least the portion of the location information that is related to the at least one location measurement comprises a Physical layer waveform sent to the serving base station.

12. The method of claim 1, wherein the entity in the wireless network is the location server, and the indication that there is no update for at least the portion of the location information that is related to the at least one location measurement comprises a bit in the location information report to the location server that indicates there is no update for the at least one location measurement.

13. A user equipment (UE) configured for supporting location services in a wireless network comprising:
at least one wireless transceiver configured to wirelessly communicate with at least one wireless network;
at least one memory; and
at least one processor coupled to the at least one wireless transceiver and the at least one memory and configured to:
generate a first set of location measurements comprising at least one location measurement;
send, via the at least one wireless transceiver, location information report to a location server in the wireless network for location determination of the UE, wherein the location information report comprises location information based on the first set of location measurements;
generate a second set of location measurements comprising the at least one location measurement; and
provide, via the at least one wireless transceiver, an indication to an entity in the wireless network that there is no update for at least a portion of the location information that is related to the at least one location measurement.

14. The UE of claim 13, wherein the location information comprises at least one of the first set of location measurements, a position estimate determined based on the first set of location measurements, or a combination thereof.

15. The UE of claim 13, wherein the at least one processor is further configured to determine that a change in location of the UE between generating the first set of location measurements and generating the second set of location measurements is below a threshold, wherein the at least one processor is configured to provide the indication that there is no update for at least the portion of the location information that is related to the at least one location measurement is in response to the change in location being less than the threshold.

16. The UE of claim 13, wherein the at least one processor is further configured to determine a change in the at least one location measurement in the first set of location measurements and the at least one location measurement in the second set of location measurements is below a threshold, wherein the at least one processor is configured to provide the indication that there is no update for at least the portion of the location information that is related to the at least one location measurement is in response to the change being less than the threshold.

17. The UE of claim 13, wherein the at least one processor is further configured to:
receive, via the at least one wireless transceiver, an accuracy quality of service requirement; and
determine the accuracy quality of service requirement is satisfied without updating the at least the portion of the location information that is related to the at least one location measurement, wherein providing the indication that there is no update for at least the portion of the location information that is related to the at least one location measurement is in response to the determination that the accuracy quality of service requirement is satisfied.

18. The UE of claim 13, wherein the at least one processor is further configured to receive a configuration for a number of consecutive location information reports for which the indication of no update may be sent.

19. The UE of claim 13, wherein the at least one processor is further configured to receive, via the at least one wireless transceiver, a location request for periodic or triggered location measurements, wherein the at least one processor is configured to send the location information report and provide the indication that there is no update for at least the portion of the location information that is related to the at least one location measurement in response to the location request for periodic or triggered location measurements.

20. The UE of claim 13, wherein the indication that there is no update for at least the portion of the location information that is related to the at least one location measurement comprises a bit that indicates there is no update for the at least one location measurement.

21. The UE of claim 13, wherein the indication that there is no update for at least the portion of the location information that is related to the at least one location measurement comprises a bit that indicates there is no update for all location information in the location information report.

22. The UE of claim 13, wherein the at least one processor is further configured to provide the indication that there is no update for at least the portion of the location information that is related to the at least one location measurement by being configured to not send a second location information report to the location server by an end of a configured report expiration time.

23. The UE of claim 13, wherein the entity in the wireless network is a serving base station, and the indication that there is no update for at least the portion of the location information that is related to the at least one location measurement comprises a Physical layer waveform sent to the serving base station.

24. A method performed by a base station serving a user equipment (UE) in a wireless network for supporting location services for the UE comprising:
receiving a location information report from the UE comprising location information based on a set of location measurements comprising at least one location measurement generated by the UE; and
receiving an indication from the UE that there is no update for at least a portion of the location information that is related to the at least one location measurement.

25. The method of claim 24, wherein the location information comprises at least one of the set of location measurements, a position estimate determined by the UE based on the set of location measurements, or a combination thereof.

26. The method of claim 24, further comprising sending the location information report to a location server, and sending a second indication that there is no update for at least the portion of the location information that is related to the at least one location measurement to an external client.

27. The method of claim 24, further comprising sending the location information report to a location server, and sending the indication that there is no update for at least the portion of the location information that is related to the at least one location measurement to the location server.

28. The method of claim 24, wherein the location information report and the indication that there is no update for at least the portion of the location information that is related to the at least one location measurement are for periodic or triggered location measurements.

29. The method of claim 24, wherein the indication that there is no update for at least the portion of the location information that is related to the at least one location measurement comprises a bit that indicates there is no update for the at least one location measurement.

30. The method of claim 24, wherein the indication that there is no update for at least the portion of the location information that is related to the at least one location measurement comprises a bit that indicates there is no update for all of the location information in the location information report.

31. The method of claim 24, wherein the indication that there is no update for at least the portion of the location information that is related to the at least one location measurement comprises a Physical layer waveform.

32. A base station configured for supporting location services for a user equipment (UE), the base station serving the UE in a wireless network, comprising:
an external interface configured to wirelessly communicate with entities in the wireless network;
at least one memory;
at least one processor coupled to the external interface and the at least one memory, wherein the at least one processor is configured to:
receive a location information report from the UE comprising location information based on a set of location measurements comprising at least one location measurement generated by the UE; and
receive an indication from the UE that there is no update for at least a portion of the location information that is related to the at least one location measurement.

33. The base station of claim 32, wherein the location information comprises at least one of the set of location measurements, a position estimate determined by the UE based on the set of location measurements, or a combination thereof.

34. The base station of claim 32, wherein the at least one processor is further configured to send the location information report to a location server, and send a second indication that there is no update for at least the portion of the location information that is related to the at least one location measurement to an external client.

35. The base station of claim 32, wherein the at least one processor is further configured to send the location information report to a location server, and send the indication that there is no update for at least the portion of the location information that is related to the at least one location measurement to the location server.

36. The base station of claim 32, wherein the location information report and the indication that there is no update for at least the portion of the location information that is related to the at least one location measurement are for periodic or triggered location measurements.

37. The base station of claim 32, wherein the indication that there is no update for at least the portion of the location information that is related to the at least one location measurement comprises a bit that indicates there is no update for the at least one location measurement.

38. The base station of claim 32, wherein the indication that there is no update for at least the portion of the location information that is related to the at least one location measurement comprises a bit that indicates there is no update for all of the location information in the location information report.

39. The base station of claim 32, wherein the indication that there is no update for at least the portion of the location information that is related to the at least one location measurement comprises a Physical layer waveform.

40. A method performed by a location server in a wireless network for supporting location services for a user equipment (UE) comprising:
receiving a location information report from the UE comprising location information based on a set of location measurements comprising at least one location measurement generated by the UE; and
detecting an indication from the UE that there is no update for at least a portion of the location information that is related to the at least one location measurement.

41. The method of claim 40, wherein the location information comprises at least one of the set of location measurements, a position estimate determined by the UE based on the set of location measurements, or a combination thereof.

42. The method of claim 40, further comprising sending a location request for periodic or triggered location measurements to the UE, wherein the location information report is sent by the UE in response to the location request for periodic or triggered location measurements.

43. The method of claim 40, further comprising sending the UE a threshold configuration for the UE to determine when an update to at least the portion of the location information is not required.

44. The method of claim 40, further comprising sending the UE a number of consecutive location information reports for which no update may be sent.

45. The method of claim 40, further comprising sending the UE an accuracy quality of service requirement, wherein an update to the at least the portion of the location information is not required to be reported in a location measurement report when the accuracy quality of service requirement is satisfied without updating the at least the portion of the location information.

46. The method of claim 40, wherein detecting the indication that there is no update for at least the portion of the location information that is related to the at least one location measurement comprises determining that the UE did not send a second location information report by an end of a configured report expiration time.

47. The method of claim 40, wherein detecting the indication that there is no update for at least the portion of the location information that is related to the at least one location measurement comprises receiving the indication from a serving base station that the UE did not update the at least the portion of the location information that is related to the at least one location measurement.

48. The method of claim 40, wherein detecting the indication that there is no update for at least the portion of the location information that is related to the at least one location measurement comprises receiving the indication that there is no update for at least the portion of the location information that is related to the at least one location measurement from the UE.

49. A location server configured for supporting location services for a user equipment (UE) in a wireless network comprising:
an external interface configured to communicate with entities in the wireless network;
at least one memory;
at least one processor coupled to the external interface and the at least one memory, wherein the at least one processor is configured to:
receive a location information report from the UE comprising location information based on a set of location measurements comprising at least one location measurement generated by the UE; and
detect an indication from the UE that there is no update for at least a portion of the location information that is related to the at least one location measurement.

50. The location server of claim 49, wherein the location information comprises at least one of the set of location measurements, a position estimate determined by the UE based on the set of location measurements, or a combination thereof.

51. The location server of claim 49, wherein the at least one processor is further configured to send a location request for periodic or triggered location measurements to the UE, wherein the location information report is sent by the UE in response to the location request for periodic or triggered location measurements.

52. The location server of claim 49, wherein the at least one processor is further configured to send the UE a threshold configuration for the UE to determine when an update to at least the portion of the location information is not required.

53. The location server of claim 49, wherein the at least one processor is further configured to send the UE a number of consecutive location information reports for which no update may be sent.

54. The location server of claim 49, wherein the at least one processor is further configured to send the UE an accuracy quality of service requirement, wherein an update to the at least the portion of the location information is not required to be reported in a location measurement report when the accuracy quality of service requirement is satisfied without updating at least the portion of the location information.

55. The location server of claim 49, wherein the at least one processor is configured to detect the indication that there is no update for at least the portion of the location information that is related to the at least one location measurement by being configured to determine that the UE did not send a second location information report by an end of a configured report expiration time.

56. The location server of claim 49, wherein the at least one processor is configured to detect the indication that there is no update for at least the portion of the location information that is related to the at least one location measurement by being configured to receive the indication from a serving base station that the UE did not update the at least the portion of the location information that is related to the at least one location measurement.

57. The location server of claim 49, wherein the at least one processor is configured to detect the indication that there is no update for at least the portion of the location information that is related to the at least one location measurement by being configured to receive the indication that there is no update for at least the portion of the location information that is related to the at least one location measurement from the UE.
